(19) United States
(12) Patent Application Publication
(10) Pub. No.: US 2025/0385944 A1
(43) Pub. Date: Dec. 18, 2025

(54) DYNAMIC SYSTEMS AND METHODS FOR MEDIA-AWARE LOW- TO ULTRALOW-LATENCY, REAL-TIME TRANSPORT PROTOCOL CONTENT DELIVERY

(71) Applicant: Adeia Guides Inc., San Jose, CA (US)

(72) Inventors: Christopher Phillips, Hartwell, GA (US); Dhananjay Lal, Englewood, CO (US)

(21) Appl. No.: 18/744,496

(22) Filed: Jun. 14, 2024

(51) Int. Cl. H04L 65/65; H04L 43/065; H04L 65/70; H04L 65/80

(52) U.S. Cl. CPC H04L 65/65; H04L 43/065; H04L 65/70; H04L 65/80

(57) ABSTRACT

Low- to ultralow-latency content delivery via real-time transport protocol (RTP) is provided. In an example, transport packets, which carry a packetized elementary stream (PES), are selectively marked based on frame size. More particularly, if a number or size of packets needed to transport a picture or PES packet exceeds a threshold, they are marked for preferential processing, such as low latency, low loss, and scalable throughput (L4S) processing. If the number or size of packets is below the threshold, they are marked for default or non-preferential processing. The marking may be applied to entire pictures, tiles, and/or slices. Related apparatuses, devices, techniques, and articles are also described.

### FIELD OF THE DISCLOSURE

The present disclosure relates to content delivery, including low- to ultralow-latency content delivery via real-time transport protocol (RTP).

### SUMMARY

Real-time video for interactive experiences, including gaming, is increasingly popular. Low latency is important for such experiences and particularly challenging in mobile environments. In some approaches, RTP and a low latency, low loss, and scalable throughput (L4S) service are provided. For instance, the Internet Engineering Task Force (IETF)'s Request for Comments (RFC) 8888 defines real-time transport control protocol (RTCP) feedback for congestion control in RTP flows including interactive real-time traffic. RFC 9330 describes the L4S architecture highlighting capacity-seeking congestion controllers as a “root cause” of queuing delay. RFC 9331 specifies the explicit congestion notification (ECN) protocol for L4S, which uses scalable congestion control for very low and consistent queuing delay without compromising link utilization, distinguishing L4S from non-L4S or classic traffic. RFC 9332 defines a framework for dual-queue coupled active queue management (AQM) for L4S, allowing the coexistence of classic and scalable congestion controls and transitioning to scalable congestion controls for low latency and loss.

However, L4S may be improved in some areas, such as congestion control, network congestion, and usage of additional buffers (so as to avoid “buffer bloat”). Generally, congestion control mechanisms have not evolved significantly since the early days of the internet. These mechanisms introduce latency, jitter, and packet loss, not only to themselves but also to other applications using the network at the same time. Also, as network buffers have expanded, latency problems in real-time applications like video calls or game streaming services have followed. Further, one of the challenges of L4S is ensuring its coexistence with classic traffic in a shared network, as L4S traffic may dominate the network, causing congestion.

To help address the limitations and problems of these and other approaches, low- to ultralow-latency content delivery is provided in various methods, systems, and related apparatuses, devices, techniques, and articles. For example, a method is provided that checks whether a transport unit, which carries an image unit, meets a certain standard, and based on the transport unit meeting the certain standard, preferential processes the transport unit. Also, for example, a method for sending data, like parts of an image or video, is provided. Further, for example, a condition is checked for each data unit. Still further, for example, if the condition is met, the unit is marked for preferential processing, e.g., an L4S service.

In some embodiments, in lieu of or in addition to marking image units between preferential (e.g., L4S) and non-preferential or default (e.g., non-L4S), at least one of the following is implemented: (1) reducing network congestion, e.g., by temporarily dropping a number of devices on a given connection; (2) as-needed change (e.g., via virtual private network (VPN) to a server and/or edge physically closer to a client device; (3) router optimization (e.g., modifying quality of service (QOS) settings); (4) a temporary burst of increased network bandwidth; or the like.

Moreover, for example, if the condition is not met, the unit is sent via a non-L4S service. In addition, for example, data is controlled from both L4S and non-L4S services, rearranging them before decoding. Furthermore, for example, data sent to and received from the L4S service is tracked. Also, for example, a target bitrate is estimated for sending data, and a bitrate of an encoder is adjusted based on the estimated target bitrate. Further, for example, the preferential processing can involve setting a target bitrate, and data received from both L4S and non-L4S services can be streamed at the target bitrate.

For example, a method is provided for sending data from a sender to a receiver. Also, for example, a data unit is combined and encoded with information for L4S or non-L4S sending, and the data unit is sent to the receiver. Further, for example, if a condition is met, the data unit is marked for the L4S service. Still further, for example, a bitrate of an encoder is based on a priority queue. Moreover, for example, at the receiver, a packet is received, packet information is updated, and a response is sent back to the sender. In addition, for example, devices are provided to perform these features. Furthermore, for example, non-transitory computer-readable mediums are provided for storing operations for performing these features.

In some embodiments, a method for low- to ultralow-latency content delivery is provided. For example, the method involves determining if a quantification of a transport unit, needed to encapsulate and transport an image unit, satisfies a threshold. Also, for example, the method involves providing preferential encapsulation and transport of the image unit if the quantification satisfies the threshold. If it does not, for example, default encapsulation and transport of the image unit are provided. Further, for example, the preferential encapsulation and transport involve tagging the transport unit for an L4S service. Still further, for example, the transport unit could be a plurality of transport packets that encapsulate a packetized elementary stream (PES). Moreover, for example, the transport units are RTP packets or TCP packets. In addition, for example, the method includes streaming and storing transport packets from both the L4S service and a non-L4S service. Furthermore, for example, the method involves resequencing transport packets from both services prior to demultiplexing and decoding. Additionally, the method includes storing transport packets for transmission to the L4S and non-L4S services at both sender and receiver devices. Even further, for example, the method involves reporting packet statistics for transport packets transmitted to and received from the L4S service.

Also, for example, the method includes affecting, on a frame-to-frame basis, transport packets traversing both the L4S and non-L4S services based at least in part on an encoder bitrate and a content complexity. Further, for example, the target bitrate for the encoder can be set based on a weighted average of the target bitrates for transport packets traversing both services. Still further, for example, the quantification can comprise a quantity or size of a plurality of transport units. Moreover, for example, the image unit can be a picture (or frame), slice, or tile. Unless implied otherwise from context, as used herein, any one description of a feature with respect to a picture (or frame), slice, or tile may be applied to any other one of the group without limitation. In addition, for example, the preferential encapsulation and transport of the image unit can involve setting a target bitrate. Furthermore, for example, the method also involves generating for output (e.g., streaming) the transport unit received from the L4S and non-L4S services from a sender device to a receiver device at the target bitrate.

In some embodiments, a method for low- to ultralow-latency content delivery from a sender to a receiver is provided. For example, the method involves multiplexing one or more content (e.g., video and/or audio) packets, which encapsulate video and/or audio encoded PES data into a transport unit at the sender; and tagging the transport unit with information for either preferential or non-preferential encapsulation and transport. Also, for example, the method involves transmitting (or causing to transmit) the multiplexed and encoded transport unit to the receiver. Further, for example, the sender includes an RTP multiplexer, which determines whether a quantification of the transport unit to encapsulate and transport an image unit satisfies a condition. Still further, if the condition is satisfied, preferential encapsulation and transport of the image unit are provided, which include tagging the transport unit for an L4S service, for instance. Moreover, for example, a packet data structure is provided at the RTP multiplexer, which includes either an L4S tag or a non-L4S tag, and an RTP packet, which encapsulates encoded video and/or audio data. In addition, for example, a priority queue of RTP packet data structures is provided, where the priority of each packet in the queue is based on the preferential encapsulation and transport of the image unit determined at the RTP multiplexer. Furthermore, for example, the bitrate of an encoder of the sender is controlled based on the priority queue.

Also, for example, the sender includes a transmission scheduler which provides various services based on the priority queue of RTP packet data structures. Further, for example, the sender includes a video encoding rate control and repair unit that receives a repair request from the transmission scheduler, transmits a target video encoding bitrate to an encoder of the sender, and requests key slices and/or tiles to be generated by the encoder for repair of dropped transport packets. Still further, the sender includes a video encoding rate control and repair unit that identifies, based on RTCP responses to the RTP sender from a client device's RTP receiver, that an RTP packet was late or dropped. Moreover, for example, a repair request is made as a result of the transmission scheduler making a key slice or tile request for one or more slices and/or tiles based on a priority queue of RTP packet data structures. In addition, for example, the multiplexer tags the transport unit for an L4S service or a non-L4S service and affects, on a frame-to-frame basis, the transport unit traversing the L4S service or the non-L4S service based at least in part on an encoder bitrate and a content complexity. Furthermore, for example, the video encoding rate control and repair subsystem sets a target bitrate for an encoder based on the queue length of the RTP priority queue of RTP packet data structures. Additionally, for example, the RTP packet which encapsulates encoded video and/or audio data is transmitted to the receiver. Further still, for example, at the receiver, the multiplexed transport packet from the sender is received, the information for preferential encapsulation and transport or non-preferential encapsulation and transport is updated, and a response packet including the updated information is transmitted from the receiver to the sender.

In some embodiments, various devices for low- to ultralow-latency content delivery are provided. For example, a multiplexer is provided that determines whether a quantification of a transport unit, to encapsulate and transport an image unit, satisfies a threshold. Also, for example, based on this determination, the multiplexer provides preferential encapsulation and transport of the image unit. Further, for example, the multiplexer tags the transport unit for an L4S service or a non-L4S service, and affects, on a frame-to-frame basis, the transport unit traversing the L4S service or the non-L4S service based at least in part on an encoder bitrate and a content complexity (e.g., a queue length of an RTP priority queue of RTP packet data structures). Still further, for example, the video encoding rate control and repair subsystem sets a target bitrate for an encoder based on the queue length of the RTP priority queue of RTP packet data structures. Moreover, for example, the device can stream the transport unit received from the L4S service and the non-L4S service from a sender device to a receiver device at the target bitrate.

For example, a transport unit (e.g., a transport packet) is generated in an RTP multiplexer at an encoder. Also, for example, the encoder encodes video into encoded PES packets and audio into encoded audio PES packets. Further, the encoded video and audio PES packets are sent to the RTP multiplexer, where the PES packets are multiplexed into RTP transport packets. Still further, for example, the packets are encoded with information for preferential or non-preferential processing. Moreover, for example, the device can receive an RTPRTP multiplexed transport packet, and update information for preferential or non-preferential processing (e.g., if a received RTP packet has an L4S marking, a corresponding RTCP packet will have an L4S marking). In addition, for example, the device can receive an RTP multiplexed and encoded transport packet from the sender to the receiver, generate a corresponding response including information for preferential encapsulation and transport or non-preferential encapsulation and transport at the receiver (e.g., generate an RTCP packet with an L4S marking based on the received RTP packed having an L4S marking), and transmit the corresponding response packet from the receiver to the sender. Furthermore, for example, the response packet includes the updated information.

For example, the device includes means for performing all the above functions. Also, for example, a device is provided that receives an RTPRTP multiplexed packet from a sender, generates a corresponding response packet including information for preferential or non-preferential encapsulation and transport, and transmits the response packet from the receiver to the sender, including the updated information (e.g., based at least in part on an L4S marking in a received RTP packet).

In some embodiments, non-transitory computer-readable mediums for low- to ultralow-latency content delivery are provided.

The present invention is not limited to the combination of the elements as listed herein and may be assembled in any combination of the elements as described herein. These and other capabilities of the disclosed subject matter will be more fully understood after a review of the following figures, detailed description, and claims.

### BRIEF DESCRIPTIONS OF THE DRAWINGS

The present disclosure, in accordance with one or more various embodiments, is described in detail with reference to the following figures. The drawings are provided for purposes of illustration only and merely depict typical or example embodiments. These drawings are provided to facilitate an understanding of the concepts disclosed herein and should not be considered limiting of the breadth, scope, or applicability of these concepts. It should be noted that for clarity and ease of illustration these drawings are not necessarily made to scale.

The embodiments herein may be better understood by referring to the following description in conjunction with the accompanying drawings in which like reference numerals indicate identically or functionally similar elements, of which:

FIG. 1A depicts an example of an instant scene change resulting in a very large predicted coded picture (P-picture) and a corresponding chart of arrival time versus frame size, in accordance with some embodiments of the disclosure;

FIG. 1B shows a flowchart of a process for low- to ultralow-latency content delivery, in accordance with some embodiments of the disclosure;

FIG. 2 depicts predicted pictures in a cloud gaming environment with a group of pictures (GOP) structure (including intra (I), predicted (P), and bidirectional (B) coded pictures) with all P-pictures following the I-picture, in accordance with some embodiments of the disclosure;

FIG. 3 depicts I-pictures in a cloud gaming environment with the GOP structure where the GOP size is about two seconds, in accordance with some embodiments of the disclosure;

FIGS. 4A-4H depict delivery of a sequence of pictures after a scene change avoiding a large picture with slices (FIGS. 4A-4D) and tiles (FIGS. 4E-4H), in accordance with some embodiments of the disclosure;

FIG. 4A depicts a first generated frame including four I-slices after a scene change, in accordance with some embodiments of the disclosure;

FIG. 4B depicts a second generated frame including four I-slices and four P-slices after the scene change, in accordance with some embodiments of the disclosure;

FIG. 4C depicts a third generated frame including four I-slices and eight P-slices after the scene change, in accordance with some embodiments of the disclosure;

FIG. 4D depicts a fourth generated frame including four I-slices and 12 P-slices after the scene change, in accordance with some embodiments of the disclosure;

FIG. 4E depicts a first generated frame including 32 I-tiles after a scene change, in accordance with some embodiments of the disclosure;

FIG. 4F depicts a second generated frame including 32 I-tiles and 32 P-tiles after the scene change, in accordance with some embodiments of the disclosure;

FIG. 4G depicts a third generated frame including 32 I-tiles and 64 P-tiles after the scene change, in accordance with some embodiments of the disclosure;

FIG. 4H depicts a fourth generated frame including 32 I-tiles and 96 P-tiles after the scene change, in accordance with some embodiments of the disclosure;

FIGS. 4I-4L depict repairing packet loss with slices (FIGS. 4I and 4J) and tiles (FIGS. 4K and 4L), in accordance with some embodiments of the disclosure;

FIG. 4I depicts slices with packet loss in independently encoded slices 0, 4, 6, 9, and 12 resulting in macro-blocking and/or corruption of those independently encoded slices, in accordance with some embodiments of the disclosure;

FIG. 4J depicts I-slice repair for slices 0, 4, 6, 9, and 12, in accordance with some embodiments of the disclosure;

FIG. 4K depicts packet loss in independently encoded tiles 8, 22, 27, 30, 50, and 101 resulting in macro-blocking and/or corruption of those independently encoded tiles, in accordance with some embodiments of the disclosure;

FIG. 4L depicts I-tile repair for tiles 8, 22, 27, 30, 50, and 101, in accordance with some embodiments of the disclosure;

FIG. 5 is a table representing marking of an ECN packet, in accordance with some embodiments of the disclosure;

FIG. 6 depicts a system architecture for prioritized frame, slice, and/or tile delivery, in accordance with some embodiments of the disclosure;

FIG. 7 depicts an architecture of a video encoder for the system of FIG. 6, in accordance with some embodiments of the disclosure;

FIG. 8 depicts an architecture of a rate controller within the video encoder of FIG. 7, in accordance with some embodiments of the disclosure;

FIG. 9 depicts an example queue with data structure entries for RTP packets within a frame where there is one slice per frame, in accordance with some embodiments of the disclosure;

FIG. 10 depicts an example queue with data structure entries for RTP packets for a frame where there are 16 independently encoded slices per frame, in accordance with some embodiments of the disclosure;

FIG. 11 depicts an example queue with data structure entries for RTP packets for a frame where there are 128 independently encoded tiles per frame, in accordance with some embodiments of the disclosure;

FIG. 12 shows a flowchart of an example process for an RTP multiplexer, in accordance with some embodiments of the disclosure;

FIG. 13 shows a flowchart of an example process for an RTP transmission scheduler, in accordance with some embodiments of the disclosure;

FIG. 14 shows a flowchart of an example process for an RTP receiver receiving a packet, in accordance with some embodiments of the disclosure;

FIG. 15 depicts a bi-modal distribution of latency with selective L4S enablement, in accordance with some embodiments of the disclosure;

FIG. 16 depicts transmission and reception transport buffers to account for out-of-order delivery due to different round trip times (RTTs) for L4S and non-L4S packets, in accordance with some embodiments of the disclosure;

FIG. 17 depicts a weighted average bitrate calculation across L4S and non-L4S for input as a target bitrate to an encoder from a priority queue, in accordance with some embodiments of the disclosure;

FIG. 18 depicts a format for an RTCP congestion control feedback packet, in accordance with some embodiments of the disclosure;

FIG. 19 shows a flowchart of an example process for low- to ultralow-latency content delivery, in accordance with some embodiments of the disclosure;

FIG. 20 shows a flowchart of an example process with one or more steps combinable with one or more steps of the process of FIG. 19, in accordance with some embodiments of the disclosure;

FIG. 21 shows a flowchart of an example process for low- to ultralow-latency content delivery at a multiplexer, in accordance with some embodiments of the disclosure;

FIG. 22 shows a flowchart of an example process with one or more steps combinable with one or more steps of the process of FIG. 21, in accordance with some embodiments of the disclosure;

FIG. 23 shows a flowchart of an example process for low- to ultralow-latency content reception at a receiver, in accordance with some embodiments of the disclosure;

FIG. 24 depicts an artificial intelligence system, in accordance with some embodiments of the disclosure; and

FIG. 25 depicts a system including a server, a communication network, and a computing device for performing the methods and processes, in accordance with some embodiments of the disclosure.

The drawings are intended to depict only typical aspects of the subject matter disclosed herein, and therefore should not be considered as limiting the scope of the disclosure. Those skilled in the art will understand that the structures, systems, devices, and methods specifically described herein and illustrated in the accompanying drawings are non-limiting exemplary embodiments and that the scope of the present invention is defined solely by the claims.

### DETAILED DESCRIPTION

With the increase of cloud-rendered content, especially in cloud gaming and future extended reality (XR) applications, optimized encoding and transport in extreme low (or ultralow) latency cases are increasingly desired and important to industry. Optimization of low latency encoding and transport for cloud-rendered interactive content is provided. For example, optimized packet loss in extreme low latency cases in a cloud-rendered environment is provided.

Various approaches, methods, systems, apparatuses, devices, techniques, and articles are provided for low- to ultralow-latency content delivery. One or more features for low- to ultralow-latency content delivery disclosed herein may be combined with one or more features for real-time media streaming, including features to enhance user experience and optimize network resources. For example, dynamic systems and methods for media-aware ultralow-latency RTP transport utilize RTP to facilitate ultralow-latency video streaming. The dynamic systems and methods for media-aware ultralow-latency RTP transport maintain a latency (e.g., an end-to-end latency, including processing and transport) of less than about 300 milliseconds, and in some embodiments, less than about 20 milliseconds, which is imperceptible to users, thereby improving the experience of live video streaming or online gaming. Also, for example, to further enhance the interactive experience in cloud-computing environments, video compression at scene changes for a low-latency interactive experience is provided. The video compression at scene changes for a low-latency interactive experience optimizes video quality during rapid scene changes, common in interactive applications like cloud gaming, ensuring a smooth and high-quality viewing experience even under fluctuating network conditions. Further, for example, optimization of encoding at scene changes is provided. Still further, for example, optimization includes providing slices and/or tiles at scene changes. Moreover, for example, optimization includes providing slices and/or tiles for repair. In addition, for example, optimization for delivering relatively large frames, slices, or tiles is provided.

Further, optimized fast video frame repair for extreme low latency RTP delivery is provided. The optimized fast video frame repair for extreme low latency RTP delivery involves injecting P-frames for packet-loss repair of ultralow-latency streaming, reducing the bitrate overhead while maintaining streaming quality. Still further, for example, application-flow-aware broadband service with data caps is provided. Moreover, for example, intelligent application priority packet delivery control is provided. The intelligent application priority packet delivery control uses intelligent mechanisms to prioritize packet delivery based on the type of application or data. In addition, for example, methods to optimize video compression for adaptive bitrate (ABR) streaming may be used in conjunction with the provided methods. The methods to optimize video compression for ABR streaming dynamically adjust the quality of a video stream in real-time, based on the viewer's network conditions, which ensures the viewer receives the highest possible video quality without buffering or lag. These features contribute to a more seamless and high-quality streaming experience.

Extreme low latency delivery of video for interactive experiences (like gaming or interacting with live events) utilizes an extremely low- to no buffer on a client device for an optimal (uninterrupted) user experience. The more video frames that are buffered on the client device, the higher the playout latency; a larger buffer provides a more reliable video playout experience and is less likely to drop frames due to the frames not arriving in time or have time to recover from packet loss resulting in corrupt frames. The larger the buffer, the more dependable the client device is for continuous playout of video with a lower chance of completely draining the client buffer while waiting on all the packets for a frame to be decoded and rendered. For example, the interplay between extreme low latency and a buffer plays out in cloud-based video gaming for game genres like first person shooter games. Another example is an XR (including augmented reality (AR) and virtual reality (VR)) interactive experience. Cloud-based simultaneous localization and mapping (SLAM) is another example where a video stream is delivered to a system; the cloud-based SLAM system provides localization data back to the client device. Cloud-based SLAM includes applications in XR, robotics, and autonomous driving. Another example is remote control of vehicles like construction equipment or drones. Typically, these delivery systems use a very low latency protocol like RTP.

It is to be understood that various terms relating to latency may be understood as set forth in the following. These latency terms are not intended to be limiting but exemplary. “High” latency is, e.g., about 45 seconds or more. An example of this is DASH/HLS with 10-second segments. “Typical” latency ranges, e.g., from about 10 to about 45 seconds. This can be seen in DASH/HLS with 6-second segments. DASH/HLS with 2-second segments falls between low latency and typical latency. “Low” latency is, e.g., between about 1 and 10 seconds. Examples include DASH/HLS with fragmented or 1-second segments, cable, IPTV, satellite, over-the-air broadcast, social media, messaging, live sports, game streaming, and eSports. Online gambling, betting, and auctioning fall between ultralow latency and low latency. “Ultralow” latency is, e.g., about 100 milliseconds to about 1 second. Cloud gaming, videoconferencing, and Voice over IP (VOIP) straddle the line between near-real-time latency and ultralow latency. “Near-real-time” latency is, e.g., less than about 100 milliseconds. An example of this is surgical robots. Other examples include different game genres. For example, for a role playing fantasy game, a latency of less than about 100 milliseconds is likely sufficient. Whereas, in a first-person shooter game, end-to-end latency below about 40 milliseconds is desirable. In another example, VR cloud gaming pushes these latencies even lower to below about 20 milliseconds.

Another example is video for live streams delivered via hypertext transfer protocol (HTTP) ABR. For live streams, this example leverages ABR formats including Apple's HTTP live streaming (HLS) or moving picture experts group (MPEG) dynamic adaptive streaming over HTTP (DASH). Typically, devices that support Apple's HLS or MPEG DASH for live streams buffer plural (e.g., three) video segments. The plural segment buffering provides a full buffer for playout reliability, allows bandwidth measurement algorithms that run on the device to select which bitrate segments to receive, and adjusts the bitrate in time to prevent completely draining the buffer and stalling playout. Even though live content interaction does not necessarily need to be as low in latency as cloud gaming (e.g., first-person shooter (FPS) games, remote control of a vehicle, or interactive XR experiences), the latency may need to be lower for these types of applications resulting in a much smaller buffer than three segments. In some cases, the latency is less than the playout time of one segment. In interactive experiences with live content, MPEG DASH and HLS do not offer low latency for an interactive experience with the live content. Another example of an interactive experience is gambling and placing bets during live sporting events (e.g., bets like “will the player make the goal?” benefit from low latency for an optimal user experience).

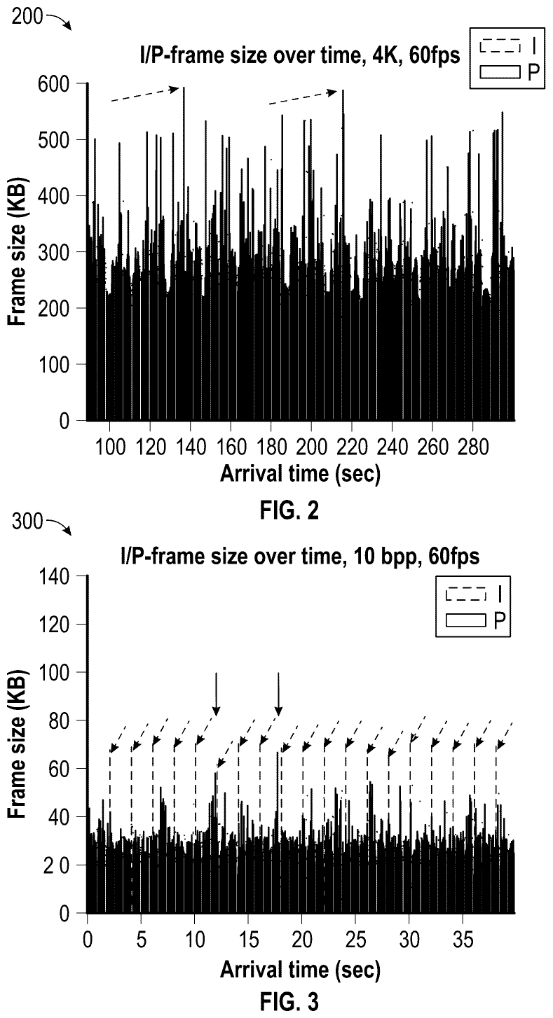

When video is encoded at a set bitrate, the encoder encodes the video to average out to a bitrate over time. For example, a defined buffer model achieves the encoding of the video to average out to the bitrate over time. Also, for example, a modeled buffer may be provided within a rate controller of an encoder. Video encoders can be configured to encode I-pictures, P-pictures, and B-pictures into a GOP structure. In many instances, the I-pictures, P-pictures, and B-pictures have varied sizes, where an I-picture is very large (e.g., greater than about 600 KB as shown, for example, in FIG. 2, or greater than about 60 KB as shown, for example, in FIG. 3) as compared to the P-pictures and B-pictures. Further, for example, P-pictures are often larger than B-pictures. The differences between one frame and the next also impacts the picture size. Some content is more difficult to encode versus other content based, on the differences from picture to picture. A news broadcast is typically easy to encode since the video is usually of a person or a few people sitting in front of a camera just talking. Still further, for example, a basketball game is more difficult to encode, because the difference from one picture to the next can be significant due to the movement of the camera, the movement of the players, and the movement of the people captured in the stands (other examples include rendering of grass on a football field during movement of a player in motion and moving water or waves). In cloud gaming, the difference in frames is also a big factor. Due to the extreme low latency provision, an encoder is configured to encode an I-picture at the beginning, and every picture after the I-picture is a P-picture. B-pictures are not encoded in cloud gaming due to the increased latency. A GOP for typical video with no low latency provision would typically be an encode order of (I, P, B, B, B) for encoding efficiency. The way the pictures are encoded is a sequence of (I, P, B, B, and B), meaning the encoder will have to encode the I-pictures, P-pictures, and B-pictures before delivering those pictures to the client device. The client device, in this example, waits on the P-picture to decode the B-pictures. To enable the lowest latency, an I-picture, P-picture (IP) GOP structure may be used. In the case of SLAM or remote-rendered gaming, there is typically one encoder per each client device or user device; there is no need to generate an instantaneous decoder refresh (IDR) frame (a type of I-frame that specifies that no frame after the IDR frame can reference any frame before it) every so often since no other client devices will need to join the video stream. In these cases, an IDR picture is created at the start of the video stream and all following pictures will be P-pictures. For HTTP ABR video, for example, an IDR is the first picture of every segment.

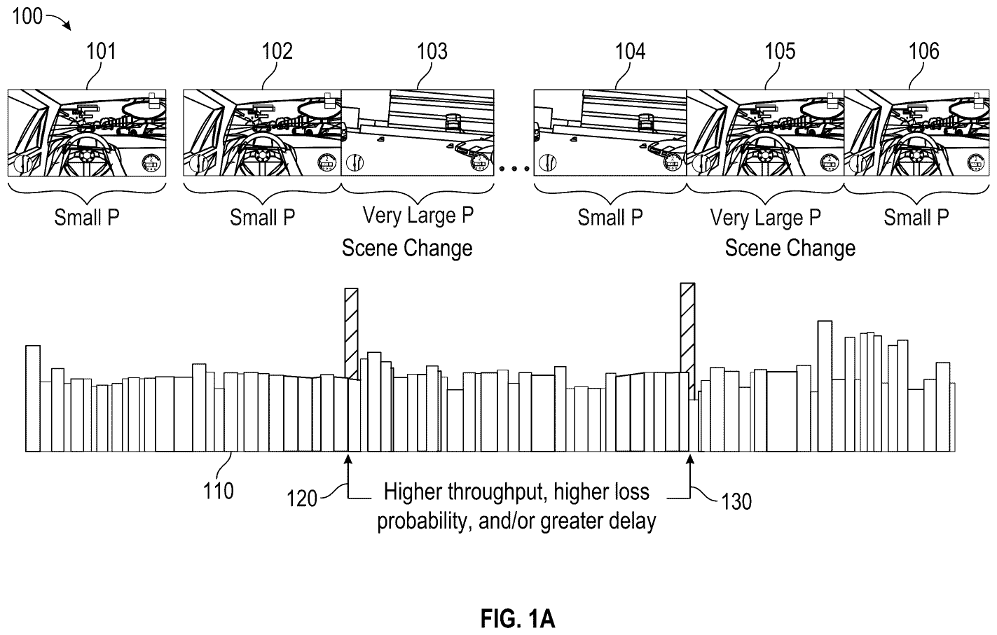

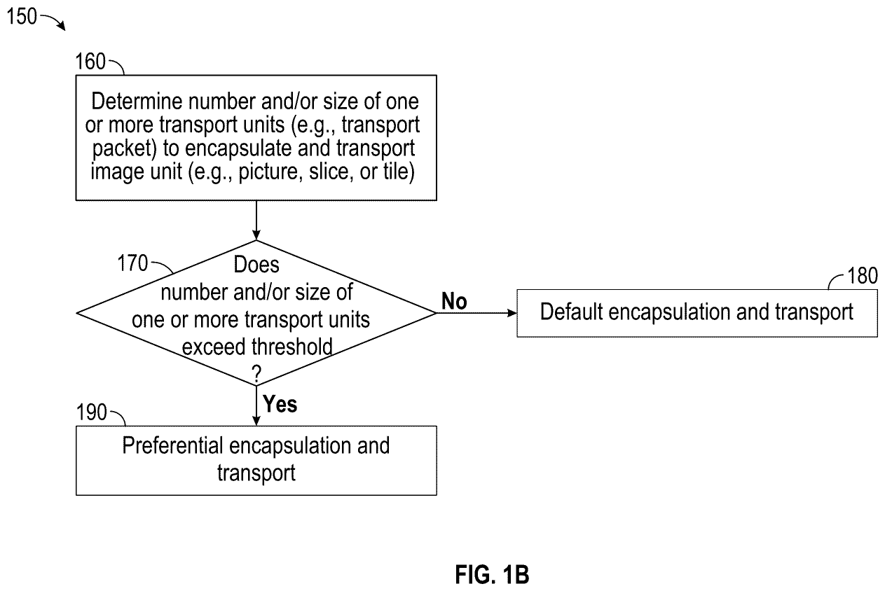

Another example is a racing game where the difference from one frame to the next can be significant. Some racing games allow a user playing the game to switch views, for example, from the front windshield to a left, right, or rear view. The difference from one frame to the next will cause the picture sizes to increase significantly. A series of frames are shown in FIG. 1A. The series is an example of two scene changes causing very large P-picture sizes to be generated on the encoded first frame at each scene change.

For example, FIG. 1A depicts an example of an instant scene change 100 resulting in a very large predicted coded picture (P-picture) and a corresponding chart 110 of arrival time versus frame size, in accordance with some embodiments of the disclosure. The scene change 100 includes, for example, a first frame 101 and a second frame 102 depicting a first-person viewpoint of a driver (corresponding with the gamer). There may be additional frames (depicted with an ellipsis) between the first frame 101 and the second frame 102. The corresponding chart 110 of arrival time (x-axis) versus frame size (y-axis) shows a relatively small difference between frames 101 and 102. Whereas, for example, if a user selects a viewpoint change, e.g., a switch from the first-person viewpoint of the driver at the second frame 102 to the driver checking their right side in a third frame 103, a relatively large P-picture 120 is generated due to the scene change. The relatively large P-picture 120 is associated with higher throughput, suffers higher loss probability, and/or suffers greater delay, and the present disclosure helps to address these issues.

As above, there may be additional frames (depicted with an ellipsis) between the third frame 103 and a fourth frame 104, where the viewpoint may remain on the driver checking their right side. Again, the corresponding chart 110 shows a relatively small difference between frames 103 and 104. If, as in this example, the driver selects another viewpoint change, e.g., a switch from the driver checking their right side in the fourth frame 104 back to the first-person viewpoint of the driver at a fifth frame 105, again, a relatively large P-picture 130 is generated due to the scene change. A subsequent frame, a sixth frame 106, continues in this example with a relatively small difference between frames 105 and 106. In some approaches, the relatively large P-picture 130 utilizes higher throughput, suffers higher loss probability, and/or suffers greater delay associated with such scene changes.

FIG. 1B shows a flowchart of a process 150 for low- to ultralow-latency content delivery, in accordance with some embodiments of the disclosure. The process 150, and others disclosed herein, provides a solution to the problems noted herein. For example, the process 150 provides lower throughput, encounters a lower probability, and/or encounters lesser delay. For example, the process 150 includes determining 160 a quantification (e.g., number and/or a size) of one or more transport units (e.g., a transport packet or the like) to encapsulate and transport an image unit (e.g., a picture, a slice, a tile, or the like). Also, for example, the process 150 may include determining 170 whether the number and/or the size of the one or more transport units exceeds a threshold (details of different examples of thresholds are provided herein). Further, for example, based at least in part on the number and/or the size) of the one or more transport units not exceeding the threshold (170=“No”), the process 150 continues with providing 180 default (or non-preferential) encapsulation and transport of the one or more transport units (details of different examples of default (or non-preferential) encapsulation and transport are provided herein). Still further, for example, based at least in part on the number and/or the size of the one or more transport units exceeding the threshold (170=“Yes”), the process 150 continues with providing 190 preferential encapsulation and transport of the one or more transport units. In some embodiments, a transport unit is a transport packet. Also, for example, the transport packet may be one or more TCP packets. In some embodiments, a transport unit includes a plurality of transport packets that encapsulate a PES. The term transport unit is not intended to be limited and is understood to have a meaning suitable for any of the embodiments described herein or the like.

FIG. 2 depicts a graph 200 of sizes of P-pictures in a cloud gaming environment over time, in accordance with some embodiments of the disclosure. A GOP structure is utilized with all P-pictures following the I-picture. The graph 200 shows very large P-pictures being generated in a cloud gaming environment, which, depending on the difference from one picture to the next, may or may not generate a very large amount of data for the encoding of that picture. Note there are two frames in this example that are about 600 KB in frame size (marked with arrows). This size would be typical at a scene change as described herein. The encoded video in this example (also shown, e.g., in FIG. 1A) is encoded in accordance with advanced video coding (AVC) (i.e., H.264 or MPEG-4 Part 10) at a resolution of approximately 4000 pixels horizontally (i.e., 4K), at a refresh rate of about 60 Hz, and at a speed of about 85 Mbps. Since this represents extremely low latency delivery with a minimal buffer size, delivery of about 600 KB in about 16.67 milliseconds results in a spike in bandwidth of about (600,000×8)×60=288,000,000 or about 288 Mbps. The video will average over time to about 85 Mbps and depending on the buffer model of the client device, this would not pose a problem since many frames will be much smaller in size, allowing the buffer to not drain completely and rebuild on smaller size frames. Other bitrates were evaluated. In all the tested bitrates, the extreme spike in bitrate compared to the encoder bitrate from frame to frame size was the same at scene changes. Large frames were generated, for example, by changing the driver view.

FIG. 3 depicts a graph 300 of I-pictures in a cloud gaming environment with the GOP structure where the GOP size is about two seconds, in accordance with some embodiments of the disclosure. In this example, an I-picture is created and delivered to the client device every two seconds. The I-picture sizes are marked with 19 arrows, and the P-picture sizes are shown otherwise. In this example, the video is an analysis of a clip captured during a game that was processed at 1080p, 60 Hz, with AVC encoding at 10 Mbs. Note that a size of most of the I-pictures is greater than most P-pictures. I-pictures are often much larger than predicted pictures. This particular game clip also contains numerous large P-pictures as well. There are two cases near the sixth I-picture and near the ninth I-picture where the P-pictures are as large or larger than the I-picture (marked with two vertical arrows), which indicates, in this example, a scene change. This example did not include a user changing their view, e.g., the user was using the same viewpoint perspective, so this example is not as extreme as the racing game example above.

In some embodiments, video is encoded into slices and/or tiles. For example, when a very large picture occurs, an I-frame is generated in place of a large P-frame and delivered to client devices over the next few frame slots. Also, for example, AVC (or H.264), high-efficiency video coding (HEVC) (or H.265), or versatile video coding (VVC) (or H.266) is used for slicing, and HEVC or VVC is used for tiling. In some embodiments, an I-frame is generated at scene change detection points along with generation and slicing or tiling to break the delivery of the large frame into several frame time slots delivering a subset of the pictures, slices, or tiles up over the course of several frame slots. Tao Chen and Christopher Phillips, U.S. patent application Ser. No. 17/992,582, titled “Video Compression at Scene Changes for Low-Latency Interactive Experience,” filed Mar. 28, 2022, published as U.S. Patent Application Publication No. 2024/0171741 on May 23, 2024 (hereinafter “Chen '582”), covers systems and methods for optimization for the scene change detection and I-frame generation. Christopher Phillips and Tao Chen, U.S. patent application Ser. No. 18/622,467, titled “Optimized Fast Video Frame Repair for Extreme Low Latency RTP Delivery,” filed Mar. 29, 2024 (hereinafter “Phillips '467”), teaches frame repair using slicing or tiling for dropped packets resulting in a corrupt frame and late frame arrival. Chen '582 and Phillips '467 leverage slicing and tiling for sending a very large frame into slices or tiles to perform the repair over the next several frame slots for reducing the provision of a very large frame to be sent to the client device in time when there is virtually no buffer on the client device.

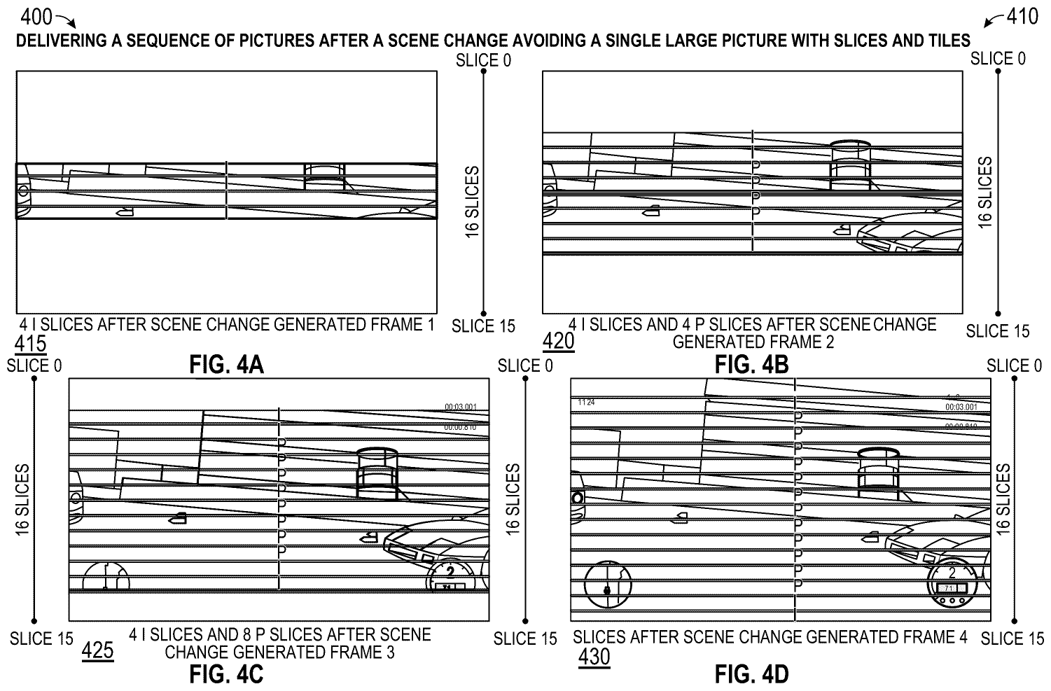

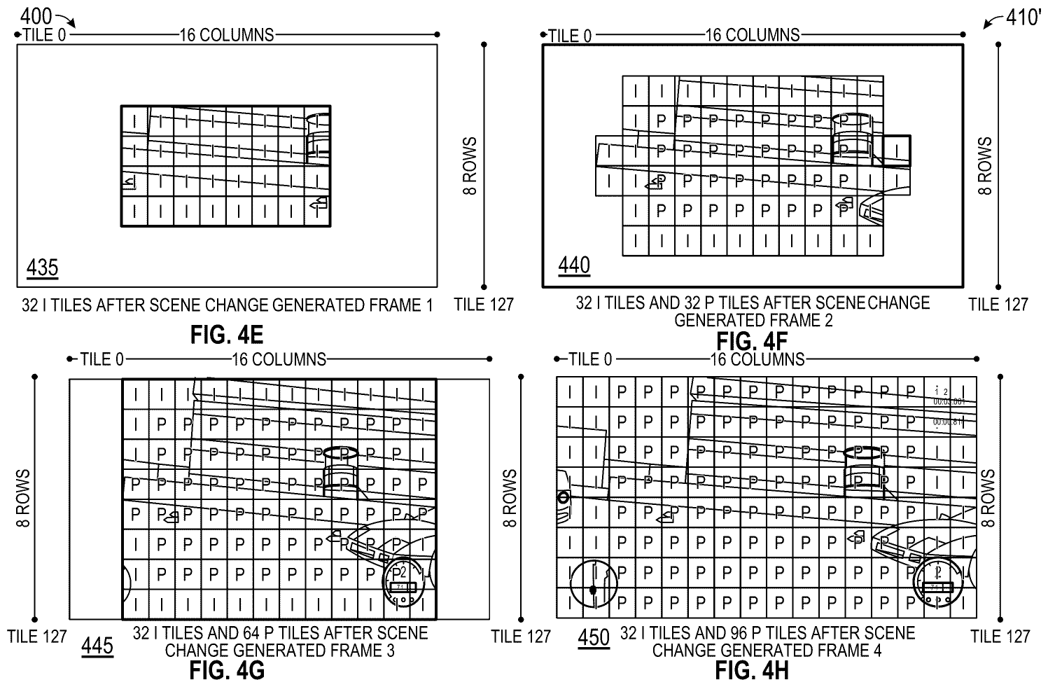

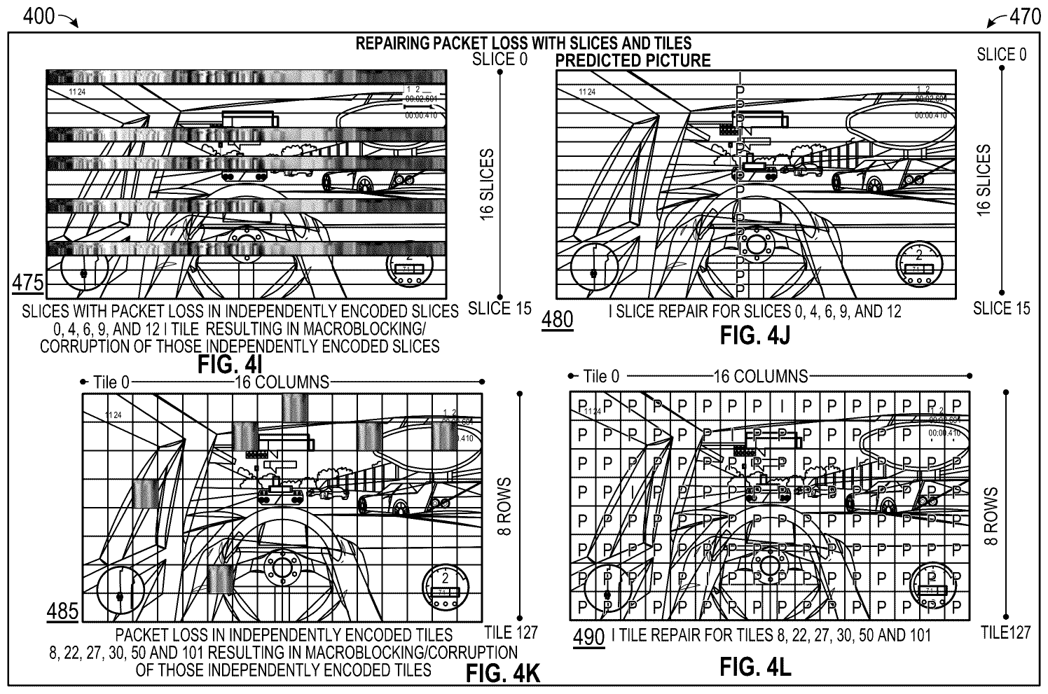

FIGS. 4A-4L include examples of how the large frame delivery and packet loss repair using slices and tiles are performed. Specifically, FIGS. 4A-4H include examples of detecting a scene change in a video encoding and controlling the large frame as taught in Chen '582, and FIGS. 4I-4L include examples of correcting packet loss as taught in Phillips '467.

FIGS. 4A-4H depict delivery pictures after a scene change (so as to avoid a large picture) by providing a sequence 410 of as many as 16 slices (FIGS. 4A-4D) or a sequence 410′ of as many as 8 rows×16 columns=128 tiles (FIGS. 4E-4H), in accordance with some embodiments of the disclosure.

FIG. 4A depicts a first generated frame 415 including four I-slices after a scene change, in accordance with some embodiments of the disclosure. In this example, all four slices are I-slices and occupy a central portion of the frame 415. FIG. 4B depicts a second generated frame 420 including four I-slices and four P-slices after the scene change, in accordance with some embodiments of the disclosure. In this example, the upper two and lower two slices are I-slices, the four slices in between are P-slices, and the I-slices and P-slices occupy a central portion of the frame 420. FIG. 4C depicts a third generated frame 425 including four I-slices and eight P-slices after the scene change, in accordance with some embodiments of the disclosure. In this example, the upper two and lower two slices are I-slices, the eight slices in between are P-slices, and the I-slices and P-slices occupy most of a central portion of the frame 425. FIG. 4D depicts a fourth generated frame 430 including four I-slices and 12 P-slices after the scene change, in accordance with some embodiments of the disclosure. In this example, the upper two and lower two slices are I-slices, the 12 slices in between are P-slices, and the I-slices and P-slices occupy an entirety of the frame 430.

FIG. 4E depicts a first generated frame 435 including 32 I-tiles after a scene change, in accordance with some embodiments of the disclosure. In this example, all 32 tiles are I-tiles and occupy a central portion of the frame 435. FIG. 4F depicts a second generated frame 440 including 32 I-tiles and 32 P-tiles after the scene change, in accordance with some embodiments of the disclosure. In this example, 32 tiles are around a periphery of a portion of the frame 435 are I-tiles, 32 tiles are at a center the portion of the frame 435 are P-tiles, and the I-tiles and P-tiles occupy a larger central portion of the frame 440. FIG. 4G depicts a third generated frame 445 including 32 I-tiles and 64 P-tiles after the scene change, in accordance with some embodiments of the disclosure. In this example, the I-tiles and P-tiles occupy all but two vertical areas on either side of the frame 445. FIG. 4H depicts a fourth generated frame 450 including 32 I-tiles and 96 P-tiles after the scene change, in accordance with some embodiments of the disclosure. In this example, two columns of tiles at either side of the frame 450 are I-tiles, 12 columns of tiles in a central portion of the frame 450 are P-tiles, and the I-tiles and P-tiles occupy an entirety of the frame 450.

FIGS. 4I-4L depict repairing packet loss with, for example, 16 slices (FIGS. 4I and 4J) or, for example, with 8 rows×16 columns=128 tiles (FIGS. 4K and 4L), in accordance with some embodiments of the disclosure. FIG. 4I depicts a frame 475 including 16 slices with packet loss in independently encoded slices 0, 4, 6, 9, and 12 resulting in macro-blocking and/or corruption of those independently encoded slices, in accordance with some embodiments of the disclosure. FIG. 4J depicts a frame 480 including 16 slices and I-slice repair for slices 0, 4, 6, 9, and 12, in accordance with some embodiments of the disclosure. In this example, the 16 slices are arranged in the following order of I-slices and P-slices: (I, P, P, P, I, P, I, P, P, I, P, P, I, P, P, and P). FIG. 4K depicts a frame 485 including 128 tiles with packet loss in independently encoded I-tiles 8, 22, 27, 30, 50, and 101 resulting in macro-blocking and/or corruption of those independently encoded tiles, in accordance with some embodiments of the disclosure. FIG. 4L depicts a frame 490 including 128 tiles and I-tile repair for I-tiles 8, 22, 27, 30, 50, and 101, in accordance with some embodiments of the disclosure.

In some embodiments, further optimizations are made in the delivery of the packets from the server to the client over the network for enabling large frames to be delivered to the client faster and more reliably. For example, optimized packet delivery with L4S is provided. Christopher Phillips, Dhananjay Lal, and Reda Harb, U.S. patent application Ser. No. 18/626,659, titled “Application-Flow Aware Broadband Service with Data Caps,” filed Apr. 4, 2024 (hereinafter “Phillips '659”), proposes imposing data caps to prevent application providers from enabling all packet flows to be L4S capable. Christopher Phillips, Dhananjay Lal, and Reda Harb, U.S. Provisional Patent Application No. 63/574,668, titled “Intelligent Application Priority Packet Delivery Control,” filed Apr. 4, 2024, and Christopher Phillips, Dhananjay Lal, and Reda Harb, U.S. patent application Ser. No. 18/667,655, titled “Intelligent Application Priority Packet Delivery Control,” filed May 17, 2024, include systems and methods for various applications to enable and disable L4S, based, for example, on low latency within the applications covering cloud video gaming, cloud-based SLAM, video conferencing, remote vehicle control, gambling, and the like. In some embodiments, an explicit congestion notification (ECN) packet is marked in an IETF definition by marking a packet with a binary codepoint and codepoint name meaning at least one of not ECN-capable transport, L4SL4S-capable transport, ECN-capable transport, congestion experienced, or the like.

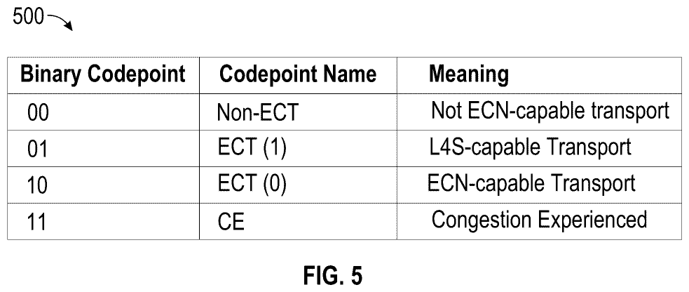

FIG. 5 depicts a table 500 representing marking of an ECN packet, in accordance with some embodiments of the disclosure. For example, a packet is marked with codepoint name ECN-capable transport (ECT)(1) using a binary codepoint setting of 01 to identify the packet as L4S-capable transport. FIG. 5 contains information on ECN in computer networking. An ECN-capable AQM marks a packet as congestion experienced (CE) instead of dropping it when congestion is detected. This leads to a considerable reduction in packet loss but a less significant latency reduction compared to a packet-dropping AQM. L4S is an evolution of ECN. It dedicates one of the ECN codepoints, ECT(1), specifically for L4S traffic. The table 500 in FIG. 5 lists binary codepoints for ECN as follows:

| | | |
|---|---|---|
| 00: | Non-ECT | Not ECN-capable transport, |
| 01: | ECT(1) | L4S-capable transport, |
| 10: | ECT(0) | ECN-capable transport, and |
| 11: | CE | Congestion Experienced. |

In some embodiments, an RTP video sender and/or delivery system is provided for low- to ultralow-latency use cases to selectively mark transport packets that encapsulate a PES as high priority based on a frame size. If the number of transport packets to encapsulate and transport a picture or PES packet is beyond a threshold, the transport packets that transport the large, encoded picture to the client device will be L4S-enabled. If the number of transport packets to deliver a picture are below a threshold, the packets will not be L4S-enabled.

In addition to packets for an entire picture, large tiles and slices may be determined to be above a certain threshold size. Again, this will be determined by the number of transport packets encapsulating the PES packet for the picture, slices or tiles for delivering the picture, slice or tile. For transport packets transporting the large picture, tile, or slice data, L4S will be enabled. If the number of transport packets to deliver a picture, slice or tile data is below a threshold number, L4S will be disabled for the transport packets encapsulating that slice or tile data.

In some embodiments, both sender and receiver maintain separate transport buffers so that packets received via L4S and non-L4S paths and/or channels can be re-sequenced prior to demultiplexing and decoding. Further, for example, the sender and receiver may maintain and report packet statistics for L4S and non-L4S paths separately (e.g., RTCP sender reports, receiver reports, congestion control packets, and the like). For example, a target bitrate for the encoder is set based on a weighted average of the target bitrates estimated for the packets traversing L4S and non-L4S paths.

Further, an embodiment is provided in which the sender can temporally enable L4S when the non-L4S channel and/or path degrades and reverts back if the non-L4S channel and/or path recovers.

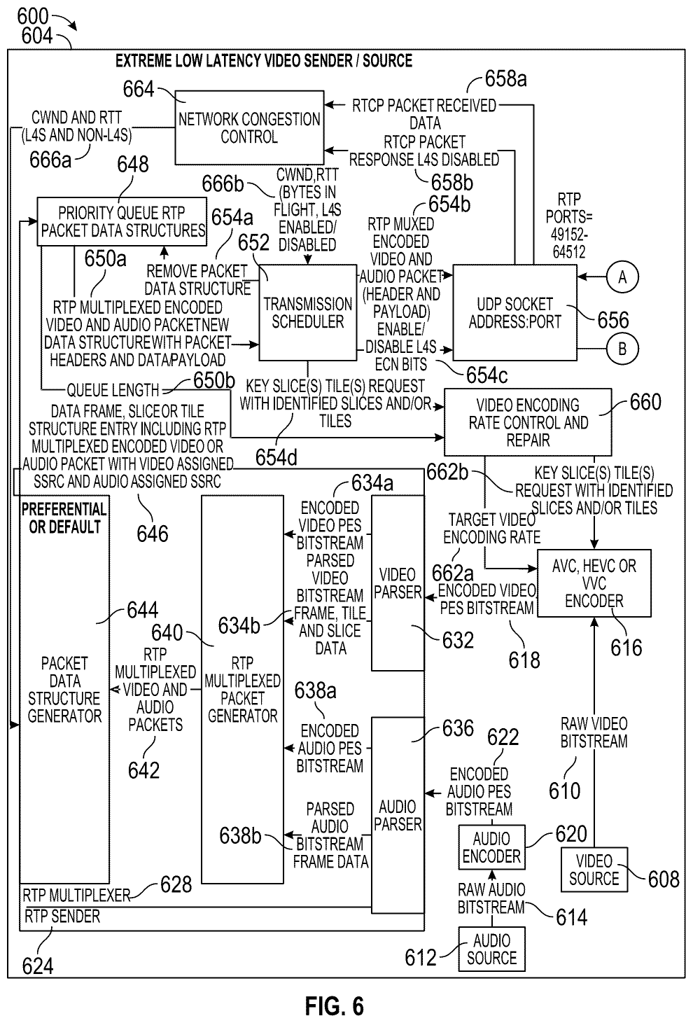

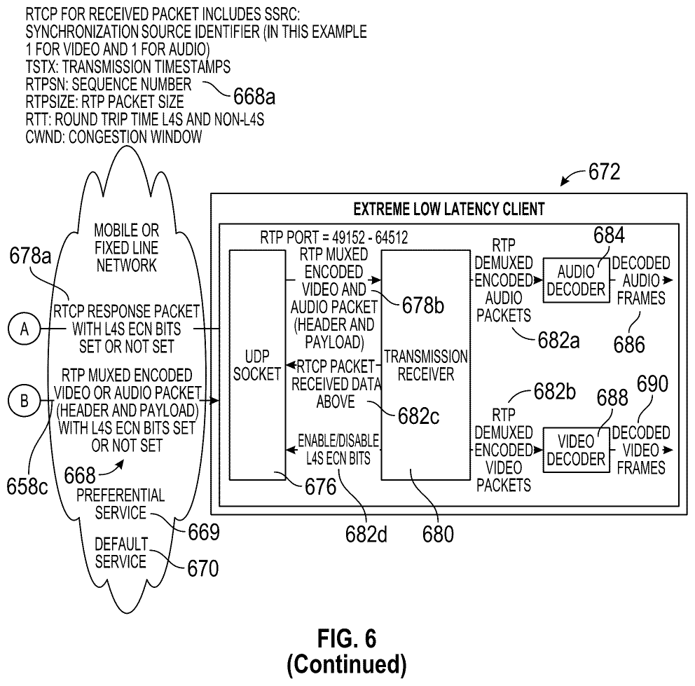

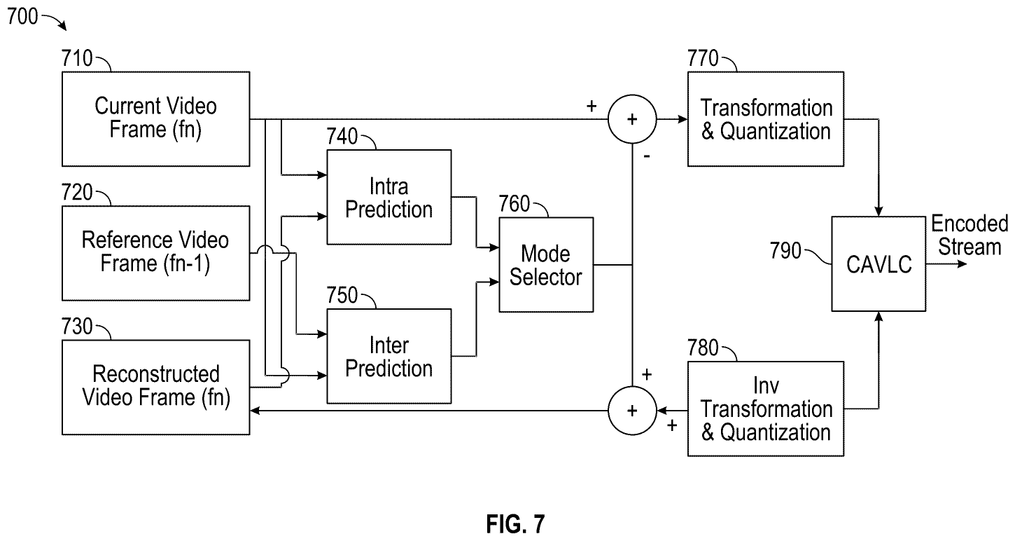

FIG. 6 depicts a system 600 for prioritized frame, slice, and/or tile delivery, in accordance with some embodiments of the disclosure. For example, the system 600 has an architecture for low latency RTP delivery where an RTP sender (e.g., 624) contains a video parser (e.g., 632) to parse a PES stream for frame, slice, and/or tile data. The video parser sends an RTP multiplexer (e.g., 628) parsed PES bitstream frame, slice, and/or tile data for identifying exactly the video specifics (frames, slices, and/or tiles) contained in the PES packet based on packet offsets within the PES packet. In some examples, an entire frame is contained in a single PES packet. As shown in FIGS. 7, 8, and 9, for example, an RTP multiplexer generates data structures with data (details herein). Within the data structure is a priority marker that is set based on a threshold number of RTP packets (e.g., 1500 byte RTP packets) for transmitting the frame, slice or tile data. The priority queue is, for example, a transmission priority queue of the data structures defined in FIGS. 7, 8, and 9. When it is time to transmit a packet, a transmission scheduler (e.g., 652) retrieves the first packet in the transmission priority queue and extracts the RTP packet data, header+payload data, and parses the data structure for the priority flag. If the priority flag is set to 1, the user datagram protocol (UDP) socket (e.g., 656) is set to L4S-enabled, and the RTP packet will have the ECN/ECT set to ECT(1) or 01 when it is transmitted over the UDP port to the client device (e.g., 672). This setting will increase the priority of the packet in all networking equipment from the source of the packet to the client device, provided all network equipment the packet passes through to the client device supports L4S. When the client device receives the L4S-enabled RTP packet, the RTP receiver on the client device will enable L4S of the UDP socket, and the RTCP packet sent from the client device to the server will have the ECN bits/ECT set to ECT(1) or 01.

If the priority flag is set to 0, the UDP socket is set to L4S-disabled, and the RTP packet will have the ECN set to 00 when it is transmitted over the UDP port to the client device. When the client device receives the L4S-disabled RTP packet, the RTP receiver on the client device will disable L4S of the UDP socket, and the RTCP packet sent from the client device to the server will have the ECN bits set to 00.

In a general scenario, when the RTP sender sends an RTP packet to the client device with the ECT(1) set identifying the packet is LAS-enabled, and receives a response with ECN set to 00, it may be because at least one hop along the route includes network equipment that does not support L4S. In this case, future RTP packets will have the ECN bits set to 00 regardless of the number of packets making up the frame, slice or tile. That is, for example, as soon as the sender receives a response packet with ECN bits missing or the packet that was sent to the client was L4S-enabled but the response was ECN 00 or 10, it may be assumed that at least one hop along the way does not support L4S and either the ECN bits were dropped or the L4S markings were changed. In this circumstance, future L4S packets are not marked.

In some embodiments, the system 600 of FIG. 6 includes, for example, an extreme low latency video sender and/or source 604 and an extreme low latency client 672. For example, the source 604 and the client 672 communicate across a mobile or fixed line network 668.

In some embodiments, the source 604 includes at least one of a video source 608, an audio source 612, an AVC, HEVC, or VVC encoder 616, an RTP sender 624, an RTP multiplexer 628, priority queue RTP packet data structures 648, a transmission scheduler 652, a UDP socket (e.g., at address: port) 656, video encoding rate control and repair 660, network congestion control 664, combinations of the same, or the like.

In some embodiments, the RTP sender 624 includes at least one of an RTP multiplexer, a video parser 632, an audio parser 636, an RTP multiplexed packet generator 640, a packet data structure generator 644, combinations of the same, or the like.

In some embodiments, the mobile or fixed line network 668 includes at least one of a preferential service 669 (e.g., L4S), a default service 670 (e.g., non-L4S), combinations of the same, or the like.

In some embodiments, the video source 608 sends a raw video bitstream 610 to the AVC, HEVC, or VVC encoder 616. For example, the AVC, HEVC, or VVC encoder 616 sends an encoded video PES bitstream 618 to the RTP sender 624, the RTP multiplexer, or the video parser 632. Also, for example, the video parser 632 sends an encoded video PES bitstream 634a to the RTP multiplexed packet generator 640. Further, for example, the video parser 632 sends parsed video bitstream frame, tile, and slice data 634b to the RTP multiplexed packet generator 640.

In some embodiments, the audio source 612 sends a raw audio bitstream 614 to the audio encoder 620. For example, the audio encoder 620 sends an encoded audio PES bitstream 622 to the RTP sender 624, the RTP multiplexer, or the audio parser 636. Also, for example, the audio parser 636 sends an encoded audio PES bitstream 638a to the RTP multiplexed packet generator 640. Further, for example, the audio parser 632 sends parsed audio bitstream frame data 638b to the RTP multiplexed packet generator 640.

In some embodiments, the RTP multiplexed packet generator 640 sends RTP multiplexed video and audio packets 642 to the packet data structure generator 644. For example, at least one of the RTP multiplexer 628, the packet data structure generator 644, or the like determines whether a packet satisfies a condition or not. Also, for example, the at least one of the RTP multiplexer 628, the packet data structure generator 644, or the like sends data frame, slice, or tile structure entry 646 for the priority queue RTP packet data structures 648. Further, for example, the data frame, slice, or tile structure entry 646 includes RTP multiplexed and an encoded video and/or audio packet, e.g., with a video assigned synchronization source identifier (SSRC) and an audio assigned SSRC.

In some embodiments, the priority queue RTP packet data structures 648 produce an RTP multiplexed encoded video and/or audio packet new data structure 650a. For example, the new data structure 650a includes packet headers and data and/or payload information. Also, for example, the RTP multiplexed encoded video and/or audio packet new data structure 650a is sent to the transmission scheduler 652. Further, for example, the priority queue RTP packet data structures 648 produce a queue length 650b, which is sent to the video encoding rate control and repair 660.

In some embodiments, the transmission scheduler 652 sends a command 654a to remove the packet data structure from the priority queue RTP packet data structures 648. For example, the transmission scheduler 652 sends an RTP muxed encoded and video and audio packet (e.g., including a header and payload information) to the UDP socket 656 (throughout the disclosure, for convenience, “‘muxed’ and the like” is short for “multiplexed and the like”). Also, for example, the transmission scheduler 652 sends enable and/or disable L4S ECN bits 654c to the UDP socket 656. Further, for example, the transmission scheduler 652 sends a key slice(s) and/or tile(s) request 654d with identified slices and/or tiles to the video encoding rate control and repair 660.

In some embodiments, the UDP socket 656 is assigned one of RTP ports 49152-64512. For example, the UDP socket 656 sends RTCP packet received data 658a to the network congestion control 664. Also, for example, RTCP for the received packet 668a includes at least one of an SSRC (e.g., in this example, one SSRC for video, and one SSRC for audio), a transmission timestamp (TSTX), an RTP sequence number (RTPSN), an RTP packet size (RTPsize), a round trip time (RTT) (e.g., for L4S and/or for non-L4S), a congestion window (CWND), combinations of the same, or the like. Further, for example, the UDP socket 656 sends an RTCP packet response of L4S-disabled 658b to the network congestion control 664. Still further, for example, the UDP socket 656 sends an RTP muxed encoded video and/or audio packet (e.g., with header and payload) with L4S ECN bits set or not set 658c to the client 672 across the network 668.

In some embodiments, the video encoding rate control and repair 660 sends a target video encoding rate 662a to the AVC, HEVC, or VVC encoder 616. Also, for example, the video encoding rate control and repair 660 sends a key slice(s) and/or tile(s) request 662b with identified slices and/or tiles to the AVC, HEVC, or VVC encoder 616.

In some embodiments, the network congestion control 664 sends CWND and RTT (e.g., L4S and non-L4S) 666a to the packet data structure generator 644. For example, the network congestion control 664 sends CWND and RTT (e.g., bytes in flight, L4S-enabled, and L4S-disabled) 666b to the transmission scheduler 652.

In some embodiments, the client 672 includes at least one of a UDP socket 676, a transmission receiver 680, an audio decoder 684, a video decoder 688, combinations of the same, or the like. For example, the UDP socket 676 (e.g., utilizing RTP port=49152-64512) receives the RTP muxed encoded video and/or audio packet (e.g., with header and payload) with L4S ECN bits set or not set 658c from the UDP socket 656 via the network 668. Also, for example, the UDP socket 676 sends an RTCP response packet 678a, for example, with L4S ECN bits set or not set to the UDP socket 656 across the network 668. Further, for example, the UDP socket 676 sends an RTP muxed encoded video and/or audio packet 678b (e.g., including header and payload information) to the transmission receiver 680.

In some embodiments, the transmission receiver 680 sends RTP demuxed encoded audio packets 682a to the audio decoder 684. For example, the transmission receiver 680 sends RTP demuxed encoded video packets 682b to the video decoder 688. Also, for example, the transmission receiver 680 sends RTCP packet received data 682c (see, the description of the RTCP for received packet 668a above) to the UDP socket 676. Further, for example, the transmission receiver 680 sends enable and/or disable L4S ECN bits 682d to the UDP socket 676. Still further, the audio decoder 684 sends decoded audio frames 686 to an audio output device (not shown) of the client 672. Moreover, the video decoder 688 sends decoded video frames 690 to a video output device (not shown) of the client 672.

In some embodiments, the system 600 provides granular preferential (e.g., L4S) and default (e.g., non-L4S) control with the above-referenced structures 624, 628, 632, 636, 640, 644, 648, and 660, and with the above-referenced data 634b, 638b, 650a, 654a, 654c, 654d, 658c, 666a, 666b, and 678a.

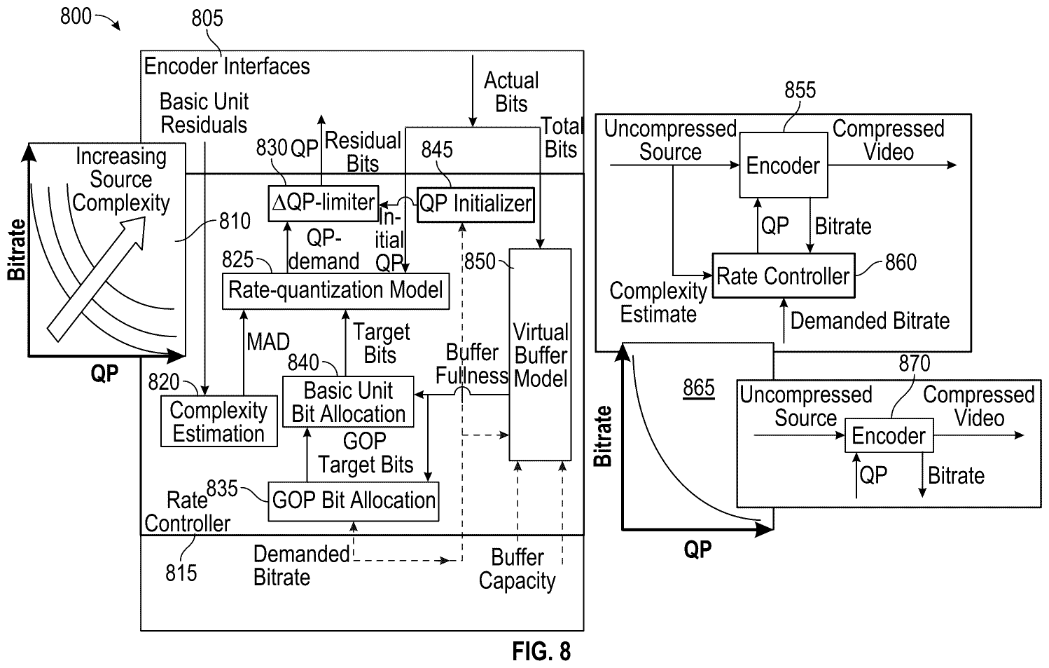

In some embodiments, as shown, for example, in FIG. 6, two rate controllers are provided, e.g., a rate controller of the AVC, HEVC, or VVC encoder 616, and, independently and separately, a rate controller of the video encoding rate control and repair 660. For example, the rate controller is built into the video encoder 616. FIG. 7 depicts an architecture of a video encoder 700 (e.g., 616) for the system 600 of FIG. 6, in accordance with some embodiments of the disclosure. FIG. 8 depicts an architecture of a rate controller 800 within the video encoder 700 of FIG. 7, in accordance with some embodiments of the disclosure.

In some embodiments, the encoder 700 encodes a video at a set quantization parameter (QP). The QP is an index that controls an amount of compression for each macroblock in a frame in an encoder. Larger values of QP mean higher quantization, more compression, and lower quality, while smaller values mean the opposite. The QP values range, for example, from 0 to 51, and any value above 51 is clamped to 51. When an encoder is set to encode at a fixed QP value, the size of each picture can vary widely based on the difference from one picture to the next. The same goes for the size of the slices or tiles.

In some embodiments, the encoder 700 includes at least one of a current video frame (fn) 710, a reference video frame (fn−1) 720, a reconstructed video frame (fn) 730, an intra prediction module 740, an inter prediction module 750, a mode selector 760, a transformation and quantization module 770, an inverse transformation and quantization module 780, a context-adaptive variable-length coding (CAVLC) module 790 that outputs an encoded stream, combinations of the same, or the like. For example, a video encoding process with the encoder 700 starts with the current video frame (fn) 710 and the reference video frame (fn−1) 720. The current video frame 710 is the one being encoded, while the reference video frame 720 is typically a previously encoded frame. The intra prediction module 740 and the inter prediction module 750 work together to predict the current frame based on the reference frame. Intra prediction works within the same frame, predicting parts of the image based on other parts within the same frame. Inter prediction, on the other hand, predicts the current frame based on data from the reference frame. The mode selector 760 then decides whether to use intra or inter prediction for each block of pixels in the frame, based on, for example, which method provides the best compression. The selected prediction is then subtracted from the original frame to create a residual frame, which is passed to the transformation and quantization module 770. This module transforms the residual frame into the frequency domain and quantizes it, reducing the precision of the data to save space. The quantized data is then passed to the inverse transformation and quantization module 780, which reverses the previous step, creating a reconstructed video frame (fn) 730. This frame 730 is used as the reference frame for the next frame to be encoded. Finally, the quantized data is encoded into a bitstream by the context-adaptive variable-length coding (CAVLC) module 790. The module 790 uses variable-length codes, which assign shorter codes to more common patterns of data, further compressing the video. The output is an encoded stream that can be efficiently transmitted or stored. The process associated with the encoder 700 provides high-quality video at low bit rates.

The rate controller 800 as shown in FIG. 8, for example, adjusts the QP value dynamically based on the encoded pictures and their sizes. It does this using a virtual buffer model 850 that maintains the average bitrate within scope of the set bitrate. The encoder may be set to encode at a constant bitrate or a capped virtual bitrate. In either case, the bitrate should not exceed the set bitrate. This bitrate averages out over time based on the virtual buffer model 850. The buffer models for video encoders are typically not adjustable and are fixed within the encoder. In the background information, there were frames that were very large in size and many frames that were smaller in size. This variance in frames is a prime example of how the rate controller cannot make QP adjustments in time to adjust each frame size to be within the size of the encoded bitrate and will average out to the target bitrate over the course of time as modeled in the virtual buffer model 850 within the encoder's rate controller 800.

The previous description of the encoder's rate controller 800 is distinguished from the rate controller in the RTP delivery system, e.g., the rate controller of the video encoding rate control and repair 660. The rate controller in the RTP delivery system controls the bitrate based on the priority queue to the encoder. This rate controller is different from the encoder's rate controller and is external to the encoder. The RTP delivery system makes application programming interface (API) calls to change the encoder's target bitrate based on the priority queue size.

In some embodiments, the controller 800 includes at least one of an encoder interface 805, a rate controller module 815, a complexity estimation unit 820, a rate quantization model 825, a ΔQP-limiter 830, a GOP bit allocation unit 835, a basic unit bit allocation unit 840, a QP initializer 845, a virtual buffer model 850, combinations of the same, or the like. Increasing source complexity 810 refers to QP versus bitrate, where bitrate decreases as QP increases. One or more portions of the controller 800 may be operatively connected with at least one of an encoder 855 and a rate controller 860, or an encoder 870.

The controller 800 includes several modules that work together to manage the quality and bitrate of the encoded video. The encoder interface 805 serves as the communication link between the controller 815 and an encoder (e.g., 855). The encoder interface 805 receives information about the video from the encoder and sends back the decisions made by the rate controller 815. The rate controller module 815 manages the overall bitrate of the video. It uses information from the complexity estimation unit 820, which measures the complexity of the video and outputs, e.g., a mean absolute distance (MAD), and the rate quantization model 825, which models the relationship between the QP and the bitrate and outputs, e.g., QP-demand. The AQP-limiter 830 ensures that the QP does not change too rapidly from frame to frame and outputs, e.g., QP. The GOP bit allocation unit 835 and the basic unit bit allocation unit 840 work together to allocate bits to different parts of the video. The GOP unit 835 allocates bits to groups of pictures (GOPs). For example, the GOP unit 835 receives a demanded bitrate and outputs GOP target bits. The basic unit 840 allocates bits within each picture. For example, the basic unit 840 receives the GOP target bits from the GOP unit 835 and buffer fullness from the virtual buffer model 850 and outputs target bits. The QP initializer 845 receives the demanded bitrate and sets the initial QP for each picture based on the target bitrate and the estimated complexity. The virtual buffer model 850 receives a buffer capacity and keeps track of the buffer fullness and adjusts the QP to prevent the buffer from overflowing or underflowing. The controller 800 is designed to control increasing source complexity 810, where the bitrate decreases as the QP increases. This is managed by the rate controller module 815 and the rate quantization model 825, which adjust the QP to maintain a constant bitrate despite the increasing complexity. The controller 800 may be operatively connected with at least one of an encoder 855, which receives the uncompressed source and QP and outputs a bitrate and compressed video, and a rate controller 860 when a complexity estimate is provided to the rate controller 860 based on the uncompressed source. Once the bitrate is set, the controller 800, which is connected to an encoder 870, receives the uncompressed source and QP and outputs a bitrate and compressed video. That is, the controller 800 controls the encoding process and manages the bitrate of the video. The process for controller 800 provides high-quality video at a controlled bitrate.

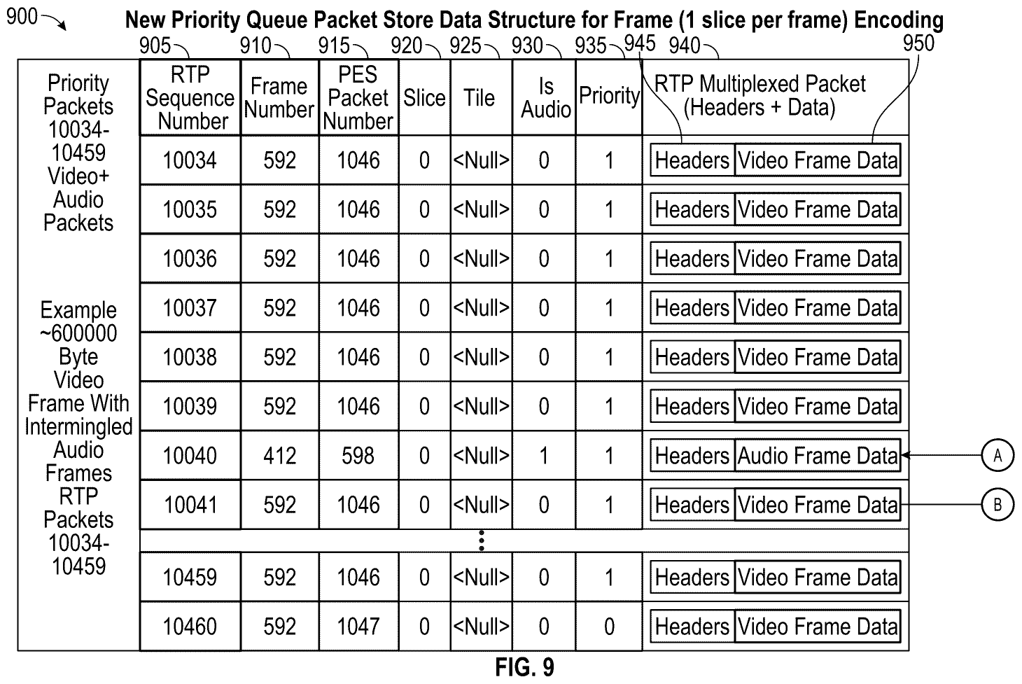

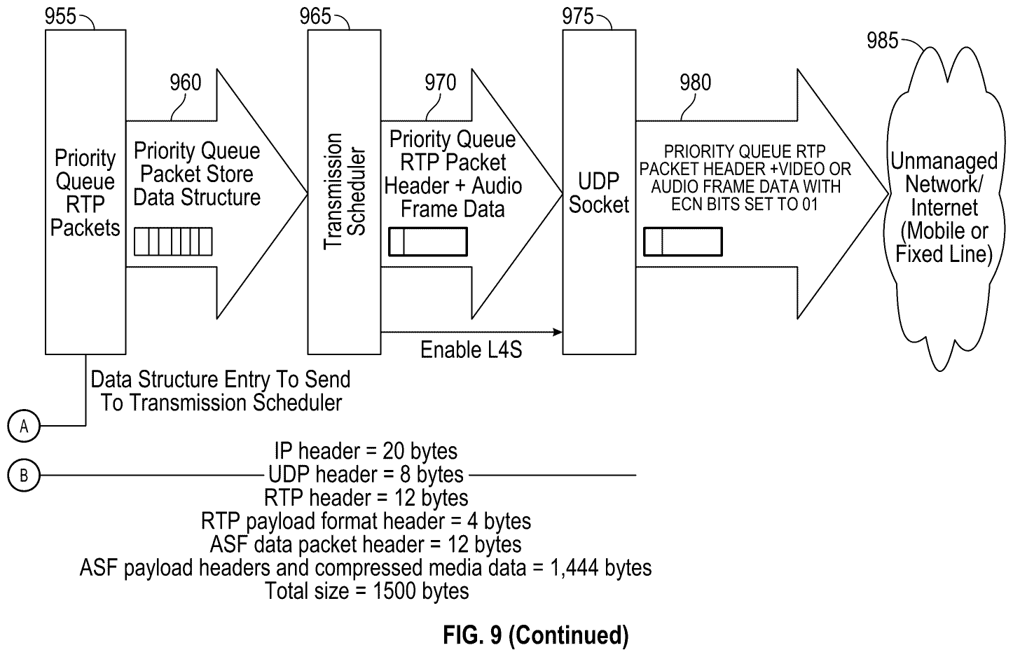

FIG. 9 depicts an example priority queue 900 with data structure entries for RTP packets within a frame where there is one slice per frame, in accordance with some embodiments of the disclosure. For example, the example priority queue 900 includes the data structure, which identifies what data is included in the RTP multiplexed packet. Also, for example, the priority queue 900 includes at least one of an RTP sequence number 905, a frame number 910, a PES packet number 915, a slice indicator 920, a tile indicator 925, an audio indicator 930, a priority indicator 935, an RTP multiplexed packet 940 including, e.g., headers 945 and video frame data 950, combinations of the same, or the like. In RTP transport, for example, there is an SSRC for video and audio. This data structure includes the RTP sequence number 905, which is also included in the RTP packet header 945; the frame number 910 for the video or audio; the PES packet number 915, which, e.g., for the video PES will be the same PES packet for the frame; the slice number 920, which, for example, will be 0 if the video is encoded with one slice per frame; the tile 925, which, for example, will be null when tiles are not in use; the audio indicator 930 flag for identifying whether the RTP packet is transporting audio data; the priority indicator 935 flag, which indicates if the packet should be L4S-enabled or not; and the 1500 byte RTP multiplexed packet 940 including headers 945 and payload data, e.g., the video frame data 950. In this example, one slice per frame is provided and the tile 925 data is null, so the RTP packets are prioritized at the frame level. The priority 935 flag is set for all video and audio packets from the first RTP packet for the video frame data to the last packet for the video frame data and all interleaved audio packets for that video frame.

In some embodiments, the queue 900 includes at least one of a priority queue of RTP packets 955, a priority queue store data structure 960, operations with a transmission scheduler 965, a priority queue RTP packet header including audio frame data 970, operations with a UDP socket 975, a priority queue RTP packet header including audio frame data with ECN bits set to 01 980, operations with an unmanaged network and/or internet connection (e.g., mobile or fixed line) 985, combinations of the same, or the like. For example, the priority queue of RTP packets 955 includes a data structure entry for the RTP multiplexed packet 940, and the structure 960 is sent to the transmission scheduler 965. Also, for example, the transmission scheduler 965 enables L4S at the UDP socket 975 by sending the data 970. The UDP socket 975 sends the priority queue RTP packet header and audio frame data 980 to the network 985. In FIG. 9, the example refers to priority packets numbered from 10034 to 10469 including video and audio packets. Each packet may include, for example, about 600,000 bytes of data for a video frame with intermingled audio frames for the RTP packets 10034 to 10459. In some examples, each packet may include less than about 65,536 bytes of data; the size depends on at least one of resolution, bitrate, encoding complexity, frame encoding type, combinations of the same, or the like. Also, for example, the IP header may be about 20 bytes, the UDP header may be about 8 bytes, the RTP header may be about 12 bytes, the RTP payload format header may be about 4 bytes, the advanced systems format (ASF) data packet header may be about 12 bytes, the ASF payload of headers and compressed media data may be about 1,444 bytes, and the total size may be about 1,500 bytes.

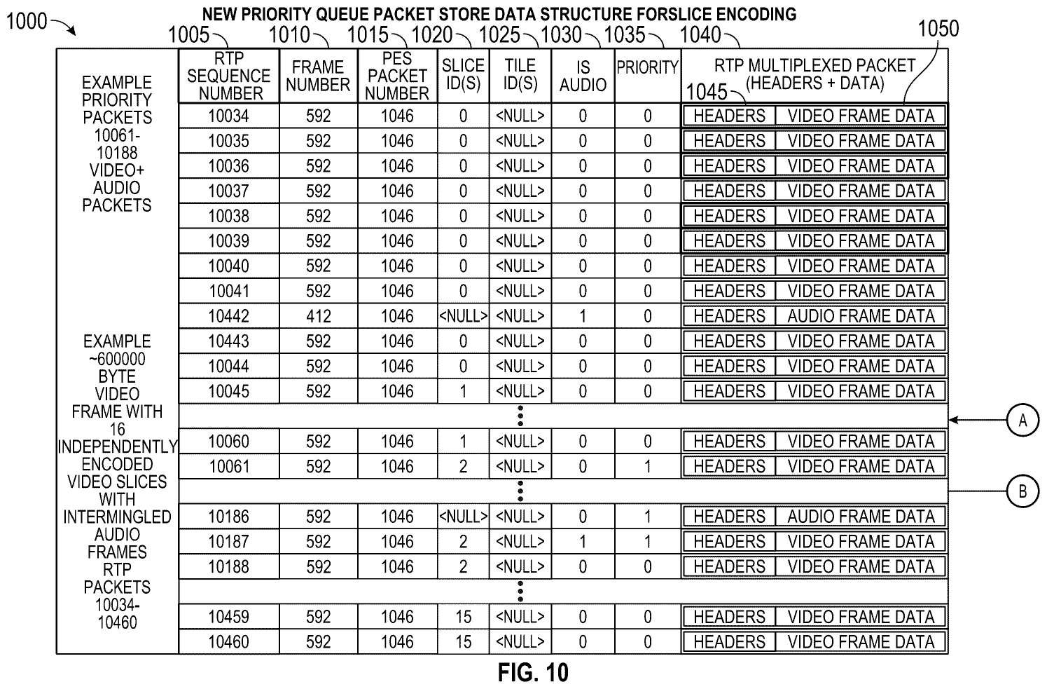

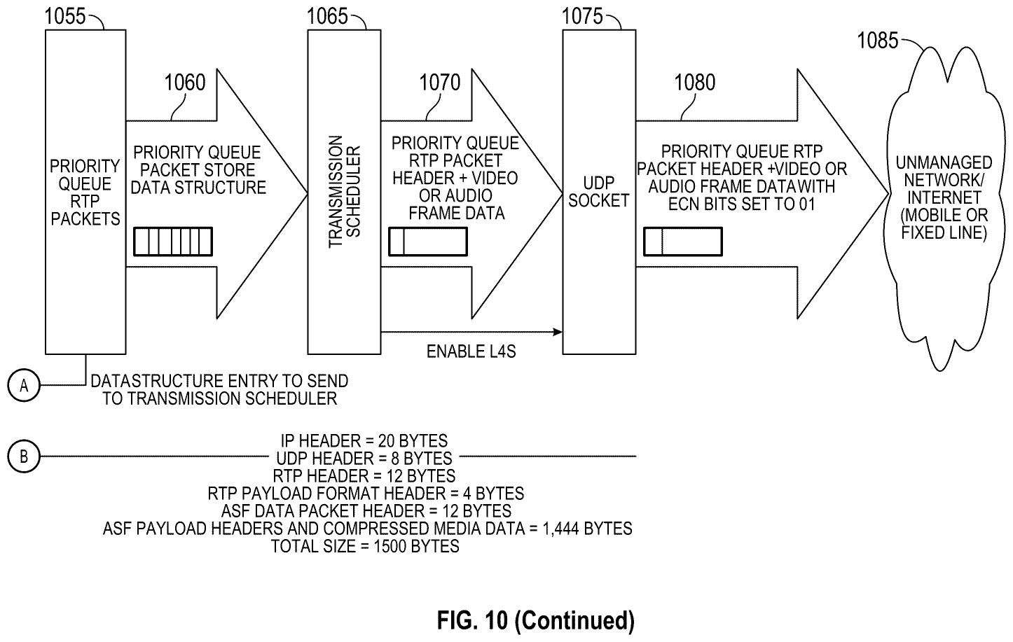

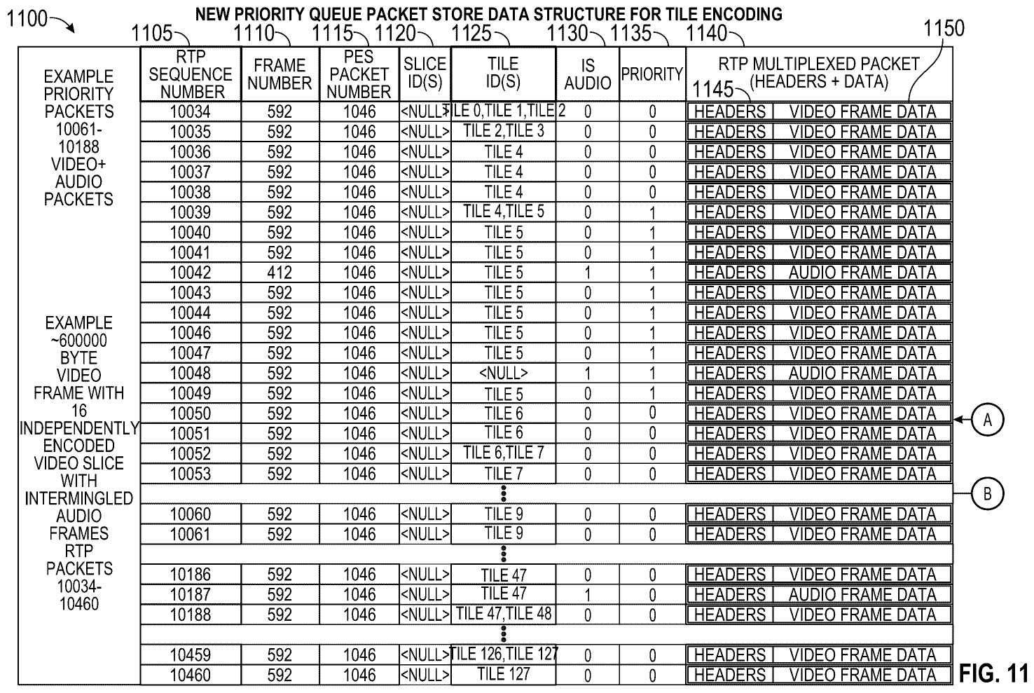

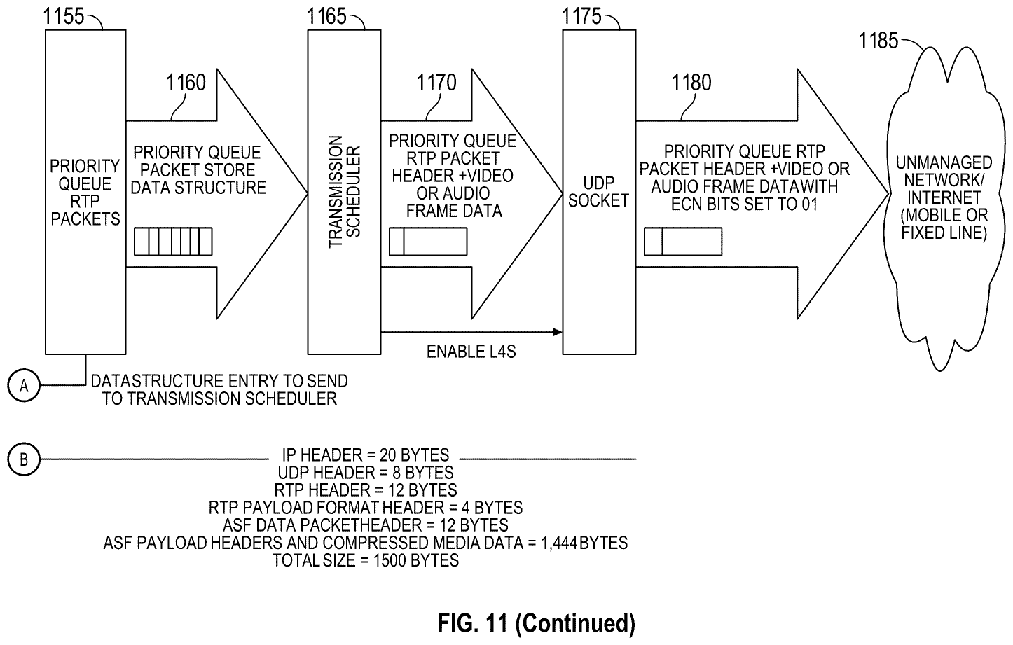

FIGS. 10 and 11 include features similar to those depicted in FIG. 9. Where the last two digits of a reference in FIG. 9 match those of FIG. 10 or FIG. 11, the descriptions may be identical and are omitted for brevity.

FIG. 10 is an example priority queue 1000 where there are multiple slices (e.g., 16, numbered 0 to 15, inclusive) per frame, in accordance with some embodiments of the disclosure. Since this is an example of multiple independently encoded slices within a frame and the tile data 1025 is null, this is controlled as prioritizing the RTP packets at the slice level. Based on the number of RTP packets for encapsulating a slice, the priority flag 1035 may be set to 1 or 0 based on a threshold size of RTP packets for that slice. As the example of FIG. 10 shows, slice 0 is encapsulated in 10 RTP packets (numbered 10034 to 10044) with one audio packet (number 10042) interleaved. Since this is below a higher threshold size, the priority flag 1035 is set to 0 for all of these RTP packets. Since slice 1 has only 15 RTP packets (numbered 10045 to 10060) with possible interleaved audio packets, which are also below the threshold, the priority indicator 1035 for those packets will also be set to 0. Moving on to slice 2, the number of RTP video packets and possible audio interleaved packets is 127 packets (numbered 10061 to 10188), which is above the threshold value. Therefore, the priority flag 1035 is set to 1 for the slice 2. The same is applied for the remaining 13 slices (having RTP sequence numbers 10189 (not shown) to 10460).

It is noted that slices or tiles can be of different sizes, e.g., varying numbers of macroblocks included in slices or tiles in a same frame. The different sizes have an impact of the bits per slice or tile, and thus the number of packets. In some embodiments, the threshold is adaptive, considering the importance per defined unit, e.g., 16×16 or 32×32 pixels. The unit is, for example, encapsulated into multiplexed RTP packets. The threshold of RTP packets may be adaptive or hard coded. The threshold of RTP packets may be adaptive based on the RTT and also based on the encoded bitrate.

FIG. 11 depicts an example queue with data structure entries for RTP packets for a frame where there are 128 independently encoded tiles per frame, in accordance with some embodiments of the disclosure. Since this is an example of multiple independently encoded tiles within a frame and the slice data 1120 is null; there will be slices included but the slices are not leveraged in this scenario. Rather, in this example, RTP packets are prioritized strictly at the tile level. Based on the number of RTP packets for encapsulating a tile, the priority flag 1135 may be set to 1 or 0 based on a threshold size of RTP packets for that tile. As the example herein shows, tiles 0, 1 and 2 (see 1125) are encapsulated in one RTP packet numbered 10034. Since one packet encapsulates the data for the first two tiles and partial data for a third tile, the priority 1135 is set to 0 for that packet since one packet for the tile is below the packet threshold number for the encapsulated tiles. The next RTP packet, numbered 10035, contains partial data for tile 2 and also encapsulates tile 3. Again, this number of packets is a threshold value to represent a tile or a set of tiles. The same applies to tile 4, which is encapsulated in RTP packets numbered 10036, 10037, 10038, and a first portion of 10039. Packet number 10039 also encapsulates the final bits for tile 4 but also includes the starting bits for tile 5. Tile 5 is also encapsulated in the following RTP packets: a second portion of number 10039, numbers 10040 through 10047, and 10049. This tile is above the tile packet threshold value to encapsulate the tile data for a tile, and therefore all packets that encapsulate tile 5 along with any interleaved audio packets will have the priority flag 1135 set to 1. These data entries will either have the priority 1135 set or not, based on the number of packets to encapsulate a tile for all entries for a frame. In this example, there are 128 tiles (16 columns×8 rows) as used to create the frame as in the examples herein.

It is noted that by assigning different priorities to the tiles in a same frame, varying availability of tile streams for decoding the frame may be provided in some examples. In some examples, prioritization (e.g., L4S or non-L4S) is provided for all tiles for the frame, which is an optimization for the management of L4S-enabled packets while still providing an added benefit. For example, L4S/non-L4S prioritization provided for all tiles for the frame is provided in combination with one or more systems and methods described and incorporated herein regarding scene changes, dropped packet repair and/or late frame arrival repair. Also, for example, L4S/non-L4S prioritization for tiles for the frame provides an improvement over not using L4S at all and at the same time conserves L4S usage. In some embodiments, RTT, for example, is a basis for determining a threshold of when to enable and disable L4S. In some embodiments, tile or slice types, e.g., intra or inter, indicate an importance that leads to a difference in the eventual video quality.

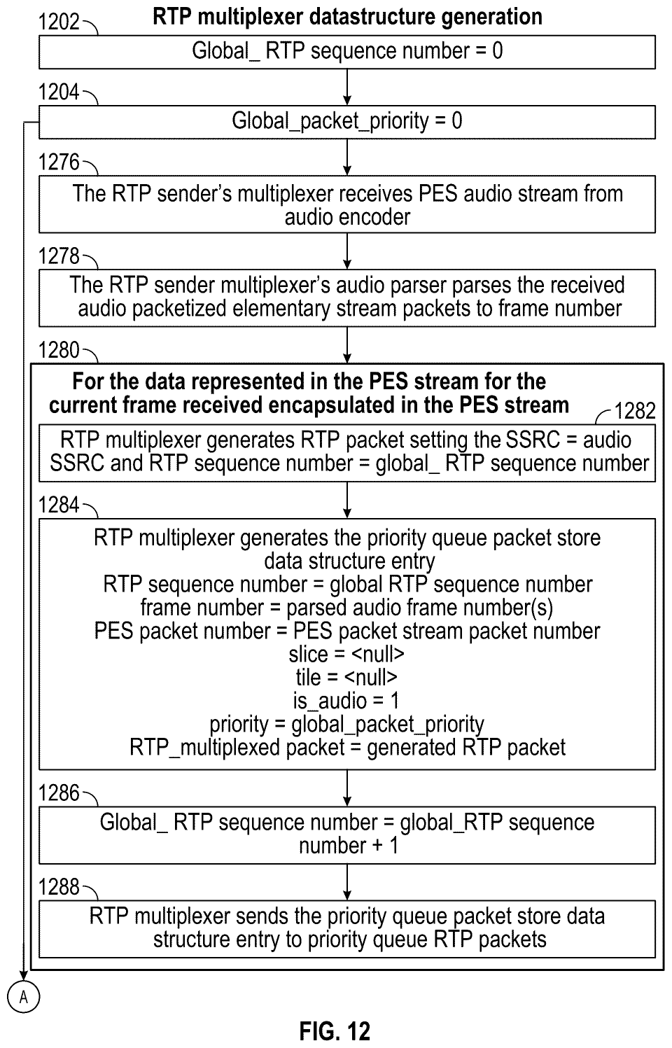

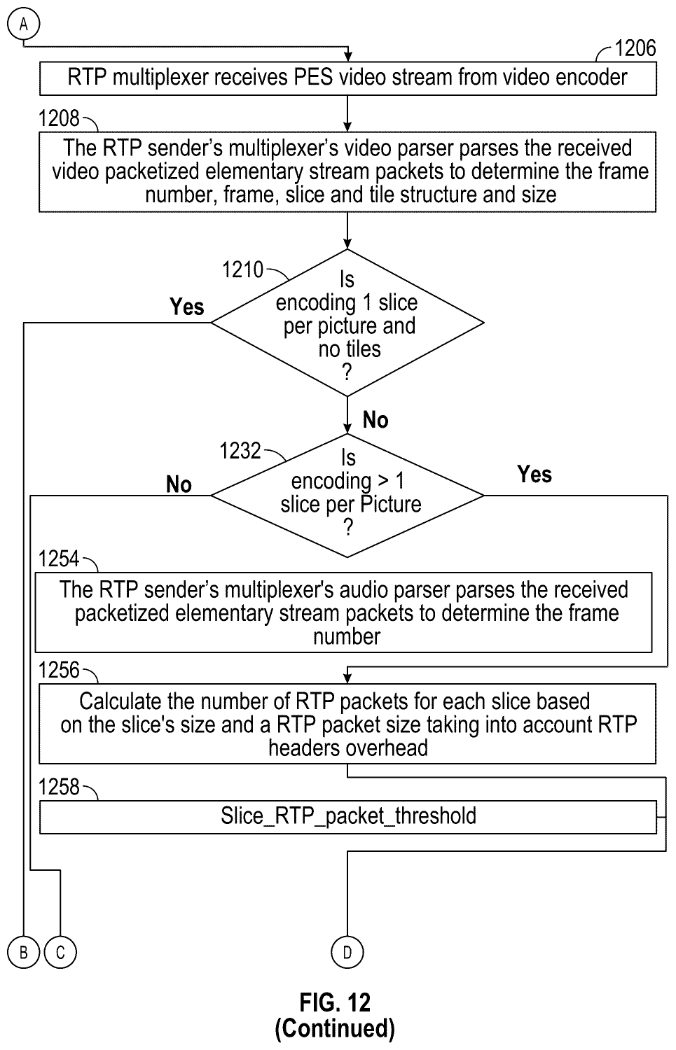

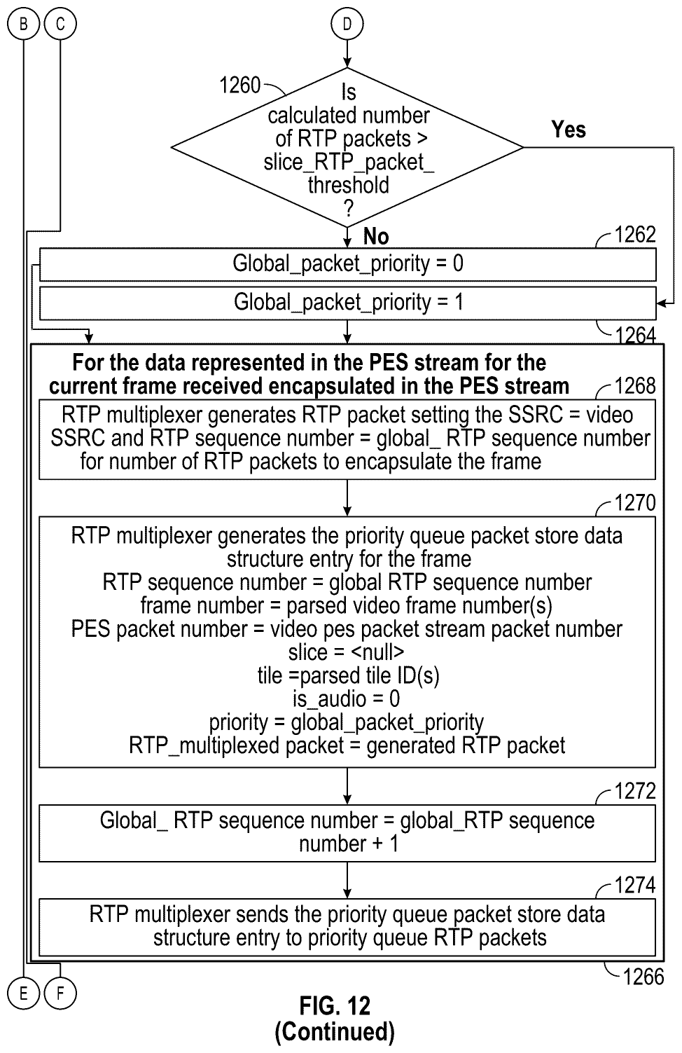

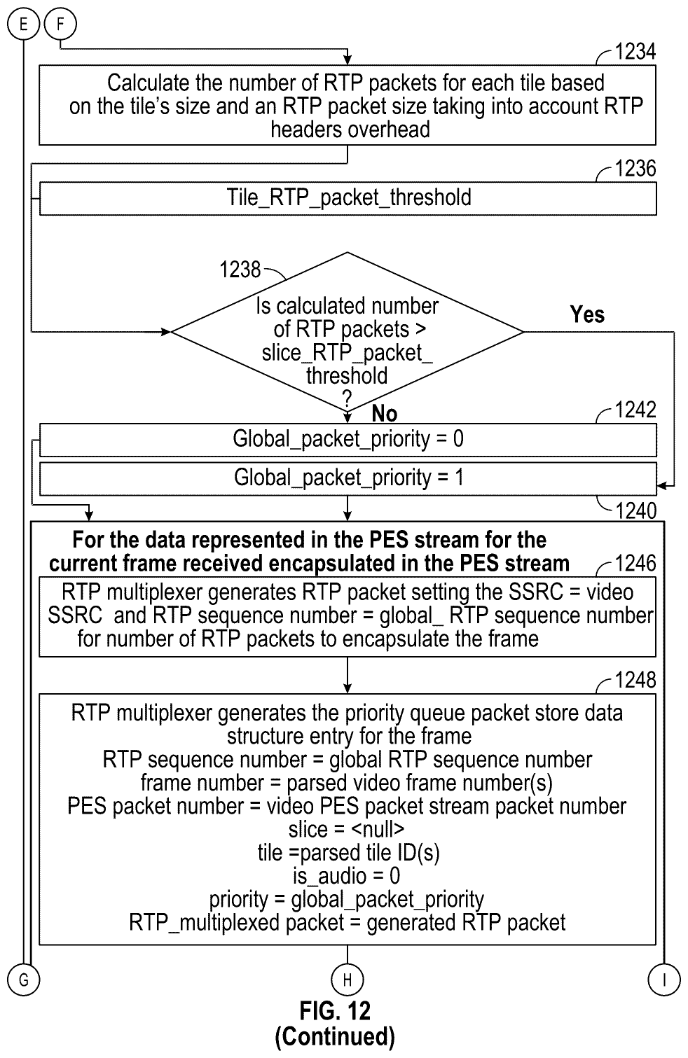

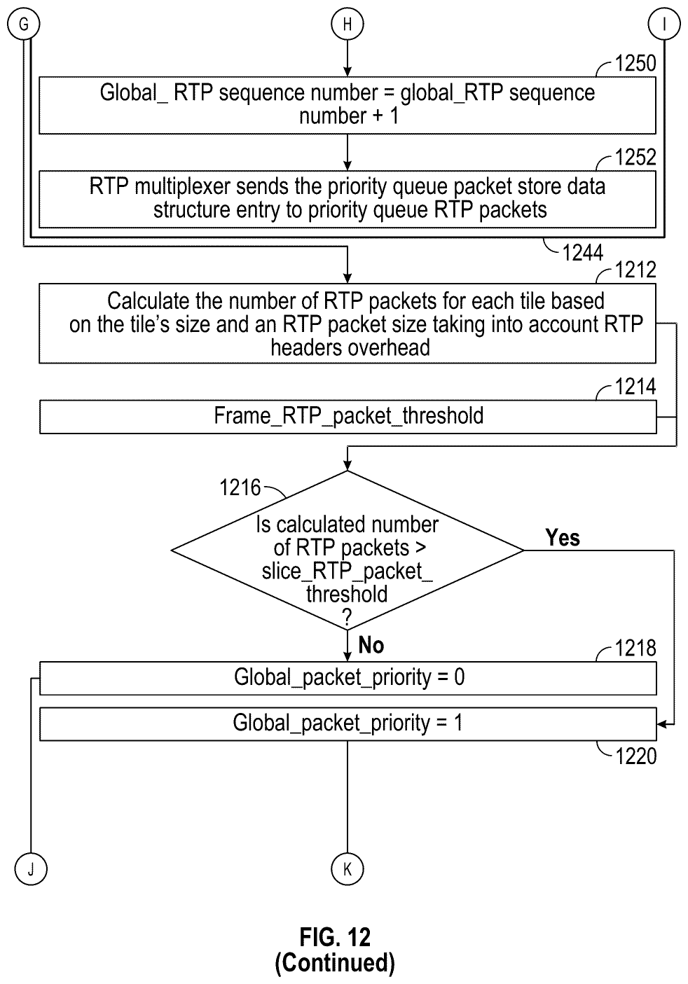

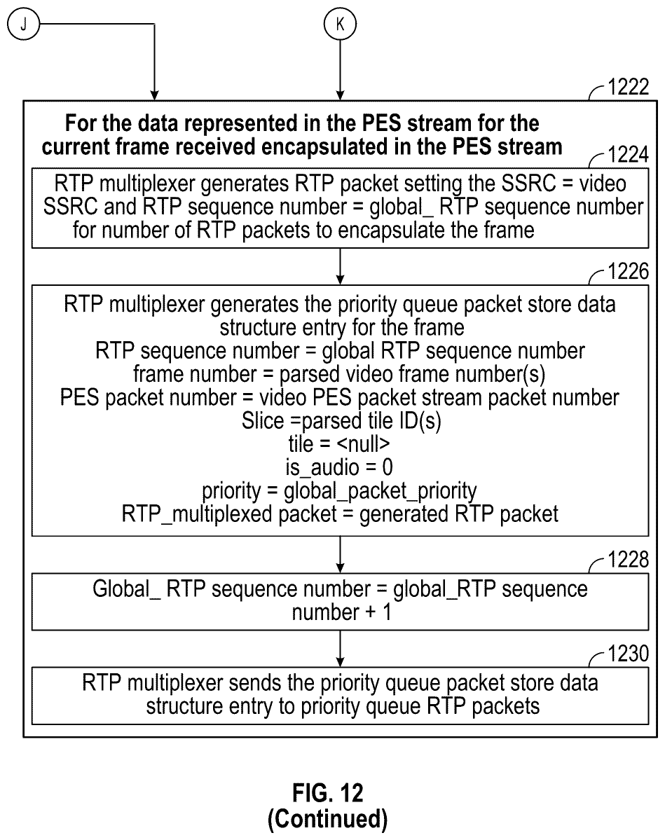

FIG. 12 shows a flowchart of an example process 1200 for an RTP multiplexer, in accordance with some embodiments of the disclosure. For example, in FIG. 12, the process 1200 for the RTP multiplexer includes receiving audio and video streams where the video parser parses the PES packets to determine characteristics of video frame, slice, and tile, depending on a type of encoding. Also, for example, the audio parser parses the audio to determine the audio frames represented in the audio PES packets. Further, for example, based on the parsed data, the data structure entry for the RTP priority queue of data structures is generated and sent to the RTP priority queue for RTP video and audio packets. Still further, for example, a system is provided where the RTP multiplexer multiplexes the video and audio RTP packets, and these packets are interleaved (as presented earlier in the data structure examples herein). Moreover, for example, the threshold value for frame, slice, and tile RTP packets in making the determination of whether the packet is priority or not is set based on experimentation. In addition, for example, priorities are set statically or dynamically. Furthermore, for example, a dynamic threshold depends on at least one of a current congestion window calculated by the RTP system, the estimated RTT for L4S-enabled packets, the estimated RTT for non-L4S-enabled packets, combinations of the same, or the like.

In some embodiments, the process 1200 is provided for RTP multiplexer data structure generation. The process 1200 includes, e.g., setting 1202 a global RTP sequence number to 0. The process 1200 includes, e.g., setting 1204 a global packet priority to 0. The process 1200 includes, e.g., receiving 1206, at the RTP multiplexer, a PES video stream from a video encoder. The process 1200 includes, e.g., parsing 1208, at a video parser of an RTP sender of the RTP multiplexer, the received video PES packets to determine a frame number, frame, slice, and tile structure and size. The process 1200 includes, e.g., determining 1210 whether encoding is performed at one slice per picture and with no tiles. Based at least in part on determining the encoding is performed at one slice per picture and with no tiles (1210=“Yes”), the process 1200 includes, e.g., calculating 1212 a number of RTP packets for the frame based at least in part on a size of the frame and a size of an RTP packet considering an overhead of RTP headers. The process 1200 includes, e.g., accessing 1214 a threshold of a frame of an RTP packet. The process 1200 includes, e.g., determining 1216 whether a calculated number of RTP packets is greater than the threshold of the frame of the RTP packet (e.g., from step 1214). Based at least in part on determining the calculated number of RTP packets is greater than the threshold of the frame of the RTP packet (1216=“Yes”), the process 1200 includes, e.g., setting 1218 the global packet priority to 1. Based at least in part on determining the calculated number of RTP packets is not greater than the threshold of the frame of the RTP packet (1216=“No”), the process 1200 includes, e.g., setting 1220 the global packet priority to 0.

In some embodiments, the process 1200 includes, e.g., steps 1222 for the data represented in the PES stream for the current frame received and encapsulated in the PES stream. The steps 1222 include, e.g., at least one of step 1224, step 1226, step 1228, step 1230, combinations of the same, or the like. The process 1200 includes, e.g., generating 1224, at the RTP multiplexer, an RTP packet setting the SSRC equal to the video SSRC, and an RTP sequence number equal to the global RTP sequence number for a number of RTP packets for encapsulating a frame. The process 1200 includes, e.g., generating 1226, at the RTP multiplexer, at least one of a priority queue packet store data structure entry for the frame; an RTP sequence number equal to the global RTP sequence number; a frame number equal to one or more parsed video frame numbers; a PES packet number equal to a video PES stream packet number; a slice equal to one or more parsed slice identifiers; a tile equal to null; an “is audio” identifier equal to 0; a priority equal to the global packet priority; an RTP multiplexed packet equal to a generated RTP packet; combinations of the same; or the like. The process 1200 includes, e.g., setting 1228 the global RTP sequence number equal to the global RTP sequence number+1. The process 1200 includes, e.g., sending 1230, at the RTP multiplexer, the priority queue packet store data structure entry to the priority queue RTP packets.

In some embodiments, based at least in part on determining the encoding is not performed at one slice per picture and with no tiles (1210=“No”), the process 1200 includes, e.g., determining 1232 whether the encoding is greater than one slice per picture. Based at least in part on determining the encoding is not greater than one slice per picture (1232=“No”), the process 1200 includes, e.g., calculating 1234 a number of RTP packets for each tile based at least in part on a size of the tile and a size of an RTP packet considering an overhead of RTP headers. The process 1200 includes, e.g., accessing 1236 a threshold of a tile of an RTP packet. The process 1200 includes, e.g., determining 1238 whether a calculated number of RTP packets is greater than the threshold of the tile of the RTP packet (e.g., from step 1236). Based at least in part on determining the calculated number of RTP packets is greater than the threshold of the tile of the RTP packet (1238=“Yes”), the process 1200 includes, e.g., setting 1240 the global packet priority to 1. Based at least in part on determining the calculated number of RTP packets is not greater than the threshold of the tile of the RTP packet (1238=“No”), the process 1200 includes, e.g., setting 1242 the global packet priority to 0.

In some embodiments, the process 1200 includes, e.g., steps 1244 for the data represented in the PES stream for the current frame received and encapsulated in the PES stream. Steps 1222 through 1230 are, in some embodiments, identical to steps 1244 to 1252, respectively. In some example, a data structure may be populated differently at each of steps 1226, 1248, and 1270. Duplicative descriptions are omitted for brevity.

In some embodiments, based at least in part on determining the encoding is greater than one slice per picture (1232=“Yes”), the process 1200 includes, e.g., parsing 1254, at an audio parser of an RTP sender of the RTP multiplexer, the received PESs to determine a frame number. The process 1200 includes, e.g., calculating 1256 a number of RTP packets for each slice based at least in part on a size of the slice and a size of an RTP packet considering an overhead of RTP headers. The process 1200 includes, e.g., accessing 1258 a threshold of a slice of an RTP packet. The process 1200 includes, e.g., determining 1260 whether a calculated number of RTP packets is greater than the threshold of the slice of the RTP packet (e.g., from step 1258). Based at least in part on determining the calculated number of RTP packets is greater than the threshold of the slice of the RTP packet (1260=“Yes”), the process 1200 includes, e.g., setting 1262 the global packet priority to 1. Based at least in part on determining the calculated number of RTP packets is not greater than the threshold of the slice of the RTP packet (1260=“No”), the process 1200 includes, e.g., setting 1264 the global packet priority to 0.

In some embodiments, the process 1200 includes, e.g., steps 1266 for the data represented in the PES stream for the current frame received and encapsulated in the PES stream. Steps 1222 through 1230 are, in some embodiments, identical to steps 1266 to 1274, respectively. Duplicative descriptions are omitted for brevity. Please note, in step 1270, a slice is set equal to null, and a tile is set equal to one or more parsed tile identifiers; otherwise, step 1226 is identical to step 1270.

In some examples, the process 1200 includes, e.g., receiving 1276, at the RTP multiplexer, a PES audio stream from an audio encoder. The process 1200 includes, e.g., parsing 1278, at an audio parser of an RTP sender of the RTP multiplexer, the received audio PES packets to determine a frame number.

In some embodiments, the process 1200 includes, e.g., steps 1280 for the data represented in the PES stream for the current frame received and encapsulated in the PES stream. The steps 1280 include, e.g., at least one of step 1282, step 1284, step 1286, step 1288, combinations of the same, or the like. The process 1200 includes, e.g., generating 1282, at the RTP multiplexer, an RTP packet setting the SSRC equal to the audio SSRC, and an RTP sequence number equal to the global RTP sequence number. The process 1200 includes, e.g., generating 1284, at the RTP multiplexer, at least one of a priority queue packet store data structure entry; an RTP sequence number equal to the global RTP sequence number; a frame number equal to one or more parsed audio frame numbers; a PES packet number equal to a PES stream packet number; a slice equal to null; a tile equal to null; an “is audio” identifier equal to 1; a priority equal to the global packet priority; an RTP multiplexed packet equal to a generated RTP packet; combinations of the same; or the like. The process 1200 includes, e.g., setting 1286 the global RTP sequence number equal to the global RTP sequence number+1. The process 1200 includes, e.g., sending 1288, at the RTP multiplexer, the priority queue packet store data structure entry to the priority queue RTP packets.

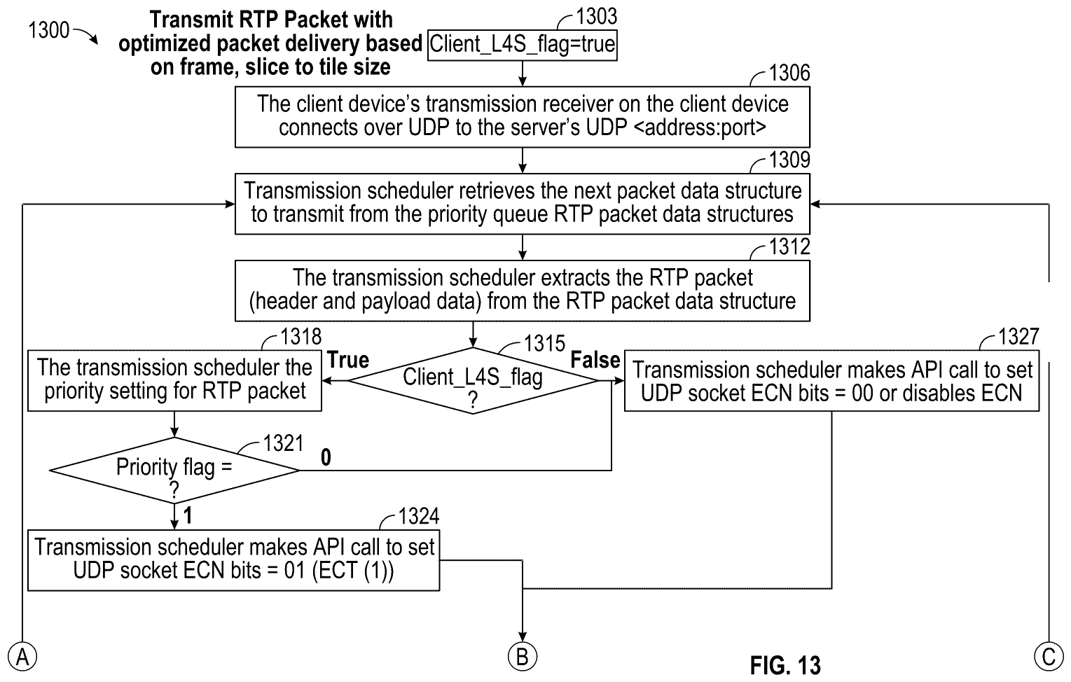

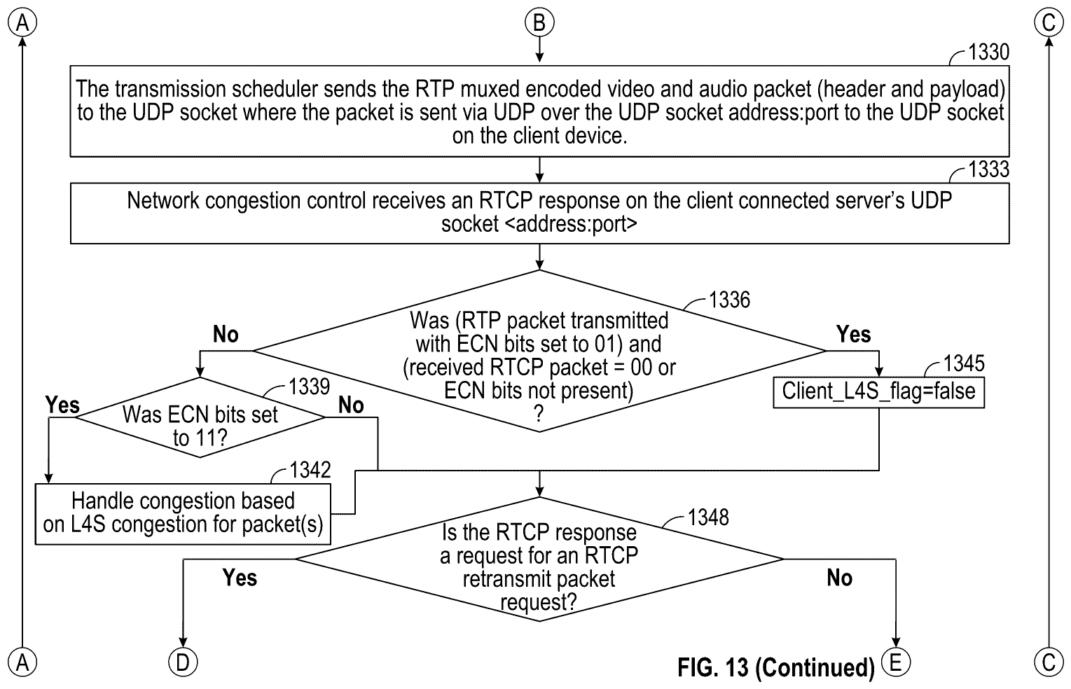

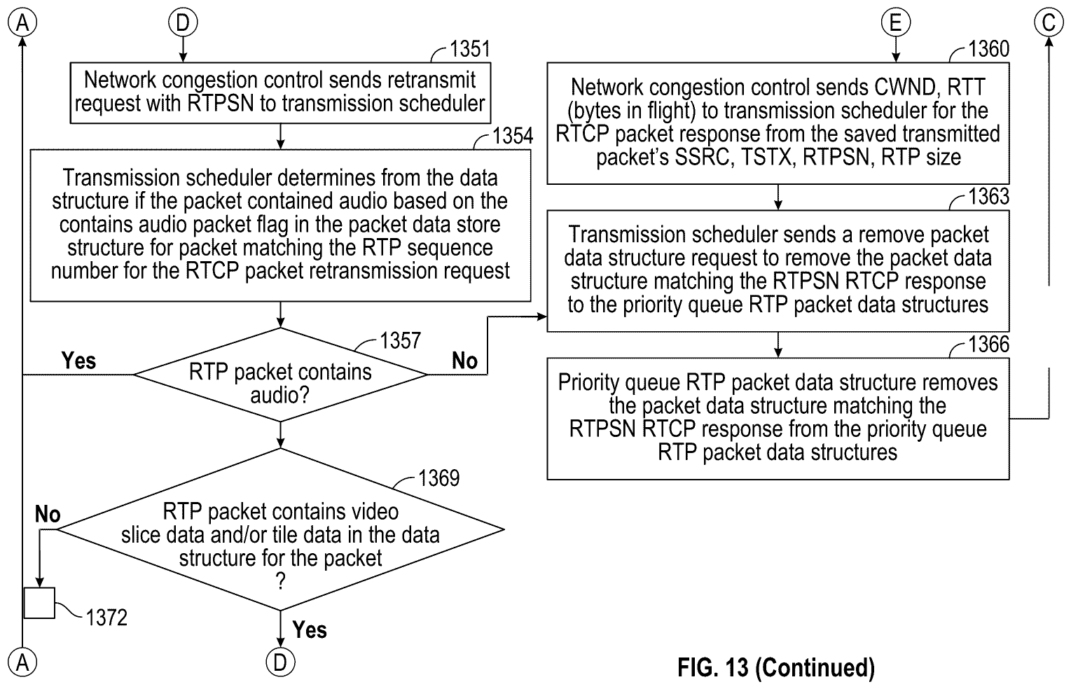

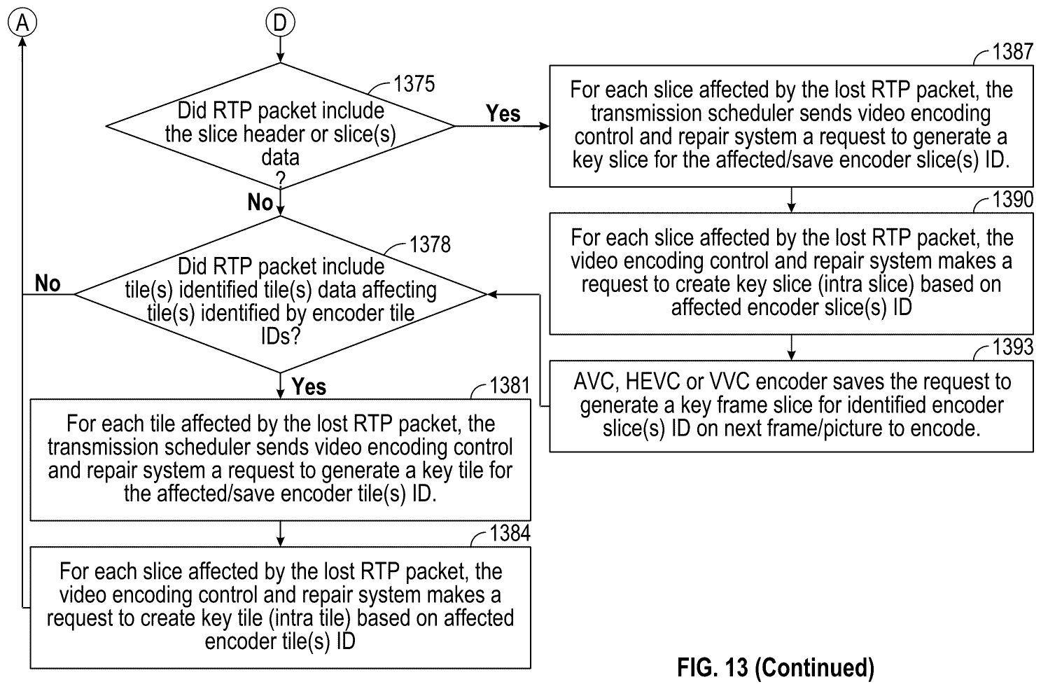

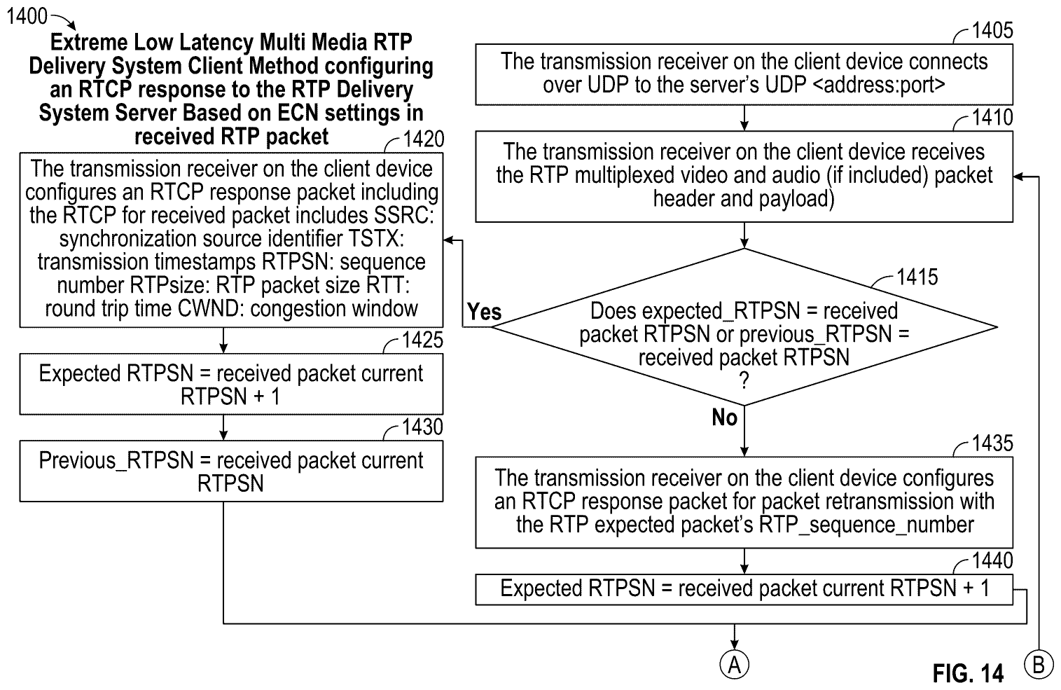

FIG. 13 shows a flowchart of an example process 1300 for an RTP transmission scheduler, in accordance with some embodiments of the disclosure. For example, as shown in FIG. 13, the example method 1300 for the RTP Transmission Scheduler includes extracting an RTP Packet (e.g., including one or more headers and a payload) and checking a priority indicator for the packet. Also, for example, if the priority indicator is set, ECN ECT(01)/L4S is set on a socket prior to transmitting the packet. Further, for example, if an RTCP response is received for a transmitted RTP packet, the transmitted RTP packet has the ECN bits set to ECN ECT(01)/L4S, and the corresponding RTCP received packet was set to 00 or the ECN bits were missing, all following RTP packets are sent with the ECN bits set to 00.

In some embodiments, for example, the process 1300 includes transmitting an RTP packet with optimized packet delivery based on a size of at least one of a frame, a slice, or a tile. The process 1300 includes, e.g., setting 1303 a client L4S flag equal to true. The process 1300 includes, e.g., connecting 1306 a transmission receiver of a client device over UDP to a UDP of the server (e.g., at a particular address: port). The process 1300 includes, e.g., retrieving 1309, at the transmission scheduler, a next packet data structure to transmit from priority queue RTP packet data structures. The process 1300 includes, e.g., extracting 1312, at the transmission scheduler, the RTP packet (e.g., including header and payload data) from the RTP packet data structure. The process 1300 includes, e.g., determining 1315 whether the client L4S flag is true or false. Based at least in part on determining the client L4S flag is true (1315=“True”), the process 1300 includes, e.g., setting 1318, at the transmission scheduler, a priority setting for the RTP packet. Based at least in part on determining the client LAS flag is false (1315=“False”), the process 1300 includes, e.g., making 1327, at the transmission scheduler, an API call to set UDP socket ECN bits equal to 00 or disabling ECN. The process 1300 includes, e.g., determining 1321 whether the priority tag is set to 0 or 1. Based at least in part on determining the priority tag is set to 0 (1321=“0”), the process 1300 includes, e.g., the making 1327 step. Based at least in part on determining the priority tag is set to 1 (1321=“1”), the process 1300 includes, e.g., making 1324 an API call to set UDP socket ECN bits equal to 01 (ECT(1)).

In some embodiments, the process 1300 includes, e.g., sending 1330, at the transmission scheduler, an RTP muxed encoded video and audio packet (e.g., including the header and payload) to the UDP socket where the packet is sent via UDP over the UDP socket (e.g., at address: port) to the UDP socket on the client device. The process 1300 includes, e.g., receiving 1333, at network congestion control, an RTCP response on the UDP socket (e.g., at address: port) of a client connected server. The process 1300 includes, e.g., determining 1336 whether (1) an RTP packet transmitted with ECN bits set to 01, and (2) the received RTCP packet equal to 00 or ECN bits not present. Based at least in part on determining (1) the RTP packet transmitted with ECN bits not set to 01, or (2) the received RTCP packet not equal to 00 or ECN bits present (1336=“No”), the process 1300 includes, e.g., determining 1339 whether ECN bits are set to 11. Based at least in part on determining (1) the RTP packet transmitted with ECN bits is set to 01, and (2) the received RTCP packet equal to 00 or ECN bits not present (1336=“Yes”), the process 1300 includes, e.g., setting 1345 a client L4S flag equal to false. Based at least in part on determining the ECN bits are set to 11 (1339=“Yes”), the process 1300 includes, e.g., handling 1342 congestion based at least in part on L4S congestion for one or more packets.

In some embodiments, after step 1342, and/or based at least in part on determining the ECN bits are not set to 11 (1339=“No”), the process 1300 includes, e.g., determining 1348 whether the RTCP response is a request for an RTCP retransmit packet request. Based at least in part on determining the RTCP response is a request for an RTCP retransmit packet request (1348=“Yes”), the process 1300 includes, e.g., sending 1351, at the network congestion control, a retransmit request with RTPSN to the transmission scheduler. The process 1300 includes, e.g., determining 1354, at the transmission scheduler, from the data structure, if the packet contained audio based on the contains audio flag in the packet data store structure for the packet matching the RTP sequence number for the RTCP packet retransmission request. The process 1300 includes, e.g., determining 1357 whether the RTCP packet contains audio. Based at least in part on determining the RTCP packet contains audio (1357=“Yes”), the process 1300 includes, e.g., reverting to the step 1309. Based at least in part on determining the RTCP packet does not contain audio (1357=“No”), the process 1300 includes, e.g., a step 1363 described herein.

In some embodiments, the process 1300 includes, e.g., based at least in part on determining the RTCP response is not a request for an RTCP retransmit packet request (1348=“No”), the process 1300 includes, e.g., sending 1360, at the network congestion control, CWND and RTT (bytes in flight) to the transmission scheduler for the RTCP packet response from the SSRC, TSTX, RTPSN, and RTP size of a saved transmitted packet. The process 1300 includes, e.g., sending 1363, at the transmission scheduler, a remove packet data structure request to remove the packet data structure matching the RTPSN RTCP response to the priority queue RTP packet data structures. The process 1300 includes, e.g., removing 1366, at the priority queue RTP packet structures, the packet data structure matching the RTPSN RTCP response from the priority packet queue RTP packet data structures. After the step 1366, the process 1300 includes, e.g., reverting to the step 1309.

In some embodiments, the process 1300 includes, e.g., determining 1369 whether an RTP packet contains video slice data and/or tile data in the data structure for the packet. Based at least in part on determining the RTP packet does not contain video slice data and/or tile data in the data structure for the packet (1369=“No”), the process 1300 includes, e.g., ending 1372 the process 1300. Based at least in part on determining the RTP packet contains video slice data and/or tile data in the data structure for the packet (1369=“Yes”), the process 1300 includes, e.g., determining 1375 whether the RTP packet includes the slice header or data of one or more slices. Based at least in part on determining the RTP packet does not include the slice header or data of one or more slices (1375=“No”), the process 1300 includes, e.g., determining 1378 whether the RTP packet includes one or more identified tiles including data for the one or more identified tiles affecting the one or more tiles identified by tile identifiers of the encoder. Based at least in part on determining the RTP packet does not include one or more identified tiles including data for the one or more identified tiles affecting the one or more tiles identified by tile identifiers of the encoder (1378=“No”), the process 1300 includes, e.g., reverting to the step 1309. Based at least in part on determining the RTP packet includes one or more identified tiles including data for the one or more identified tiles affecting the one or more tiles identified by tile identifiers of the encoder (1378=“Yes”), the process 1300 includes, e.g., sending 1381, at the transmission scheduler, for each tile affected by the lost RTP packet, to the video encoding control and repair system, a request to generate a key tile for the affected and/or saved identifiers of one or more tiles at the encoder. The process 1300 includes, e.g., making 1384, at the video encoding control and repair system, for each slice affected by the lost RTP packet, a request to create a key tile (e.g., an I-tile) based on the affected identifiers of one or more tiles at the encoder. After the step 1384, the process 1300 includes, e.g., reverting to the step 1309.

In some embodiments, based at least in part on determining the RTP packet includes the slice header or data of one or more slices (1375=“Yes”), the process 1300 includes, e.g., sending 1387, at the transmission scheduler, for each slice affected by the lost RTP packet, to the video encoding control and repair system, a request to generate a key slice for the affected and/or saved identifiers of one or more slices at the encoder. The process 1300 includes, e.g., making 1390, at the video encoding control and repair system, for each slice affected by the lost RTP packet, a request to create a key slice (e.g., an I-slice) based on the affected identifiers of one or more tiles at the encoder. The process 1300 includes, e.g., saving 1393, at the AVC, HEVC, or VVC encoder, the request to generate a key frame slice for identified identifiers of one or more slices at the encoder on a next frame and/or picture to encode. After the step 1393, the process 1300 includes, e.g., reverting to the step 1378.

In some embodiments, the process 1300 provides granular preferential (e.g., L4S) and default (e.g., non-L4S) control with the above-referenced steps 1303, 1315, 1318, 1321, 1324, 1327, 1336, 1339, 1342, and 1345.

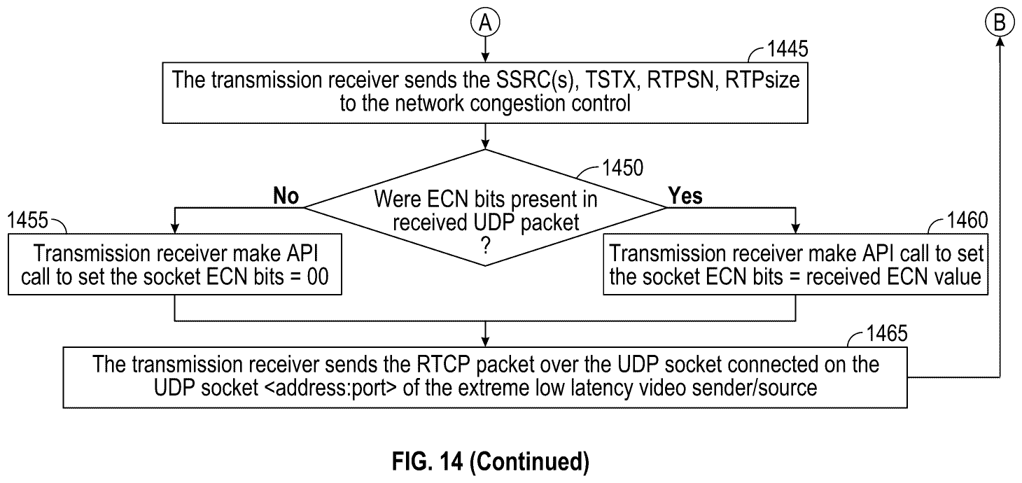

FIG. 14 shows a flowchart of an example process 1400 for an RTP receiver receiving a packet, in accordance with some embodiments of the disclosure. For example, the example method 1400 is provided for receiving, at an RTP transmission receiver, an RTP packet and responding with an RTCP packet. For example, if there are no ECN bits set, the response is set to ECN 00. Also, for example, if there are ECN bits set, the ECN bits for the RTCP response packet are set to the value of the received RTP packet.

In some embodiments, the process 1400 is provided for an extreme low latency multimedia RTP delivery system. For example, the process 1400 includes, e.g., configuring an RTCP response to an RTP delivery system server based at least in part on ECN settings in a received RTP packet. The process 1400 includes, e.g., connecting 1405, at the transmission receiver on the client device, over UDP to the UDP (e.g., at address: port) of the server. The process 1400 includes, e.g., receiving 1410, at the transmission receiver on the client device, the RTP multiplexed video and audio (e.g., if included, a header and payload). The process 1400 includes, e.g., determining 1415 whether an expected RTPSN is equal to a received packet RTPSN or whether a previous RTPSN is equal to a received packet RTPSN. Based at least in part on determining the expected RTPSN is equal to the received packet RTPSN or the previous RTPSN is equal to the received packet RTPSN (1415=“Yes”), the process 1400 includes, e.g., configuring 1420, at the transmission receiver of the client device, an RTCP response packet including the RTCP for the received packet. For example, the RTCP for the received packet includes at least one of SSRC, TSTX, RTPSN, RTPsize, RTT, CWND, combinations of the same, or the like. The process 1400 includes, e.g., setting 1425 the expected RTPSN equal to the received packet current RTPSN+1. The process 1400 includes, e.g., setting 1430 the previous RTPSN equal to the received packet current RTPSN. Based at least in part on determining the expected RTPSN is not equal to the received packet RTPSN or the previous RTPSN is not equal to the received packet RTPSN (1415=“No”), the process 1400 includes, e.g., configuring 1435, at the transmission receiver of the client device, an RTCP response packet for packet retransmission with an RTP sequence number of the RTP expected packet. The process 1400 includes, e.g., setting 1440 the expected RTPSN equal to the received packet current RTPSN+1.

In some embodiments, either after the step 1430 or the step 1440, the process 1400 includes, e.g., sending 1445, at the transmission receiver, one or more SSRCs, the TSTX, the RTPSN, and the RTPsize to the network congestion control. The process 1400 includes, e.g., determining 1450 whether ECN bits are present in the received UDP packet. Based at least in part on determining the ECN bits are not present in the received UDP packet (1450=“No”), the process 1400 includes, e.g., making 1455, at the transmission receiver, an API call to set the socket ECN bits equal to 00. Based at least in part on determining the ECN bits are present in the received UDP packet (1450=“Yes”), the process 1400 includes, e.g., making 1460, at the transmission receiver, an API call to set the socket ECN bits equal to the received ECN value. The process 1400 includes, e.g., sending 1465, at the transmission receiver, the RTCP packet over the UDP socket connected on the UDP socket (e.g., at address: port) of the extreme low latency video sender and/or source. After the step 1465, the process 1400 includes, e.g., reverting to the step 1410.

In some embodiments, the process 1400 provides ECN control with the above-referenced steps 1450, 1455, and 1460.

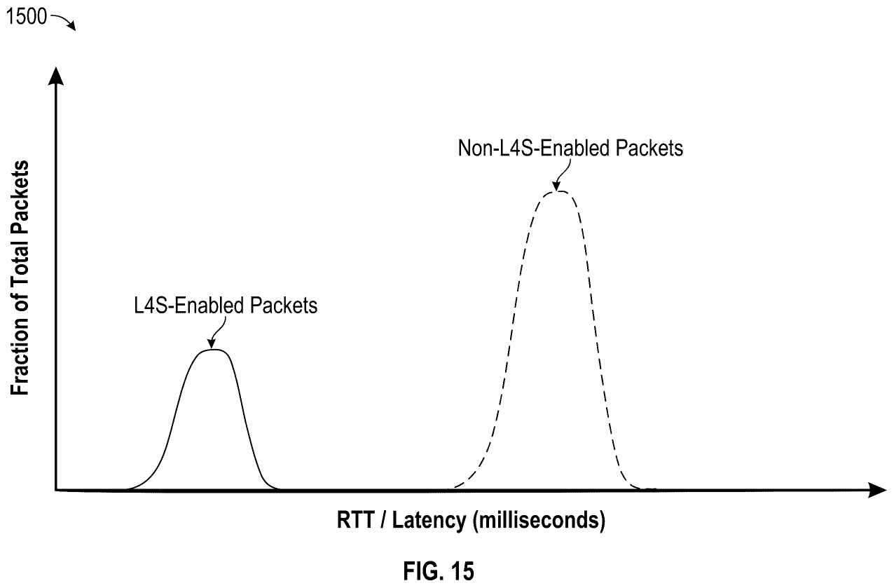

FIG. 15 depicts a bi-modal distribution 1500 of latency with selective L4S enablement, in accordance with some embodiments of the disclosure. FIG. 15 illustrates how the latency distribution of packets with selective L4S enablement is expected to be bimodal (assuming channel conditions hold constant for a while). While L4S packets pass through a channel with lower latency and lower loss, non-L4S packets encounter channel conditions with higher latency and higher loss. The height of the peaks shown here depend on a proportion of L4S packets and non-L4S packets, respectively. The higher the threshold number of transport packets (to trigger an L4S transport) encapsulating the PES packet for the picture, slices, or tiles to be delivered, the lower the proportion of L4S-enabled packets in the transport.

In some embodiments, to maintain a sequence of packets at the receiver even as packets may arrive out of order, separate L4S and non-L4S transport buffers are maintained. For example, as packets arrive in the buffers, they are sequenced back to the original RTP stream before sending to the demultiplexer.

In some embodiments, congestion control in RTP-RTCP is provided. For example, congestion control includes elements based on application. Also, for example, adaptation of the target encoding rate is provided in the video encoding rate control and repair module in the RTP Sender. Further, for example, Stadia, a currently obsolete cloud gaming service from Google, includes adaptation of a target encoding rate. Still further, for example, congestion control is provided including two components: a delay-based controller on the client side and a loss-based controller on the server side. For example, the delay-based controller uses transmission delays to estimate buffer states and calculate the required bitrate, Ar, which is then sent to the sender. Further, for example, notifications are sent every second or immediately if there is a significant change in the estimated bitrate. Still further, the loss-based controller at the server side estimates the bitrate, As, based on packet loss. For example, if packet loss is below 0.02, As increases; if packet loss is above 0.1, As decreases; and if packet loss is between 0.02 and 0.1, As remains unchanged. The sender then transmits packets at the lower of the two bitrates, i.e., min (Ar,As).

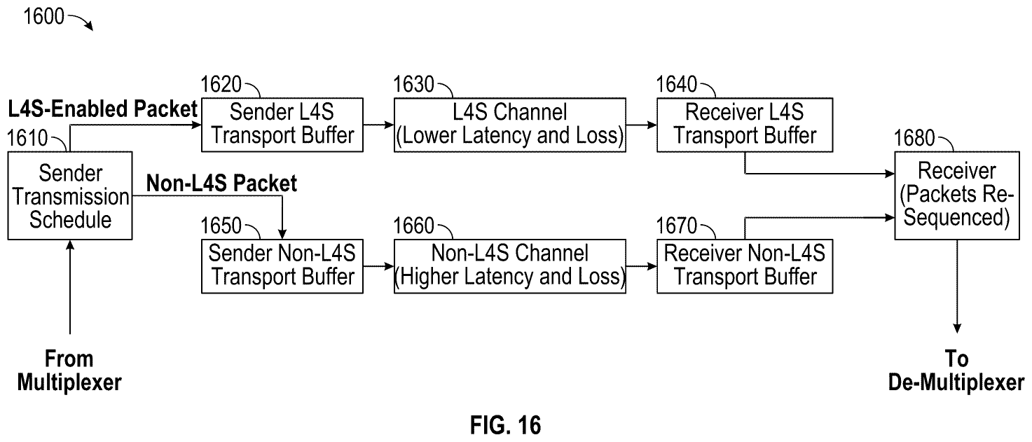

FIG. 16 depicts transmission and reception transport buffers to account for out-of-order delivery due to different round trip times (RTTs) for L4S and non-L4S packets, in accordance with some embodiments of the disclosure. For example, to account for L4S-enabled packets and non-L4S-enabled packets, which experience different RTTs and loss probabilities, the video encoding rate control and repair module in the RTP sender estimates delay and loss separately for L4S and non-L4S channels. These estimations are performed and periodically updated by the sender as RTCP retransmission requests and receiver reports are received.

In some embodiments, a system 1600 includes transmission and reception transport buffers. For example, the system 1600 includes, e.g., at least one of a sender transmission scheduler 1610, a sender L4S transport buffer 1620, an L4S channel (e.g., for lower latency and loss) 1630, a receiver L4S transport buffer 1640, a sender non-L4S transport buffer 1650, a non-L4S channel (e.g., for higher latency and loss) 1660, a receiver non-L4S transport buffer 1670, a receiver (e.g., for resequencing packets) 1680, combinations of the same, or the like. Also, for example, the system 1600 receives information from a multiplexer (not shown). Further, for example, the system 1600 sends information to a demultiplexer (not shown). Still further, for example, the sender transmission scheduler 1610 sends an L4S-enabled packet to the sender L4S transport buffer 1620, and the sender transmission scheduler 1610 sends a non-L4S-enabled packet to the sender non-L4S transport buffer 1650. For example, the L4S-enabled packet proceeds from the scheduler 1610, to the buffer 1620, across the channel 1630, to the buffer 1640, and to the receiver 1680. Also, for example, the non-L4S-enabled packet proceeds from the scheduler 1610, to the buffer 1650, across the channel 1660, to the buffer 1670, and to the receiver 1680.

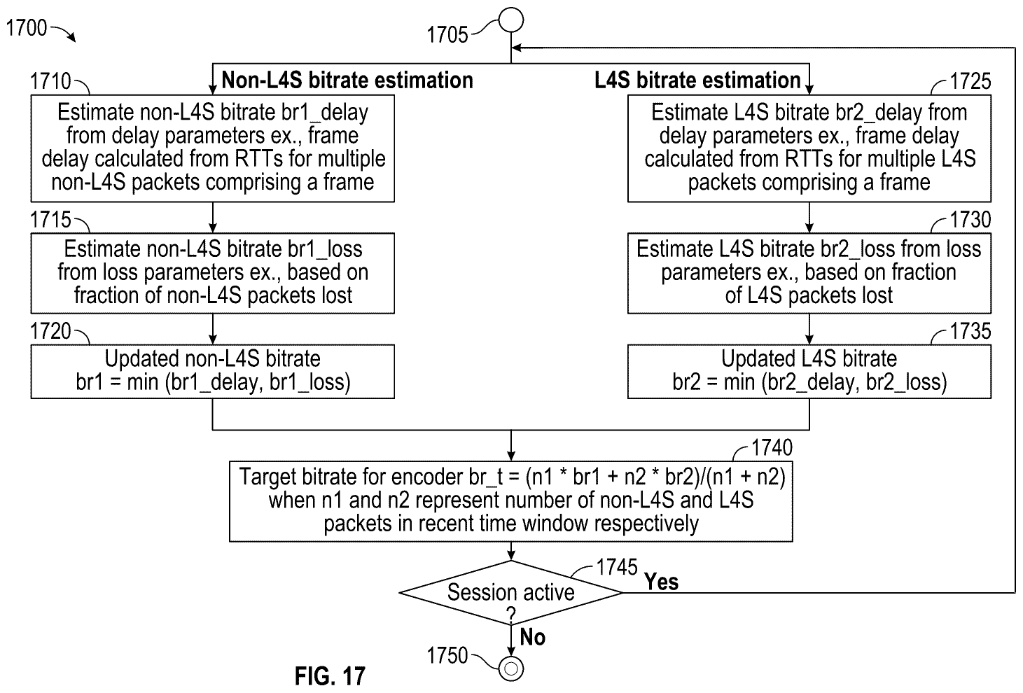

FIG. 17 depicts a weighted average bitrate calculation across L4S and non-L4S for input as a target bitrate to an encoder from a priority queue, in accordance with some embodiments of the disclosure. For example, to provide a single target bitrate to the video encoder's rate controller, a weighted average of the bitrates estimated for L4S and non-L4S channels/paths is calculated, as shown in FIG. 17 and in Formulas (1)-(33) below, as follows:

$$br\_t = ( ( n\_ 1 * br\_ 1 + n\_ 2 * br\_ 2 ) ) / ( n\_ 1 + n\_ 2 ) , \qquad ( 1 )$$

$$br\_ 1 = min ( br\_ ( 1 , delay ) , br\_ ( 1 , loss ) ) , \qquad ( 2 )$$

$$br\_ 2 = min ( br\_ ( 2 , delay ) , br\_ ( 2 , loss ) ) , \qquad ( 3 )$$

where br_t: Target Encoder bitrate,
where, n_1: Number of non-L4S packets in recent time window, and
where n_2: Number of L4S packets in recent time window.

The formulas shown herein are for illustration purposes and not limiting. For example, the calculated target bitrate may be further modified based on a function of current and recent historical values, e.g., an exponentially weighted moving average may be used to control the temporal weights of current versus recent historical estimated values.

In some embodiments, a process 1700 is provided for providing a weighted average bitrate calculation across L4S and non-L4S for input as a target bitrate to an encoder from a priority queue. The process 1700 includes, e.g., starting 1705, a non-L4S bitrate estimation and/or an L4S bitrate estimation. The process 1700 includes, e.g., for the non-L4S bitrate estimation, estimating 1710 non-L4S bitrate br1_delay from delay parameters, e.g., frame delay calculated from RTTs for multiple non-L4S packets comprising a frame. The process 1700 includes, e.g., estimating 1715 non-L4S bitrate br1_loss from loss parameters, e.g., based on a fraction of non-L4S packets lost. The process 1700 includes, e.g., updating 1720 non-L4S bitrate br1=min (br1_delay, br1_loss).

In some embodiments, the process 1700 includes, e.g., for the L4S bitrate estimation, estimating 1725 L4S bitrate br2_delay from delay parameters, e.g., frame delay calculated from RTTs for multiple L4S packets comprising a frame. The process 1700 includes, e.g., estimating 1730 L4S bitrate br2_loss from loss parameters, e.g., based on a fraction of L4S packets lost. The process 1700 includes, e.g., updating 1735 L4S bitrate br2=min (br2_delay, br2_loss).

In some embodiments, after the step 1720 and/or the step 1735, the process 1700 includes, e.g., setting 1740 a target bitrate for an encoder br_t=(n1*br1+n2*br2)/(n1+n2), where n1 and n2 represent a number of non-L4S and L4S packets in a recent time window, respectively. The process 1700 includes, e.g., determining 1745 whether a session is active. Based at least in part on determining the session is active (1745=“Yes”), the process 1700 includes, e.g., reverting to the step 1710 and/or the step 1725. Based at least in part on determining the session is not active (1745=“No”), the process 1700 includes, e.g., ending 1750.

In some embodiments, to estimate delays and loss for non-L4S and L4S channels and/or paths separately, RTCP congestion control packets are used.

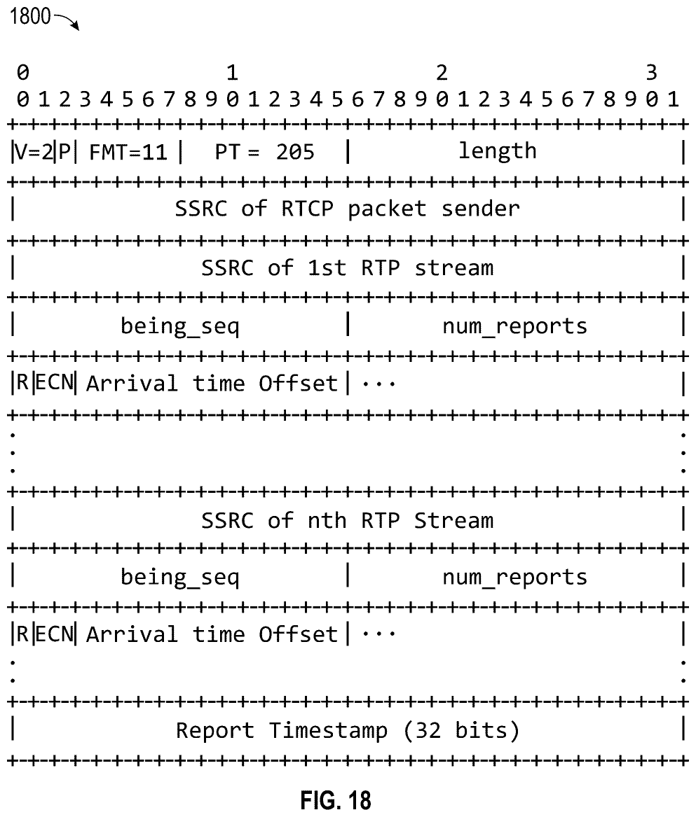

FIG. 18 depicts a format for an RTCP congestion control packet 1800, in accordance with some embodiments of the disclosure. For example, FIG. 18 illustrates the format of an RTCP congestion control packet 1800. Also, for example, as shown in FIG. 18, the ECN markings of the sender are echoed back to the sender along with the arrival time offsets. Thus, the sender is able to calculate the RTT latencies of non-L4S and L4S channels and/or paths separately. Further, for example, a similar format is used to communicate (e.g., fractional) losses of non-L4S and L4S channels and/or paths. Still further, for example, by maintaining separate buffers for non-L4S and L4S channels, the receiver performs the loss calculations for each channel separately.

In some embodiments, the RTCP congestion control feedback report is provided and congestion control feedback is transmitted in RTP/audio visual profile with feedback (AVPF) packets. For example, congestion control feedback is sent as part of a regular scheduled RTCP report or in an RTP/AVPF early feedback packet. Also, for example, the feedback is sent as a transport-layer feedback message (RTCP packet type 205). Further, for example, the RTCP header is followed by a report block for each SSRC from which RTP packets have been received, followed by a report timestamp. Still further, for example, each report block contains a 16-bit packet metric block for each RTP packet that has a sequence number in the range begin_seq to begin_seq+num_reports inclusive. For example, the contents of each 16-bit packet metric block comprise the received, ECN, and arrival time offset (ATO) fields. Also, for example, the RTCP congestion control feedback report packet concludes with the report timestamp field (RTS, 32 bits). Further, for example, RTCP congestion control feedback packets include a report block for every active SSRC. Still further, for example, if an RTCP congestion control feedback packet is too large to fit within the path maximum transmission unit (MTU), its sender should split it into multiple feedback packets. For example, if duplicate copies of a particular RTP packet are received, then the arrival time of the first copy to arrive is, in this example, to be reported. Also, for example, if no packets are received from an SSRC in a reporting interval, a report block may be sent with begin_seq set to the highest sequence number previously received from that SSRC and num_reports set to 0. Further, for example, a report block indicating that certain RTP packets were lost is not to be interpreted as a request to retransmit the lost packets. Still further, for example, the receiver of such a report might choose to retransmit such packets, provided a retransmission payload format has been negotiated, but there is no requirement that it do so.

In some embodiments, selective L4S enablement is performed based on temporal channel quality. For example, if an RTP sender determines that packet loss and/or delays using the non-L4S channel and/or path are insufficient for meeting a threshold quality of transmission, for a period of time, L4S is enabled for outgoing packets. Also, for example, the RTCP sender probes both non-L4S and L4S paths and decides that: (1) a non-L4S path does not meet a threshold quality and/or responsiveness (e.g., video resolution or latency), and/or (2) an L4S path meets desired threshold quality and/or responsiveness. Based on these determinations, for example, the RTP sender shifts the transmission to the L4S channel and/or path via L4S packet markings. Further, for example, at a later time, the sender, via receiver reports and/or congestion control packets, determines that the non-L4S channel and/or path is once again able to deliver the packets with satisfactory quality and/or responsiveness. Still further, for example, at that time, the sender resumes transmission of the packets via the non-L4S path by disabling L4S markings.

In some embodiments, for testing and other purposes, packet capture and inspection are provided. The packet capture and inspection may be performed while using, for example, an application for low latency ABR video, an extreme low latency RTP delivery system, or the like. For example, an I-frame is generated as a result of forcing a dropped packet using a traffic controller (TC). Also, for example, in cloud gaming, packet capture and inspection are performed after a scene change. In ABR traffic, captured packets are examined at the start of a segment where large I-frames are delivered to the client device to determine if some packets at a start of the segment are priority-marked versus other packets. Since, for example, the ECN bits are not encrypted, these are viewed in a packet browser like Wireshark.

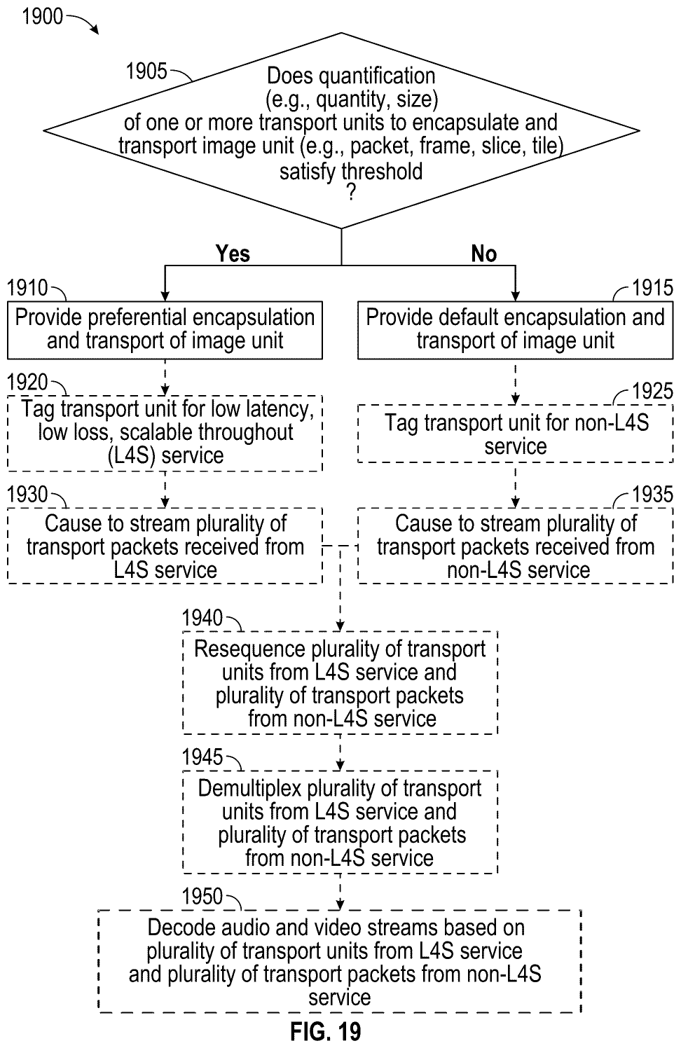

FIG. 19 shows a flowchart of an example process 1900 for low- to ultralow-latency content delivery, in accordance with some embodiments of the disclosure. For example, the process 1900 includes determining 1905 whether a quantification of a transport unit to encapsulate and transport an image unit satisfies a threshold. Also, for example, the process 1900 includes, based at least in part on determining that the quantification of the transport unit to encapsulate and transport the image unit satisfies the threshold (1905=“Yes”), providing 1910 preferential encapsulation and transport of the image unit. Further, for example, the preferential encapsulation and transport of the image unit comprise tagging 1920 the transport unit for L4S service. Still further, for example, the process 1900 includes, based at least in part on determining that the quantification of the transport unit to encapsulate and transport the image unit does not satisfy the threshold (1905=“No”), providing 1915 default encapsulation and transport of the image unit. Moreover, for example, the default encapsulation and transport of the image unit comprise tagging 1925 the transport unit for non-L4S service. In addition, for example, the transport unit may be a packetized elementary stream (PES). Furthermore, for example, the transport unit may be a transport packet.

For example, the process 1900 includes causing 1930 to stream a plurality of transport packets received from the L4S service. Also, for example, the process 1900 includes causing 1935 to stream a plurality of transport packets received from a non-L4S service. Further, for example, the process 1900 includes resequencing 1940 a plurality of transport packets from the L4S service and a plurality of transport packets from a non-L4S service. Still further, for example, the resequencing 1940 may occur prior to demultiplexing 1945 and/or decoding 1950 audio and video streams based on the plurality of transport packets from the L4S service and the plurality of transport packets from the non-L4S service).

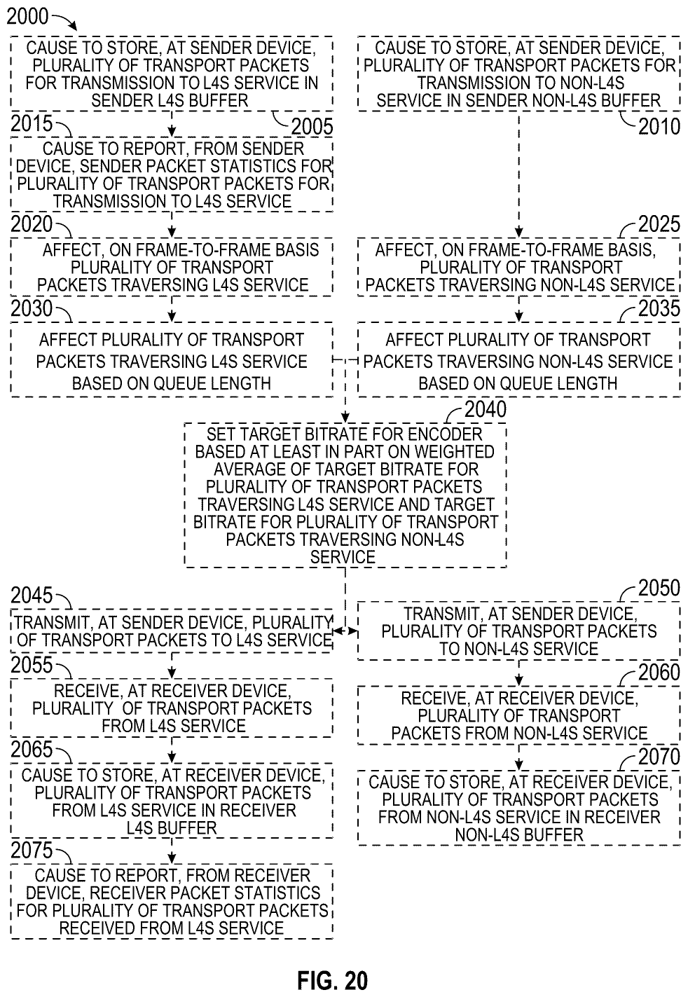

FIG. 20 shows a flowchart of an example process 2000 with one or more steps combinable with one or more steps of the process of FIG. 19, in accordance with some embodiments of the disclosure. For example, the process 2000 includes causing 2005 to store a plurality of transport packets from the L4S service in an LAS buffer. Also, for example, the process 2000 includes causing 2010 to store a plurality of transport packets from a non-L4S service in a non-L4S buffer. Further, for example, the process 2000 includes causing 2015 to report, from a sender device, sender packet statistics for a plurality of transport packets for transmission to the L4S service.

In some embodiments, the process 2000 includes affecting 2020, on a frame-to-frame basis, a plurality of transport packets traversing the L4S service. Also, for example, the process 2000 includes affecting 2025, on a frame-to-frame basis, a plurality of transport packets traversing a non-L4S service based at least in part on an encoder bitrate and a content complexity. Further, for example, the process 2000 includes affecting 2030 the plurality of transport packets traversing the L4S service based at least in part on a queue length of an RTP priority queue of RTP packet data structures. Still further, for example, the process 2000 includes affecting 2035 the plurality of transport packets traversing the non-L4S service based at least in part on a queue length of an RTP priority queue of RTP packet data structures. Moreover, for example, the process 2000 includes setting 2040 the target bitrate for the encoder based at least in part on a weighted average of the target bitrate for the plurality of transport packets traversing the L4S service and the target bitrate for the plurality of transport packets traversing the non-L4S service.

Also, for example, the process 2000 includes transmitting 2045, at the sender device, a plurality of transport packets to the L4S service. Further, for example, the process 2000 includes transmitting 2050, at the sender device, a plurality of transport packets to the non-L4S service. Still further, for example, the process 2000 includes receiving 2055, at a receiver device, a plurality of transport packets from the L4S service. Moreover, for example, the process 2000 includes receiving 2060, at the receiver device, a plurality of transport packets from the non-L4S service. In addition, for example, the process 2000 includes causing 2065 to store, at the receiver device, the plurality of transport packets received from the L4S service in a receiver L4S buffer. Furthermore, for example, the process 2000 includes causing 2070 to store, at the receiver device, a plurality of transport packets received from a non-L4S service in a receiver non-L4S buffer. Also, for example, the process 2000 includes causing 2075 to report, from the receiver device, receiver packet statistics for the plurality of transport packets received from the L4S service.

For example, the quantification comprises a quantity of a plurality of transport units. Also, for example, the quantification comprises a size of a plurality of transport units. Further, for example, the preferential encapsulation and transport of the image unit comprise setting a target bitrate. Still further, for example, the image unit may be at least one of a picture, a frame, a slice, a tile, combinations of the same, or the like.

In some embodiments, a process for low- to ultralow-latency content delivery includes each of the following: determining (see, cf., 1905) whether a quantification of a transport unit to encapsulate and transport an image unit satisfies a threshold; based at least in part on the determination: causing to provide (see, cf., 1910) preferential encapsulation and transport of the image unit by tagging the transport unit for an L4S service or a non-L4S service; affecting (see, cf., 2020 or 2025), on a frame-to-frame basis, the transport unit traversing the L4S service or the non-L4S service; and causing (see, cf., 1930 or 1935) to stream the transport unit received from the L4S service and the non-L4S service from a sender device to a receiver device at the target bitrate.

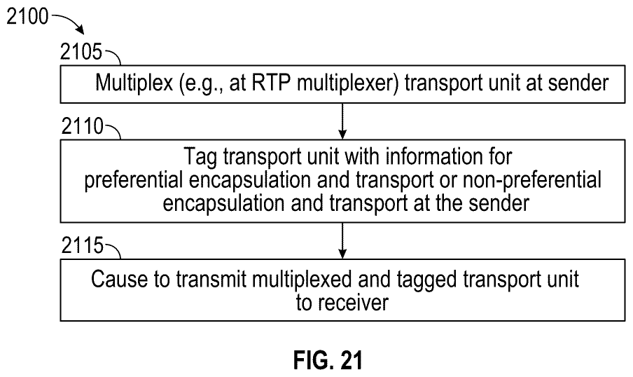

FIG. 21 shows a flowchart of an example process 2100 for low- to ultralow-latency content delivery at a multiplexer, in accordance with some embodiments of the disclosure. For example, the process 2000 is provided for low- to ultralow-latency content delivery from a sender to a receiver. Also, for example, the process 2100 includes multiplexing 2105, e.g., one or more video and/or audio packets, which encapsulate video and/or audio encoded PES data into a transport unit at the sender. Further, for example, the process 2100 includes tagging 2110 the transport unit with information for preferential encapsulation and transport or non-preferential encapsulation and transport at the sender. Still further, for example, the process 2100 includes causing 2115 to transmit the multiplexed and tagged transport unit to the receiver. Moreover, for example, the sender may include a real-time transport protocol (RTP) multiplexer.

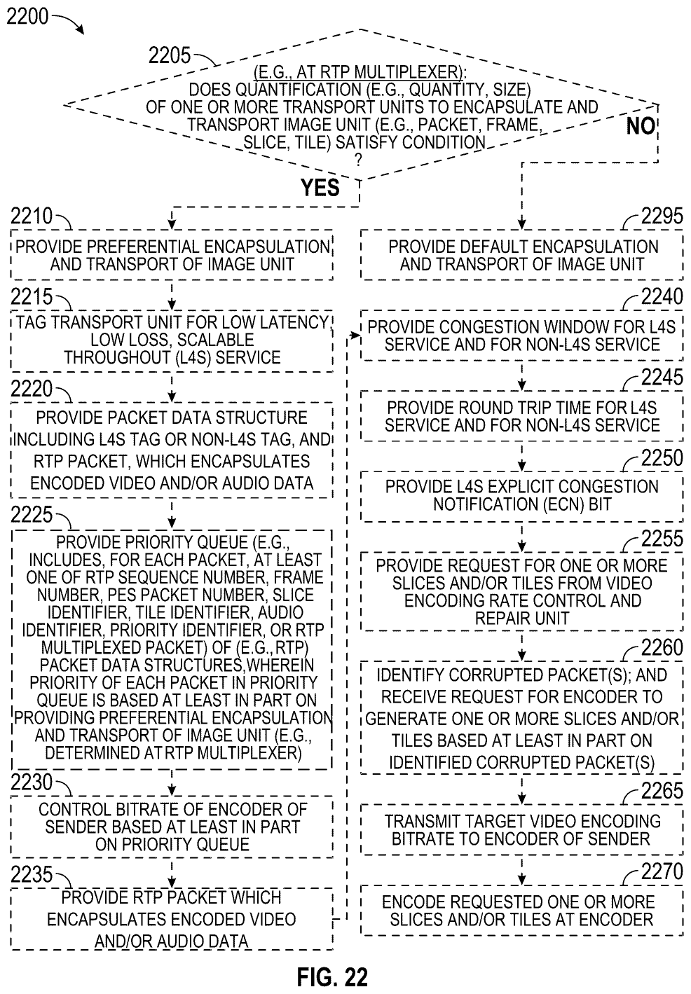

FIG. 22 shows a flowchart of an example process 2200 with one or more steps combinable with one or more steps of the process of FIG. 21, in accordance with some embodiments of the disclosure. For example, the process 2200 includes determining 2205, at the RTP multiplexer, whether a quantification of the transport unit to encapsulate and transport an image unit satisfies a condition. Also, for example, the process 2200 includes, based at least in part on determining that the quantification of the transport unit to encapsulate and transport the image unit satisfies the condition (2205=“Yes”), providing 2210 preferential encapsulation and transport of the image unit. Further, for example, the process 2200 includes, based at least in part on determining that the quantification of the transport unit to encapsulate and transport the image unit satisfies the condition (2205=“No”), providing 2295 default encapsulation and transport of the image unit.

In some embodiments, the preferential encapsulation and transport of the image unit comprise tagging 2215 the transport unit for an LAS service. For example, the process 2200 includes providing 2220, at the RTP multiplexer, a packet data structure including either an L4S tag or a non-L4S tag, and an RTP packet, which encapsulates encoded video and/or audio data. Also, for example, the process 2200 includes providing 2225 a priority queue of RTP packet data structures, where a priority of each packet in the priority queue is based at least in part on the providing preferential encapsulation and transport of the image unit determined at the RTP multiplexer. Further, for example, the process 2200 includes controlling 2230 a bitrate of an encoder of the sender based at least in part on the priority queue. Still further, for example, the priority queue may include, for each packet, at least one of an RTP sequence number, a frame number, a PES packet number, a slice identifier, a tile identifier, an audio identifier, a priority identifier, an RTP multiplexed packet, combinations of the same, or the like. Moreover, for example, the sender may include a transmission scheduler.

In some embodiments, the process 2200 includes, based at least in part on the priority queue of RTP packet data structures, providing 2235 an RTP packet, which encapsulates encoded video and/or audio data. For example, the process 2200 includes, based at least in part on the priority queue of RTP packet data structures, providing 2240 a congestion window for an L4S service and for a non-L4S service. Further, for example, the process 2200 includes, based at least in part on the priority queue of RTP packet data structures, providing 2245 a round trip time for the L4S service and for the non-L4S service. Still further, for example, the process 2200 includes, based at least in part on the priority queue of RTP packet data structures, providing 2250 an LAS ECN bit. Moreover, for example, the process 2200 includes, based at least in part on the priority queue of RTP packet data structures, providing 2255 a request for one or more slices and/or tiles from a video encoding rate control and repair unit. In addition, for example, the sender may include a video encoding rate control and repair unit. Furthermore, for example, the process 2200 includes identifying, at the Network Congestion Control, one or more dropped packets; and at the video encoding rate control and repair unit, receiving 2260 a request for an encoder to generate one or more slices and/or tiles based at least in part on the identified one or more dropped packets. For example, the process 2200 includes, at the video encoding rate control and repair unit, transmitting 2265 a target video encoding bitrate to an encoder of the sender. Also, for example, the process 2200 includes, at the video encoding rate control and repair unit, encoding 2270 the requested one or more slices and/or tiles at the encoder in accordance with the target video encoding bitrate.

In some embodiments, a process for low- to ultralow-latency content delivery from a sender, which includes a real-time transport protocol (RTP) multiplexer and a video encoding rate control and repair unit, to a receiver, includes each of the following: multiplexing (see, cf., 2105) a video and/or audio packet at the sender and encoding (see, cf., 2110) the video and/or audio packet with information for either preferential or non-preferential encapsulation and transport; determining (see, cf., 2205) whether a quantification of the video and/or audio packet to encapsulate and transport an image unit satisfies a condition; based at least in part on satisfaction of the condition (see, cf., 2205=“Yes”), providing (see, cf., 2210) preferential encapsulation and transport of the image unit including tagging (see, cf., 2215) a preferential video and/or audio packet for an L4S service; providing (see, cf., 2220) a packet data structure including either an L4S tag or a non-L4S tag, and an RTP packet, which encapsulates encoded video and/or audio data; providing (see, cf., 2225) a priority queue of RTP packet data structures, wherein the priority of each packet in the queue is based at least in part on the preferential encapsulation and transport of the image unit; controlling (see, cf., 2230) a bitrate of an encoder of the sender based at least in part on the priority queue; providing (see, cf., 2235) an RTP packet, which encapsulates encoded video and/or audio data; providing (see, cf., 2240) a congestion window for an L4S service and for a non-L4S service; providing (see, cf., 2245) a round trip time for the L4S service and for the non-L4S service; providing (see, cf., 2250) an L4S explicit congestion notification (ECN) bit; providing (see, cf., 2255) a request for one or more slices and/or tiles from the video encoding rate control and repair unit; identifying one or more corrupted packets; receiving (see, cf., 2260) a request for an encoder to generate one or more slices and/or tiles based at least in part on the identified one or more corrupted packets; transmitting (see, cf., 2265) a target video encoding bitrate to an encoder of the sender; encoding (see, cf., 2270) the requested one or more slices and/or tiles at the encoder in accordance with the target video encoding bitrate; and transmitting (see, cf., 2115) the multiplexed and encoded video and/or audio packet to the receiver.

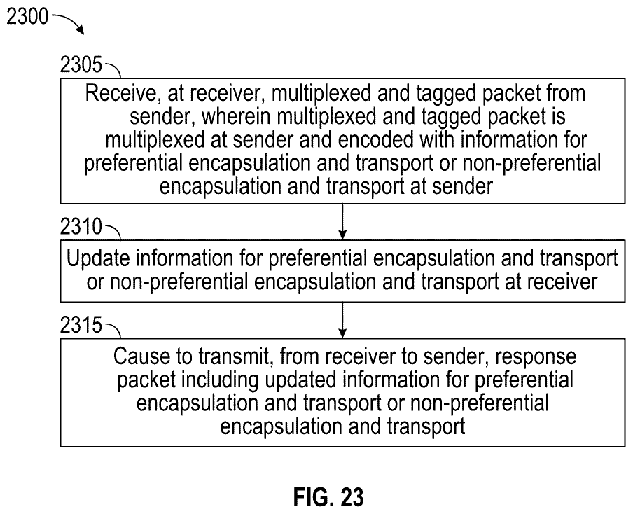

FIG. 23 shows a flowchart of an example process 2300 for low- to ultralow-latency content reception at a receiver, in accordance with some embodiments of the disclosure. For example, the process 2300 for low- to ultralow-latency content reception at a receiver and response to a sender includes 2305 receiving, at the receiver, a multiplexed and tagged packet from the sender, wherein the multiplexed and tagged packet is multiplexed at the sender and encoded with information for preferential encapsulation and transport or non-preferential encapsulation and transport at the sender. Also, for example, the process 2300 includes updating 2310 information for preferential encapsulation and transport or non-preferential encapsulation and transport at the receiver. Further, for example, the process 2300 includes causing 2315 to transmit a response packet from the receiver to the sender, the response packet including the updated information for preferential encapsulation and transport or non-preferential encapsulation and transport.

### Predictive Model

In some embodiments, a predictive model and/or predictive engine is modeled, trained, and utilized to predict when a user device is likely to request preferential treatment (e.g., L4S versus non-L4S and the like). For example, when a system, utilizing the predictive model, determines that the user is about to win a boss fight, with a cut scene following, the system prepares for higher-quality video and switches processing of image units to a preferential service (again, e.g., L4S).

Throughout the present disclosure, in some embodiments, determinations, predictions, likelihoods, and the like are determined with one or more predictive models. In some embodiments, the model receives various forms of data about users, media content items, devices, and more. This includes usage data, load-balancing data, and metadata. The model performs analysis based on hard rules, learning rules, hard models, learning models, usage data, load data, analytics, metadata, profile information, or combinations of these. The model outputs predictions of a future state of any of the devices described. Load-increasing events are determined by load-balancing processes. The model is based on inputs including hard rules, user-defined rules, rules defined by content providers, hard models, learning models, or combinations of these. The model is trained with data using various data processes, analytical processes, and machine learning approaches. It includes regression and classification analyses. An example of a multi-layer neural network is provided. The model is based on data engineering and modeling processes, and is operationalized using registration, deployment, monitoring, and retraining processes. The model is configured to output results to one or multiple devices, which can perform various functions. The devices can be a server, tablet, media display device, network-connected computer, media device, computing device, or combinations of these. The model outputs a current state, future state, determination, prediction, or likelihood. These outputs may be compared to a predetermined or determined standard. If the standard is satisfied or rejected, the predictive process outputs at least one of the current state, future state, determination, prediction, or likelihood to any device or module disclosed.

In some embodiments, the model ingests diverse forms of data about users, digital content items, devices, and more. This encompasses user interaction data, load-distribution data, and metadata. The model conducts analysis based on deterministic rules, learned rules, deterministic models, learned models, user interaction data, load data, analytics, metadata, user profile information, or combinations thereof. The model generates predictions of a future state of any of the described devices. Load-increasing events are identified by load-distribution processes.

The model is constructed based on inputs including deterministic rules, user-defined rules, rules defined by content providers, deterministic models, learned models, or combinations thereof. The model is trained with data using various data processing methods, analytical processes, and machine learning techniques. It includes regression and classification analyses. An example of a deep neural network is provided.

The model is built upon data engineering and modeling processes and is operationalized using registration, deployment, monitoring, and retraining processes. The model is designed to output results to one or multiple devices, which can perform various functions. The devices can be a server, tablet, digital display device, network-connected computer, media device, computing device, or combinations thereof.

The model outputs a current state, future state, determination, prediction, or probability. These outputs may be compared to a predetermined or determined benchmark. If the benchmark is met or not met, the predictive process outputs at least one of the current state, future state, determination, prediction, or probability to any device or module disclosed.

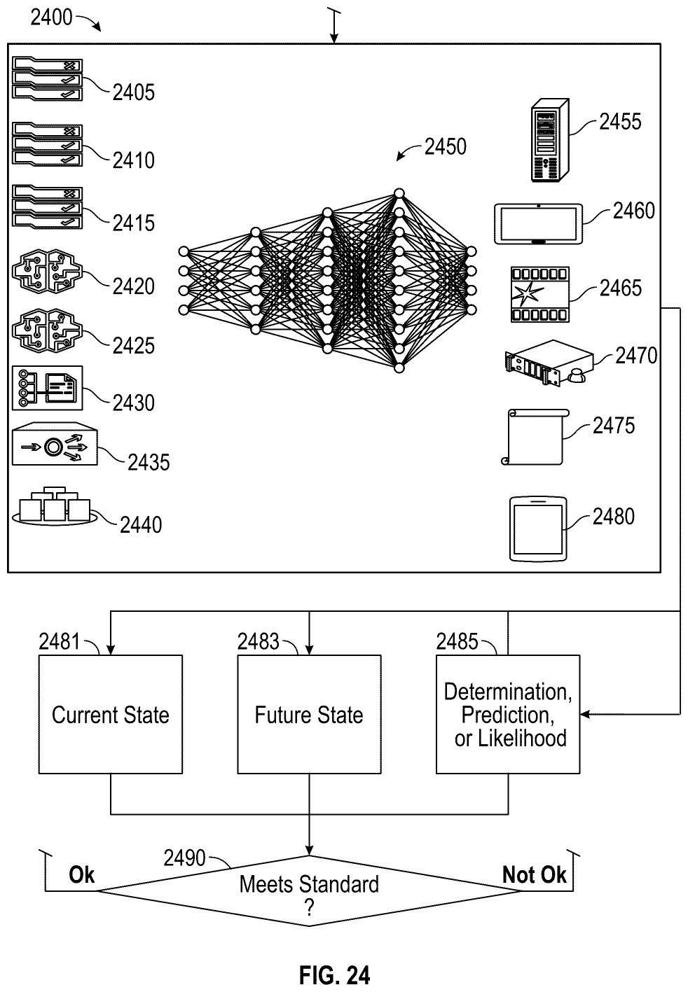

For example, FIG. 24 depicts a predictive model. A prediction process 2400 includes a predictive model 2450 in some embodiments. The predictive model 2450 receives as input various forms of data about one, more or all the users, media content items, devices, and data described in the present disclosure. The predictive model 2450 performs analysis based on at least one of hard rules, learning rules, hard models, learning models, usage data, load data, analytics of the same, metadata, profile information, combinations of the same, or the like. The predictive model 2450 outputs one or more predictions of a future state of any of the devices described in the present disclosure. A load-increasing event is determined by load-balancing processes, e.g., least connection, least bandwidth, round robin, server response time, weighted versions of the same, resource-based processes, and address hashing. The predictive model 2450 is based on input including at least one of a hard rule 2405, a user-defined rule 2410, a rule defined by a content provider 2415, a hard model 2420, a learning model 2425, combinations of the same, or the like.

The predictive model 2450 receives as input usage data 2430. The predictive model 2450 is based, in some embodiments, on at least one of a usage pattern of the user or media device, a usage pattern of the requesting media device, a usage pattern of the media content item, a usage pattern of the communication system or network, a usage pattern of the profile, a usage pattern of the media device, combinations of the same, or the like.

The predictive model 2450 receives as input load-balancing data 2435. The predictive model 2450 is based on at least one of load data of the display device, load data of the requesting media device, load data of the media content item, load data of the communication system or network, load data of the profile, load data of the media device, combinations of the same, or the like.

The predictive model 2450 receives as input metadata 2440. The predictive model 2450 is based on at least one of metadata of the streaming service, metadata of the requesting media device, metadata of the media content item, metadata of the communication system or network, metadata of the profile, metadata of the media device, combinations of the same, or the like. The metadata includes information of the type represented in the media device manifest.

The predictive model 2450 is trained with data. The training data is developed in some embodiments using one or more data processes including but not limited to data selection, data sourcing, and data synthesis. The predictive model 2450 is trained in some embodiments with one or more analytical processes including but not limited to classification and regression trees (CART), discrete choice models, linear regression models, logistic regression, logit versus probit, multinomial logistic regression, multivariate adaptive regression splines, probit regression, regression processes, survival or duration analysis, and time series models. The predictive model 2450 is trained in some embodiments with one or more machine learning approaches including but not limited to supervised learning, unsupervised learning, semi-supervised learning, reinforcement learning, and dimensionality reduction. The predictive model 2450 in some embodiments includes regression analysis including analysis of variance (ANOVA), linear regression, logistic regression, ridge regression, and/or time series. The predictive model 2450 in some embodiments includes classification analysis including decision trees and/or neural networks. In FIG. 24, a depiction of a multi-layer neural network is provided as a non-limiting example of a predictive model 2450, the neural network including an input layer (left side), three hidden layers (middle), and an output layer (right side) with 32 neurons and 192 edges, which is intended to be illustrative, not limiting. The predictive model 2450 is based on data engineering and/or modeling processes. The data engineering processes include exploration, cleaning, normalizing, feature engineering, and scaling. The modeling processes include model selection, training, evaluation, and tuning. The predictive model 2450 is operationalized using registration, deployment, monitoring, and/or retraining processes.

The predictive model 2440 is configured to output results to a device or multiple devices. The device includes means for performing one, more, or all the features referenced herein of the systems, methods, processes, and outputs of one or more of FIGS. 1A-23, in any suitable combination. The device is at least one of a server 2455, a tablet 2460, a media display device 2465, a network-connected computer 2470, a media device 2475, a computing device 2480, combinations of the same, or the like.

The predictive model 2450 is configured to output a current state 2481, and/or a future state 2483, and/or a determination, a prediction, or a likelihood 2485, and the like. The current state 2481, and/or the future state 2483, and/or the determination, the prediction, or the likelihood 2485, and the like may be compared 2490 to a predetermined or determined standard. In some embodiments, the standard is satisfied (2490=OK) or rejected (2490=NOT OK). If the standard is satisfied or rejected, the predictive process 2400 outputs at least one of the current state, the future state, the determination, the prediction, the likelihood to any device or module disclosed herein, combinations of the same, or the like. In some embodiments, the predictive model 2450 incorporates one or more LLMs.

A communication system is provided including a computing device, a server, and a communication network. Both the server and the communication network can exist in multiple forms and can connect directly or indirectly. The computing device includes control circuitry, a display, and I/O circuitry. The control circuitry can execute systems, methods, processes, and outputs. Both the computing device and server include control circuitry and storage, which can store content, metadata, data, user profiles, messages, and commands for an application. The computing device communicates with an I/O device and can receive and process user inputs locally or transmit them to the remote server for processing. Both the server and the computing device can transmit and receive content via the communication network or directly, and the processing circuitry receives the user input and converts it to digital signals.

In some embodiments, the system is a distributed network architecture with an edge device (a type of computing device 2502), a cloud server (a type of server 2504), and an internet of things (IoT) network (a type of communication network 2506). Both the edge device and server have microservices and data lakes. The edge device includes a user interface and I/O ports. User interactions can be processed at the edge or in the cloud. The system can transmit and receive digital assets via the IoT network. The edge device communicates with an IoT device and can be various types of smart devices capable of displaying and interacting with digital content. The communication paths in the system can be optimized for latency and bandwidth efficiency.

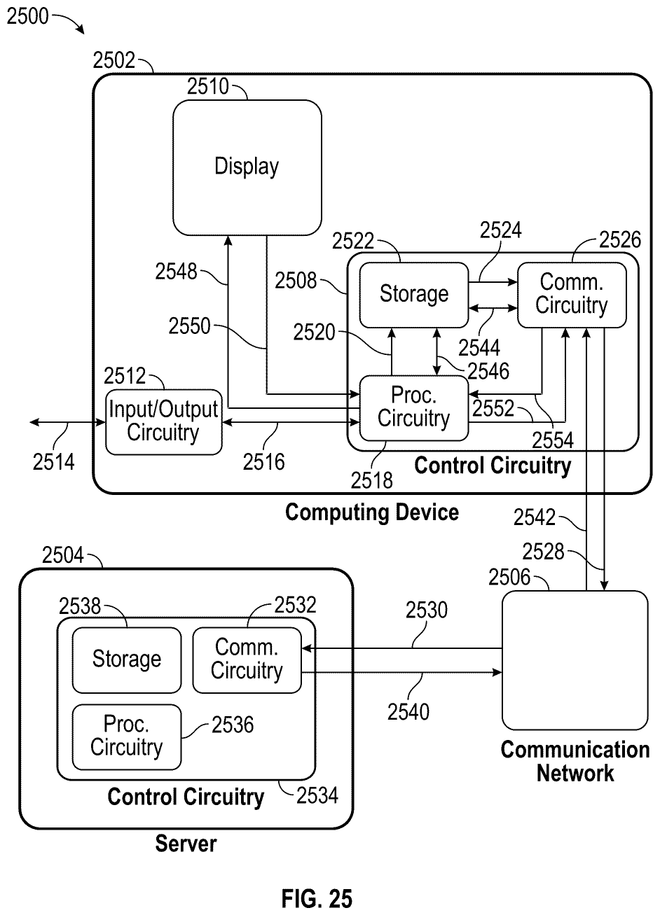

FIG. 25 depicts a block diagram of system 2500, in accordance with some embodiments. The system is shown to include computing device 2502, server 2504, and a communication network 2506. It is understood that while a single instance of a component may be shown and described relative to FIG. 25, additional embodiments of the component may be employed. For example, server 2504 may include, or may be incorporated in, more than one server. Similarly, communication network 2506 may include, or may be incorporated in, more than one communication network. Server 2504 is shown communicatively coupled to computing device 2502 through communication network 2506. While not shown in FIG. 25, server 2504 may be directly communicatively coupled to computing device 2502, for example, in a system absent or bypassing communication network 2506.

Communication network 2506 may include one or more network systems, such as, without limitation, the internet, LAN, Wi-Fi, wireless, or other network systems suitable for audio processing applications. The system 2500 of FIG. 25 excludes server 2504, and functionality that would otherwise be implemented by server 2504 is instead implemented by other components of the system depicted by FIG. 25, such as one or more components of communication network 2506. In still other embodiments, server 2504 works in conjunction with one or more components of communication network 2506 to implement certain functionality described herein in a distributed or cooperative manner. Similarly, the system depicted by FIG. 25 excludes computing device 2502, and functionality that would otherwise be implemented by computing device 2502 is instead implemented by other components of the system depicted by FIG. 25, such as one or more components of communication network 2506 or server 2504 or a combination of the same. In other embodiments, computing device 2502 works in conjunction with one or more components of communication network 2506 or server 2504 to implement certain functionality described herein in a distributed or cooperative manner.

Computing device 2502 includes control circuitry 2508, display 2510 and input/output (I/O) circuitry 2512. Control circuitry 2508 may be based on any suitable processing circuitry and includes control circuits and memory circuits, which may be disposed on a single integrated circuit or may be discrete components. As referred to herein, processing circuitry should be understood to mean circuitry based on at least one microprocessors, microcontrollers, digital signal processors, programmable logic devices, field-programmable gate arrays (FPGAs), application-specific integrated circuits (ASICs), system-on-chip (SoC), application-specific standard parts (ASSPs), indium phosphide (InP)-based monolithic integration and silicon photonics, non-classical devices, organic semiconductors, compound semiconductors, “More Moore” devices, “More than Moore” devices, cloud-computing devices, combinations of the same, or the like, and may include a multi-core processor (e.g., dual-core, quad-core, hexa-core, or any suitable number of cores). In some embodiments, processing circuitry may be distributed across multiple separate processors or processing units, for example, multiple of the same type of processing units (e.g., two Intel Core i9 processors) or multiple different processors (e.g., an Intel Core i7 processor and an Intel Core i9 processor). Some control circuits may be implemented in hardware, firmware, or software. Control circuitry 2508 in turn includes communication circuitry 2526, storage 2522 and processing circuitry 2518. Either of control circuitry 2508 and 2534 may be utilized to execute or perform any or all the systems, methods, processes, and outputs of one or more of FIGS. 1A-24, or any combination of steps thereof (e.g., as enabled by processing circuitries 2518 and 2536, respectively).

In addition to control circuitry 2508 and 2534, computing device 2502 and server 2504 may each include storage (storage 2522, and storage 2538, respectively). Each of storages 2522 and 2538 may be an electronic storage device. As referred to herein, the phrase “electronic storage device” or “storage device” should be understood to mean any device for storing electronic data, computer software, or firmware, such as random-access memory, read-only memory, cloud-based storage, hard drives, optical drives, digital video disc (DVD) recorders, compact disc (CD) recorders, BLU-RAY disc (BD) recorders, BLU-RAY 3D disc recorders, digital video recorders (DVRs, sometimes called personal video recorders, or PVRs), solid state devices, quantum storage devices, gaming consoles, gaming media, or any other suitable fixed or removable storage devices, and/or any combination of the same. Each of storage 2522 and 2538 may be used to store several types of content, metadata, and/or other types of data. Non-volatile memory may also be used (e.g., to launch a boot-up routine and other instructions). Cloud-based storage may be used to supplement storages 2522 and 2538 or instead of storages 2522 and 2538. In some embodiments, a user profile and messages corresponding to a chain of communication may be stored in one or more of storages 2522 and 2538. Each of storages 2522 and 2538 may be utilized to store commands, for example, such that when each of processing circuitries 2518 and 2536, respectively, are prompted through control circuitries 2508 and 2534, respectively. Either of processing circuitries 2518 or 2536 may execute any of the systems, methods, processes, and outputs of one or more of FIGS. 1A-24, or any combination of steps thereof.

In some embodiments, control circuitry 2508 and/or 2534 executes instructions for an application stored in memory (e.g., storage 2522 and/or storage 2538). Specifically, control circuitry 2508 and/or 2534 may be instructed by the application to perform the functions discussed herein. In some embodiments, any action performed by control circuitry 2508 and/or 2534 may be based on instructions received from the application. For example, the application may be implemented as software or a set of and/or one or more executable instructions that may be stored in storage 2522 and/or 2538 and executed by control circuitry 2508 and/or 2534. The application may be a client/server application where only a client application resides on computing device 2502, and a server application resides on server 2504.

The application may be implemented using any suitable architecture. For example, it may be a stand-alone application wholly implemented on computing device 2502. In such an approach, instructions for the application are stored locally (e.g., in storage 2522), and data for use by the application is downloaded on a periodic basis (e.g., from an out-of-band feed, from an internet resource or using another suitable approach). Control circuitry 2508 may retrieve instructions for the application from storage 2522 and process the instructions to perform the functionality described herein. Based on the processed instructions, control circuitry 2508 may determine a type of action to perform based at least in part on input received from I/O circuitry 2512 or from communication network 2506.

The computing device 2502 is configured to communicate with an I/O device (not shown) via the I/O circuitry 2512. In some embodiments, the user input 2514 is received from the I/O device. A wired and/or wireless connection between the I/O circuitry 2512 and the I/O device is provided in some embodiments. The I/O device may be, for example, at least one of a keyboard, a mouse, a touchscreen, a microphone, a scanner, a joystick, a graphics tablet, a monitor, a printer, speakers, headphones, a projector, a headset, a wearable device, a gaming controller, an external hard drive, a USB hard drive, an SD card, a network interface card (NIC), combinations of the same, or the like.

In client/server-based embodiments, control circuitry 2508 may include communication circuitry suitable for communicating with an application server (e.g., server 2504) or other networks or servers. The instructions for conducting the functionality described herein may be stored on the application server. Communication circuitry may include a cable modem, an Ethernet card, or a wireless modem for communication with other equipment, or any other suitable communication circuitry. Such communication may involve the internet or any other suitable communication networks or paths (e.g., communication network 2506). In another example of a client/server-based application, control circuitry 2508 runs a web browser that interprets web pages provided by a remote server (e.g., server 2504). For example, the remote server may store the instructions for the application in a storage device.

The remote server may process the stored instructions using circuitry (e.g., control circuitry 2534) and/or generate displays. Computing device 2502 may receive the displays generated by the remote server and may display the content of the displays locally via display 2510. For example, display 2510 may be utilized to present a string of characters. This way, the processing of the instructions is performed remotely (e.g., by server 2504) while the resulting displays, such as the display windows described elsewhere herein, are provided locally on computing device 2504. Computing device 2502 may receive inputs from the user via input/output circuitry 2512 and transmit those inputs to the remote server for processing and generating the corresponding displays.

Alternatively, computing device 2502 may receive inputs from the user via input/output circuitry 2512 and process and display the received inputs locally, by control circuitry 2508 and display 2510, respectively. For example, input/output circuitry 2512 may correspond to a keyboard and/or a set of and/or one or more speakers/microphones which are used to receive user inputs (e.g., input as displayed in a search bar or a display of FIG. 25 on a computing device). Input/output circuitry 2512 may also correspond to a communication link between display 2510 and control circuitry 2508 such that display 2510 updates based at least in part on inputs received via input/output circuitry 2512 (e.g., simultaneously update what is shown in display 2510 based on inputs received by generating corresponding outputs based on instructions stored in memory via a non-transitory, computer-readable medium).

Server 2504 and computing device 2502 may transmit and receive content and data such as media content via communication network 2506. For example, server 2504 may be a media content provider, and computing device 2502 may be a smart television configured to download or stream media content, such as a live news broadcast, from server 2504. Control circuitry 2534, 2508 may send and receive commands, requests, and other suitable data through communication network 2506 using communication circuitry 2532, 2526, respectively. Alternatively, control circuitry 2534, 2508 may communicate directly with each other using communication circuitry 2532, 2526, respectively, avoiding communication network 2506.

It is understood that computing device 2502 is not limited to the embodiments and methods shown and described herein. In nonlimiting examples, computing device 2502 may be a television, a Smart TV, a set-top box, an integrated receiver decoder (IRD) for handling satellite television, a digital storage device, a digital media receiver (DMR), a digital media adapter (DMA), a streaming media device, a DVD player, a DVD recorder, a connected DVD, a local media server, a BLU-RAY player, a BLU-RAY recorder, a personal computer (PC), a laptop computer, a tablet computer, a WebTV box, a personal computer television (PC/TV), a PC media server, a PC media center, a handheld computer, a stationary telephone, a personal digital assistant (PDA), a mobile telephone, a portable video player, a portable music player, a portable gaming machine, a smartphone, or any other device, computing equipment, or wireless device, and/or combination of the same, capable of suitably displaying and manipulating media content.

Computing device 2502 receives user input 2514 at input/output circuitry 2512. For example, computing device 2502 may receive a user input such as a user swipe or user touch. It is understood that computing device 2502 is not limited to the embodiments and methods shown and described herein.

User input 2514 may be received from a user selection-capturing interface that is separate from device 2502, such as a remote-control device, trackpad, or any other suitable user movement-sensitive, audio-sensitive or capture devices, or as part of device 2502, such as a touchscreen of display 2510. Transmission of user input 2514 to computing device 2502 may be accomplished using a wired connection, such as an audio cable, USB cable, ethernet cable and the like attached to a corresponding input port at a local device, or may be accomplished using a wireless connection, such as Bluetooth, Wi-Fi, WiMAX, GSM, UTMS, CDMA, TDMA, 8G, 4G, 4G LTE, 5G, NearLink, ultra-wideband technology, or any other suitable wireless transmission protocol. Input/output circuitry 2512 may include a physical input port such as a 12.5 mm (0.4921 inch) audio jack, RCA audio jack, USB port, ethernet port, or any other suitable connection for receiving audio over a wired connection or may include a wireless receiver configured to receive data via Bluetooth, Wi-Fi, WiMAX, GSM, UTMS, CDMA, TDMA, 3G, 4G, 4G LTE, 5G, NearLink, ultra-wideband technology, or other wireless transmission protocols.

Processing circuitry 2518 may receive user input 2514 from input/output circuitry 2512 using communication path 2516. Processing circuitry 2518 may convert or translate the received user input 2514 that may be in the form of audio data, visual data, gestures, or movement to digital signals. In some embodiments, input/output circuitry 2512 performs the translation to digital signals. In some embodiments, processing circuitry 2518 (or processing circuitry 2536, as the case may be) conducts disclosed processes and methods.

Processing circuitry 2518 may provide requests to storage 2522 by communication path 2520. Storage 2522 may provide requested information to processing circuitry 2518 by communication path 2546. Storage 2522 may transfer a request for information to communication circuitry 2526 which may translate or encode the request for information to a format receivable by communication network 2506 before transferring the request for information by communication path 2528. Communication network 2506 may forward the translated or encoded request for information to communication circuitry 2532, by communication path 2530.

At communication circuitry 2532, the translated or encoded request for information, received through communication path 2530, is translated or decoded for processing circuitry 2536, which will provide a response to the request for information based on information available through control circuitry 2534 or storage 2538, or a combination thereof. The response to the request for information is then provided back to communication network 2506 by communication path 2540 in an encoded or translated format such that communication network 2506 forwards the encoded or translated response back to communication circuitry 2526 by communication path 2542.

At communication circuitry 2526, the encoded or translated response to the request for information may be provided directly back to processing circuitry 2518 by communication path 2554 or may be provided to storage 2522 through communication path 2544, which then provides the information to processing circuitry 2518 by communication path 2546. Processing circuitry 2518 may also provide a request for information directly to communication circuitry 2526 through communication path 2552, where storage 2522 responds to an information request (provided through communication path 2520 or 2544) by communication path 2524 or 2546 that storage 2522 does not contain information pertaining to the request from processing circuitry 2518.

Processing circuitry 2518 may process the response to the request received through communication paths 2546 or 2554 and may provide instructions to display 2510 for a notification to be provided to the users through communication path 2548. Display 2510 may incorporate a timer for providing the notification or may rely on inputs through input/output circuitry 2512 from the user, which are forwarded through processing circuitry 2518 through communication path 2548, to determine how long or in what format to provide the notification. When display 2510 determines the display has been completed, a notification may be provided to processing circuitry 2518 through communication path 2550.

The communication paths provided in FIG. 25 between computing device 2502, server 2504, communication network 2506, and all subcomponents depicted are examples and may be modified to reduce processing time or enhance processing capabilities for each step in the processes disclosed herein by one skilled in the art.

### INCORPORATIONS BY REFERENCE

Each of the following is hereby incorporated by reference herein in its entirety: (1) Tao Chen and Christopher Phillips, U.S. patent application Ser. No. 17/992,582, titled “Video Compression at Scene Changes for Low-Latency Interactive Experience,” filed Mar. 28, 2022, published as U.S. Patent Application Publication No. 2024/0171741 on May 23, 2024 (Chen '582); (2) Christopher Phillips and Tao Chen, U.S. patent application Ser. No. 18/622,467, titled “Optimized Fast Video Frame Repair for Extreme Low Latency RTP Delivery,” filed Mar. 29, 2024 (Phillips '467); (3) Christopher Phillips, Dhananjay Lal, and Reda Harb, U.S. patent application Ser. No. 18/626,659, titled “Application-Flow Aware Broadband Service with Data Caps,” filed Apr. 4, 2024 (Phillips '659); (4) Christopher Phillips, Dhananjay Lal, and Reda Harb, U.S. Provisional Patent Application No. 63/574,668, titled “Intelligent Application Priority Packet Delivery Control,” filed Apr. 4, 2024 (Phillips '668); (5) Christopher Phillips, Dhananjay Lal, and Reda Harb, U.S. patent application Ser. No. 18/667,655, titled “Intelligent Application Priority Packet Delivery Control,” filed May 17, 2024 (Phillips '655); and (6) Tao Chen and Christopher Phillips, U.S. patent application Ser. No. 18/___,___ titled “Methods to Optimize Video Compression for ABR Streaming” (IDF-11866, 003597-4016-101), filed ______ __2024 (Chen 'XXX).

### Terminology

The terminology used herein is for the purpose of describing particular embodiments only and is not intended to be limiting of the disclosure.

Throughout the specification the term “comprising” shall be understood to have a broad meaning similar to the term “including” and will be understood to imply the inclusion of a stated integer or step or group of integers or steps but not the exclusion of any other integer or step or group of integers or steps. This definition also applies to variations on the term “comprising” such as “comprise” and “comprises.”

Throughout the specification the phrases “in response to” and “based on” shall be understood to have a broad meaning unless context requires otherwise. For example, “in response to” can refer to a step that is in direct or indirect response to a prior step, and “based on” can refer to a step that is based at least in part on a prior step.

As used herein, the terms “real time,” “simultaneous,” “substantially on-demand,” and the like are understood to be nearly instantaneous but may include delay due to practical limits of the system. Such delays may be in the order of milliseconds or microseconds, depending on the application and nature of the processing. Relatively longer delays (e.g., greater than a millisecond) may result due to communication or processing delays, particularly in remote and cloud-computing environments.

As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Although at least some embodiments are described as using a plurality of units or modules to perform a process or processes, it is understood that the process or processes may also be performed by one or a plurality of units or modules. Additionally, it is understood that the term controller/control unit may refer to a hardware device that includes a memory and a processor. The memory may be configured to store the units or the modules, and the processor may be specifically configured to execute said units or modules to perform one or more processes which are described herein.

Unless specifically stated or obvious from context, as used herein, the term “about” is understood as within a range of normal tolerance in the art, for example within 2 standard deviations of the mean. “About” may be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

The use of the terms “first”, “second”, “third”, and so on, herein, are provided to identify structures or operations, without describing an order of structures or operations, and, to the extent the structures or operations are used in an embodiment, the structures may be provided or the operations may be executed in a different order from the stated order unless a specific order is definitely specified in the context.

The methods and/or any instructions for performing any of the embodiments discussed herein may be encoded on computer-readable media. Computer-readable media includes any media capable of storing data. The computer-readable media may be transitory, including, but not limited to, propagating electrical or electromagnetic signals, or may be non-transitory (e.g., a non-transitory, computer-readable medium accessible by an application via control or processing circuitry from storage) including, but not limited to, volatile and non-volatile computer memory or storage devices such as a hard disk, floppy disk, USB drive, DVD, CD, media cards, register memory, processor caches, random-access memory (RAM), UltraRAM, cloud-based storage, and the like.

The interfaces, processes, and analysis described may, in some embodiments, be performed by an application. The application may be loaded directly onto each device of any of the systems described or may be stored in a remote server or any memory and processing circuitry accessible to each device in the system. The generation of interfaces and analysis there-behind may be performed at a receiving device, a sending device, or some device or processor therebetween.

Any use of a phrase such as “in some embodiments” or the like with reference to a feature is not intended to link the feature to another feature described using the same or a similar phrase. Any and all embodiments disclosed herein are combinable or separately practiced as appropriate. Absence of the phrase “in some embodiments” does not infer that the feature is necessary. Inclusion of the phrase “in some embodiments” does not infer that the feature is not applicable to other embodiments or even all embodiments.

The systems and processes discussed herein are intended to be illustrative and not limiting. One skilled in the art would appreciate that the actions of the processes discussed herein may be omitted, modified, combined, duplicated, rearranged, and/or substituted, and any additional actions may be performed without departing from the scope of the invention. More generally, the disclosure herein is meant to provide examples and is not limiting. Only the claims that follow are meant to set bounds as to what the present disclosure includes. Furthermore, it should be noted that the features and limitations described in any some embodiments may be applied to any other embodiment herein, and flowcharts or examples relating to some embodiments may be combined with any other embodiment in a suitable manner, done in different orders, or done in parallel. In addition, the methods and systems described herein may be performed in real time. It should also be noted that the methods and/or systems described herein may be applied to, or used in accordance with, other methods and/or systems.

This description is to be taken only by way of example and not to otherwise limit the scope of the embodiments herein. Therefore, it is the object of the appended claims to cover all such variations and modifications as come within the true spirit and scope of the embodiments herein.

1. A method for low- to ultralow-latency content delivery, the method comprising:
determining whether a quantification of one or more transport units, which encapsulate and transport an image unit, satisfies a threshold; and
based at least in part on determining that the quantification of the one or more transport units satisfies the threshold, providing preferential encapsulation and transport of the image unit.

2. The method of claim 1, comprising:
based at least in part on determining that the quantification of the one or more transport units to encapsulate and transport the image unit does not satisfy the threshold, providing default encapsulation and transport of the image unit.

3. The method of claim 1, wherein the providing preferential encapsulation and transport of the image unit comprise tagging the one or more transport units for a low latency, low loss, and scalable throughput (L4S) service.

4. The method of claim 3, wherein the one or more transport units comprise a plurality of transport packets that encapsulate a packetized elementary stream (PES) packet.

5. The method of claim 3, wherein the one or more transport units are a transport packet.

6. The method of claim 5, comprising:
causing to stream a plurality of transport packets from the L4S service; and
causing to stream a plurality of transport packets from a non-L4S service.

7. The method of claim 5, comprising:
causing to store a plurality of transport packets from the L4S service in an L4S buffer; and
causing to store a plurality of transport packets from a non-L4S service in a non-L4S buffer.

8. The method of claim 5, comprising:
resequencing a plurality of transport packets from the L4S service and a plurality of transport packets from a non-L4S service prior to demultiplexing and decoding audio and video streams based on the plurality of transport packets from the L4S service and the plurality of transport packets from the non-L4S service.

9. The method of claim 5, comprising:
causing to store, at a sender device, a plurality of transport packets for transmission to the L4S service in a sender L4S buffer;
causing to store, at the sender device, a plurality of transport packets for transmission to a non-L4S service in a sender non-L4S buffer;
causing to store, at a receiver device, the plurality of transport packets received from the L4S service in a receiver L4S buffer; and
causing to store, at the receiver device, a plurality of transport packets received from a non-L4S service in a receiver non-L4S buffer.

10. The method of claim 5, comprising:
causing to report, from a sender device, sender packet statistics for a plurality of transport packets for transmission to the L4S service; and
causing to report, from a receiver device, receiver packet statistics for the plurality of transport packets received from the L4S service.

11.-40. (canceled)

41. A device for low- to ultralow-latency content delivery, the device comprising:
a multiplexer, wherein the multiplexer:
determines whether a quantification of a transport unit to encapsulate and transport an image unit satisfies a threshold; and
based at least in part on determining that the quantification of the transport unit to encapsulate and transport the image unit satisfies the threshold, provides preferential encapsulation and transport of the image unit.

42. The device of claim 41, wherein the multiplexer:
based at least in part on determining that the quantification of the transport unit to encapsulate and transport the image unit does not satisfy the threshold, provides default encapsulation and transport of the image unit.

43. The device of claim 41, wherein the preferential encapsulation and transport of the image unit comprise tagging the transport unit for a low latency, low loss, and scalable throughput (L4S) service.

44. The device of claim 43, wherein the transport unit comprises a plurality of transport packets that encapsulate a packetized elementary stream (PES) packet.

45. The device of claim 43, wherein the transport unit is a transport packet.

46. The device of claim 45, wherein the multiplexer:
causes to stream a plurality of transport packets received from the L4S service; and
causes to stream a plurality of transport packets received from a non-L4S service.

47. The device of claim 45, wherein the multiplexer:
causes to store a plurality of transport packets received from the L4S service in an L4S buffer; and
causes to store a plurality of transport packets received from a non-L4S service in a non-LAS buffer.

48. The device of claim 45, wherein the multiplexer:
resequences a plurality of transport packets received from the L4S service and a plurality of transport packets received from a non-L4S service prior to demultiplexing and decoding audio and video streams based on the plurality of transport packets received from the L4S service and the plurality of transport packets received from the non-L4S service.

49. The device of claim 45, wherein the multiplexer:
causes to store, at the device, a plurality of transport packets for transmission to the L4S service in a sender L4S buffer;
causes to store, at the device, a plurality of transport packets for transmission to a non-L4S service in a sender non-L4S buffer;
causes to store, at a receiver device, the plurality of transport packets received from the L4S service in a receiver L4S buffer; and
causes to store, at the receiver device, a plurality of transport packets received from a non-L4S service in a receiver non-L4S buffer.

50. The device of claim 45, wherein the multiplexer:
causes to report, from the device, sender packet statistics for a plurality of transport packets for transmission to the L4S service; and
causes to report, from a receiver device, receiver packet statistics for the plurality of transport packets received from the L4S service.

51.-188. (canceled)
